(19) United States
(12) Patent Application Publication
(10) Pub. No.: US 2026/0359979 A1
(43) Pub. Date: Nov. 12, 2026

(54) SYSTEMS AND METHODS FOR CHRONIC KIDNEY DISEASE CLASSIFICATION

(71) Applicant: PURDUE RESEARCH FOUNDATION, West Lafayette, IN (US)

(72) Inventors: Rachel Kathleen Surowiec, West Lafayette, IN (US); Youngjun Lee, West Lafayette, IN (US)

(21) Appl. No.: 19/644,928

(22) Filed: Apr. 10, 2026

Related U.S. Application Data
(60) Provisional application No. 63/787,530, filed on Apr. 11, 2025.

(51) Int. Cl. G06T 7/00; G06T 7/11; G06V 10/26; G06V 10/28; G06V 10/764

(52) U.S. Cl. CPC G06T 7/0012; G06T 7/11; G06V 10/26; G06V 10/28; G06V 10/764; G06T 2207/10081; G06T 2207/20081; G06T 2207/30008; G06T 2207/30084; G06V 2201/031

(57) ABSTRACT

A method for analyzing bone images includes receiving high-resolution peripheral quantitative computed tomography (HR-pQCT) image data of a bone, segmenting cortical bone regions in the HR-pQCT image data using a pre-trained machine learning model, extracting radiomic features from the segmented cortical bone regions, and classifying, using the extracted radiomic features, the bone as belonging to a chronic kidney disease (CKD) group or a non-CKD group using a machine learning classifier.

### CROSS-REFERENCE TO RELATED APPLICATIONS

This application claims priority to U.S. Patent Application No. 63/787,530 filed Apr. 11, 2025, and entitled, “Cortical Bone Texture Features Associated With CKD Using HR-pQCT,” which is hereby incorporated by reference in its entirety.

### STATEMENT REGARDING FEDERALLY SPONSORED RESEARCH

This invention was made with government support under P30 AR072581, LRP 1L30DK130133-0, RO1 HL166747, 5R01HL166747 (ROCK-D) awarded by the National Institutes of Health. The government has certain rights in the invention.

### BACKGROUND

Medical images facilitate diagnosing various diseases, conditions, as well as monitoring those conditions. Medical images may be reviewed by radiologists or other practitioners to diagnose or determine a presence of a disease by visual inspection of the images. In some examples, computer aided analysis of medical images can assist practitioners in diagnosing a disease.

### SUMMARY

Some examples of the disclosure provide a method for analyzing bone images. The method can include receiving high-resolution peripheral quantitative computed tomography (HR-pQCT) image data of a bone, segmenting cortical bone regions in the HR-pQCT image data using a pre-trained deep learning model, extracting radiomic features from the segmented cortical bone regions, wherein the radiomic features can include first-order statistics, texture features (second-order), or higher-order statistics, and classifying the bone's heterogeneity as belonging to a chronic kidney disease (CKD) group or a non-CKD group using a machine learning classifier trained on the extracted radiomic features.

In some examples, a method can include preprocessing the HR-pQCT image data by performing gray-level normalization and discretization, dividing each image stack into proximal and distal subregions, and applying a feature selection process to identify key radiomic features. The feature selection process can include removing features with variance below a first threshold and intercorrelation above a second threshold.

In some examples, the optimal first threshold is 0.20 and the optimal second threshold is 0.80.

In some examples, extracting radiomic features comprises calculating Gray Level Co-occurrence Matrix (GLCM) features from the segmented cortical bone regions and deriving at least one texture descriptor from the GLCM.

In some examples, a method can include extracting Neighboring Gray Tone Difference Matrix (NGTDM) features from the segmented cortical bone regions. The NGTDM features can include Strength. The method further comprises using the NGTDM Strength feature as an input to the machine learning classifier to distinguish between CKD and non-CKD bone images based on the quantification of texture strength.

In some examples, a method extracting radiomic features further comprises calculating Local Binary Pattern (LBP) features from the segmented cortical bone regions and combining the LBP features with Gray Level Co-occurrence Matrix (GLCM) features to create a combined feature set that captures bone texture details indicative of CKD-related cortical bone.

In some examples, classifying the bone comprises training a gradient boosted (XGB) machine learning classifier using the extracted radiomic features and features from the pre-trained deep learning model, determining hyperparameters of the gradient boosted classifier through cross-validation, and applying the trained gradient boosted classifier to new HR-pQCT image data to predict CKD bone abnormalities status.

In some examples, the pre-trained deep learning model comprises a U-Net model with an encoder block and a decoder block, multiple convolutional layers in the encoder block to transform the input HR-pQCT image data into feature space, multiple upsampling layers in the decoder block to reconstruct the segmented cortical bone regions from lower-level feature information, skip connections between corresponding layers of the encoder and decoder blocks to maintain consistency with the original input, and an edge enhancer block to transfer edge information from the input to the final output.

In some examples, a method can include analyzing bone biomarkers from blood tests including parathyroid hormone (PTH), estimated glomerular filtration rate (eGFR), fibroblast growth factor 23 (FGF-23), or alpha-Klotho in combination with the extracted radiomic features to generate additional input features for the machine learning classifier.

Some examples of the disclosure provide a non-transitory computer-readable medium storing instructions that, when executed by one or more processors, cause the one or more processors to perform operations comprising receiving high-resolution peripheral quantitative computed tomography (HR-pQCT) image data of a bone, segmenting cortical bone regions in the HR-pQCT image data using a pre-trained deep learning model, extracting radiomic features from the segmented cortical bone regions, wherein the radiomic features may include first-order statistics, texture features (second-order), or higher-order statistics, and classifying the bone as belonging to a chronic kidney disease (CKD) group or a non-CKD group using a machine learning classifier trained on the extracted radiomic features.

In some examples, the operations further comprise preprocessing the HR-pQCT image data by performing gray-level normalization and discretization, dividing each image stack into proximal and distal subregions, and applying a feature selection process to identify key radiomic features, wherein the feature selection process includes removing features with variance below a first threshold and intercorrelation above a second threshold.

In some examples, the optimal first threshold is 0.20 and the optimal second threshold is 0.80.

In some examples, extracting radiomic features comprises calculating Gray Level Co-occurrence Matrix (GLCM) features from the segmented cortical bone regions and deriving at least one texture descriptor from the GLCM.

In some examples, the operations further comprise extracting Neighboring Gray Tone Difference Matrix (NGTDM) features from the segmented cortical bone regions. The NGTDM features include Strength. The operations further comprise using the NGTDM Strength feature as an input to the machine learning classifier to distinguish between CKD and non-CKD bone images based on the quantification of texture strength.

In some examples, extracting radiomic features further comprises calculating Local Binary Pattern (LBP) features from the segmented cortical bone regions and combining the LBP features with Gray Level Co-occurrence Matrix (GLCM) features to create a combined feature set that captures bone texture details indicative of CKD-related cortical bone deterioration.

In some examples, classifying the bone comprises training a gradient boosted machine learning classifier using the extracted radiomic features and features from the pre-trained deep learning model, determining hyperparameters of the gradient boosted classifier through cross-validation, and applying the trained gradient boosted classifier to new HR-pQCT image data to predict CKD bone abnormalities status.

In some examples, the pre-trained deep learning model comprises a U-Net model with an encoder block and a decoder block, multiple convolutional layers in the encoder block to transform the input HR-pQCT image data into feature space, multiple upsampling layers in the decoder block to reconstruct the segmented cortical bone regions from lower-level feature information, skip connections between corresponding layers of the encoder and decoder blocks to maintain consistency with the original input, and an edge enhancer block to transfer edge information from the input to the final output.

In some examples, the operations further comprise analyzing bone biomarkers from blood tests including parathyroid hormone (PTH), estimated glomerular filtration rate (eGFR), fibroblast growth factor 23 (FGF-23), or alpha-Klotho in combination with the extracted radiomic features to generate additional input features for the machine learning classifier.

Some examples of the disclosure provide a method for analyzing bone images. The method can include receiving high-resolution peripheral quantitative computed tomography (HR-pQCT) image data of a bone, segmenting cortical bone regions in the HR-pQCT image data using a pre-trained machine learning model, extracting radiomic features from the segmented cortical bone regions, and classifying, using the extracted radiomic features, the bone as belonging to a chronic kidney disease (CKD) group or a non-CKD group using a machine learning classifier.

In some examples, a machine learning classifier can be trained on previously extracted radiomic features by processing previous HR-pQCT image data by performing gray-level normalization and discretization, dividing each previous HR-pQCT image into proximal and distal subregions, and applying a feature selection process to identify key radiomic features to determine the previously extracted radiomic features. The feature selection process ca include removing features with variance below a first threshold and intercorrelation above a second threshold.

In some examples, a first threshold is 0.20 and a second threshold is 0.80.

In some examples, extracting radiomic features can include calculating Gray Level Co-occurrence Matrix (GLCM) features from the segmented cortical bone regions and deriving at least one texture descriptor from the GLCM.

In some examples, a method can include extracting Neighboring Gray Tone Difference Matrix (NGTDM) features from the segmented cortical bone regions. The NGTDM features can include strength. The method can include using the NGTDM strength feature as an input to a machine learning classifier to distinguish between CKD and non-CKD bone images based on a quantification of the strength feature.

In some examples, extracting radiomic features comprises calculating Local Binary Pattern (LBP) features from the segmented cortical bone regions, and combining the LBP features with Gray Level Co-occurrence Matrix (GLCM) features to create a combined feature set that captures bone texture details indicative of CKD-related cortical bone.

In some examples, a machine learning classifier is a gradient boosted machine learning classifier.

In some examples, a method can include analyzing bone biomarkers from blood tests including parathyroid hormone (PTH), estimated glomerular filtration rate (eGFR), fibroblast growth factor 23 (FGF-23), or alpha-Klotho in combination with extracted radiomic features to generate additional input features for a machine learning classifier.

Some examples of the disclosure provide a method. The method can include receiving one or more images of a region of a subject, the region including a tissue, segmenting, using a trained image segmentation model, the tissue from each image of the one or more images to output a segmented image, extracting features from each segmented image of the one or more segmented images, and outputting a classification for a subject by providing the extracted features to a trained classification model, the classification including a presence of a medical condition or an absence of a medical condition, the medical condition being at least one of a bone abnormality or chronic kidney disease (CKD).

In some examples, a tissue is cortical bone. The medical condition can be chronic kidney disease (CKD).

In some examples, one or more images are high-resolution peripheral quantitative computed tomography (HR-pQCT) images.

In some examples, a classification indicates a stage of CKD.

In some examples, an image segmentation model is anatomical region specific or a trained classification model is anatomical region specific.

In some examples, a trained classification model is an ensemble classifier.

Some examples of the disclosure provide a method. The method can include receiving an image of a bone of a subject, segmenting, using a trained image segmentation model, the image to output a segmented image, the segmented image including cortical bone, wherein the trained image segmentation model has been trained to identify cortical bone in an image, extracting radiomic features from the segmented image, and outputting a classification for a subject by providing the extracted features to a trained classification model, the classification including a presence of chronic kidney disease (CKD) or an absence of CKD.

In some examples, a trained classification model is an ensemble classifier having a plurality of weak models.

In some examples, an image is a peripheral quantitative computed tomography (HR-pQCT) image.

In some examples, a classification includes a stage of CKD.

In some examples, extracted radiomic features include at least one of a first order radiomic feature, a second order radiomic feature, or a third order radiomic feature.

In some examples, a machine learning model includes the trained image segmentation model and the trained classification model. An image is provided to the machine learning model and the machine learning model outputs a classification.

### DESCRIPTION OF THE DRAWINGS

FIG. 1 shows a block diagram of an example of image reconstruction system according to some examples described in the present disclosure.

FIG. 2 shows a block diagram of example components that can implement the system of FIG. 1.

FIG. 3 shows a schematic illustration of a block diagram of an imaging system.

FIG. 4 shows an example of an imaging system.

FIG. 5 shows a schematic illustration of a block diagram of a machine learning model.

FIG. 6 shows plurality of machine learning models.

FIG. 7 shows a plurality of segmentation models.

FIG. 8 shows an example of a classification model.

FIG. 9 shows a flowchart of a process for training a machine learning model.

FIG. 10 shows a flowchart of a process for training a classification model.

FIG. 11 shows a flowchart of a process for classifying an image, a subject, etc., for example, performing a classification.

FIG. 12A shows a flow diagram for study inclusion.

FIG. 12B shows a 3D cross-sectional rendering of the distal and diaphyseal tibial image stack with the analysis subregions comprise of 10 consecutive slices depicted in green and blue for the distal and proximal subregions, respectively.

FIGS. 13A and 13B show radiomics-driven HR-pQCT texture analysis workflows.

FIG. 14A is the feature selection using variance and intercorrelation analysis which was performed at the distal sites at the proximal and distal subregions of the tibia.

FIG. 14B shows the feature selection using variance and intercorrelation analysis, which was performed at the diaphyseal sites at the proximal and distal subregions of the tibia.

FIG. 15A shows the ranked features from the distal tibia image stack. After excluding low variance and highly inter-correlated features, the remaining features were normalized and ranked by importance, with values closer to 1.0 indicating higher importance and values closer to 0 indicating lower importance for CKD in the proximal subregion.

FIG. 15B shows the ranked features from the distal tibia image stack. After excluding low variance and highly inter-correlated features, the remaining features were normalized and ranked by importance, with values closer to 1.0 indicating higher importance and values closer to 0 indicating lower importance for the non-CKD in the proximal subregion.

FIG. 15C shows the ranked features from the distal tibia image stack. After excluding low variance and highly inter-correlated features, the remaining features were normalized and ranked by importance, with values closer to 1.0 indicating higher importance and values closer to 0 indicating lower importance for CKD in the distal subregion.

FIG. 15D shows the ranked features from the distal tibia image stack. After excluding low variance and highly inter-correlated features, the remaining features were normalized and ranked by importance, with values closer to 1.0 indicating higher importance and values closer to 0 indicating lower importance for non-CKD in the distal subregion.

FIG. 16A shows the ranked features from the diaphyseal tibia image stack. After excluding low variance and highly inter-correlated features, the remaining features were normalized and ranked by importance, with values closer to 1.0 indicating higher importance and values closer to 0 indicating lower importance for the CKD in the proximal subregion.

FIG. 16B shows the ranked features from the diaphyseal tibia image stack. After excluding low variance and highly inter-correlated features, the remaining features were normalized and ranked by importance, with values closer to 1.0 indicating higher importance and values closer to 0 indicating lower importance for the non-CKD in the proximal subregion.

FIG. 16C shows the ranked features from the diaphyseal tibia image stack. After excluding low variance and highly inter-correlated features, the remaining features were normalized and ranked by importance, with values closer to 1.0 indicating higher importance and values closer to 0 indicating lower importance for the CKD in the distal subregion.

FIG. 16D shows the ranked features from the diaphyseal tibia image stack. After excluding low variance and highly inter-correlated features, the remaining features were normalized and ranked by importance, with values closer to 1.0 indicating higher importance and values closer to 0 indicating lower importance for the non-CKD in the distal subregion.

FIG. 17A shows a radiomic feature map that shows differences in heterogeneity of bone texture between CKD and non-CKD tibial HR-pQCT images. The local entropy feature highlights areas with varying degrees of texture complexity, with higher values indicating regions of more complex structure. In CKD, one of the top-ranked features is NGTDM-Strength, which indicates the degree of heterogeneity. In non-CKD, one of the most important features is First Order-Minimum, which focuses on regions with low signal intensities. Values, closer to red, indicate areas with more intense signals based on the feature being overlayed.

FIG. 17B shows a box plot demonstrating the average NGTDM-Strength in the distal tibial image stack in the proximal (left) and distal (right) subregions, respectively.

FIG. 17C shows a box plot demonstrating the average First Order-Minimum in the distal tibial image stack in the proximal (left) and distal (right) subregions, respectively

FIG. 17D shows a box plot demonstrating the diaphyseal tibia stack for NGTDM-Strength.

FIG. 17E shows a box plot demonstrating the diaphyseal tibia stack for First Order-Minimum.

FIG. 17F shows CKD and non-CKD original HR-pQCT images along with radiomics feature maps extracted from each.

FIG. 18A-1-18A-2 shows a comparative correlation analysis of bone texture features in CKD patients at a distal tibia site in the proximal region.

FIG. 18B-1-18B-4 shows a comparative correlation analysis of bone texture features in CKD patients at a diaphyseal tibia in the proximal region.

FIG. 19A-1-19A-2 shows a comparative correlation analysis of bone texture features in CKD patients at a distal tibia in the distal region.

FIG. 19B-1-18B-4 shows a comparative correlation analysis of bone texture features in CKD patients at a diaphyseal tibia in the distal region.

FIG. 20A-1-20A-4 shows a comparative correlation analysis of bone texture features in non-CKD patients at a distal tibia site in the proximal region.

FIG. 20B shows a comparative correlation analysis of bone texture features in non-CKD patients at a diaphyseal tibia site in the proximal region.

FIG. 21A-1-21A-4 shows a comparative correlation analysis of bone texture features in non-CKD patients at a distal tibia site in the distal region.

FIG. 21B-1-21B-2 shows a comparative correlation analysis of bone texture features in non-CKD patients at a diaphyseal tibia site in the distal region.

FIG. 22A shows a distribution of feature correlations for CKD patients at a distal tibia site in the proximal region.

FIG. 22B shows a distribution of feature correlations for non-CKD patients at a distal tibia site in the proximal region.

FIG. 22C shows a distribution of feature correlations for CKD patients at a diaphyseal tibia site in the proximal region.

FIG. 22D shows a distribution of feature correlations for non-CKD patients at a diaphyseal tibia site in the proximal region.

FIG. 23A shows a distribution of feature correlations for CKD patients at a distal tibia site in the distal region.

FIG. 23B shows a distribution of feature correlations for non-CKD patients at a distal tibia site in the distal region.

FIG. 23C shows a distribution of feature correlations for CKD patients at a diaphyseal tibia site in the distal region.

FIG. 23D shows a distribution of feature correlations for non-CKD patients at a diaphyseal tibia site in the distal region.

FIG. 24 shows a flow diagram for image inclusion.

FIG. 25A-25B shows a workflow of the two-Stage cortical bone analysis using HR-pQCT.

FIGS. 26A-D show confusion matricies for binary (non-CKD, CKD) classification using the optimized XGBoost classification models in the study cohort.

FIG. 27 shows a flow diagram for image inclusion for another study.

FIG. 28A-28C shows another workflow of the two-Stage cortical bone analysis using HR-pQCT.

FIGS. 29A and B show AUC-ROC curves for discriminating CKD patients from non-CKD participants using HR-pQCT cortical bone radiomics.

FIGS. 30A-F show confusion matrices for binary (non-CKD, CKD) classification using the top three ML classifiers from (A) Decision Tree, (B) Random Forest, and (C) XGBoost based on distal tibia cortical bone, and (D) Decision Tree, (E) Random Forest, and (F) XGBoost based on diaphyseal tibia cortical bone.

FIG. 31 shows a ROC curve comparison of feature selection methods with 10-fid cross-validation.

FIG. 32 shows performance metrics across feature selection methods.

### DETAILED DESCRIPTION

Individuals with chronic kidney disease (“CKD”) have up to 17 times higher risk of fracture than those without CKD. Unlike other diseases that impact the skeleton, bone changes in CKD are highly heterogeneous and extend beyond osteoporosis. CKD predominantly affects cortical bone—the dense, compact tissue forming the outer layer of long bones. Cortical bone changes in CKD lead to increased porosity, cortical thinning, and alterations in intracortical composition, including a reduction in bound water and changes in collagen crosslinking. These changes weaken the bone, making it more prone to fracture. Therefore, it is important for individuals to know that they have CKD to avoid risks that could lead to breaks and fractures of their more fragile bones.

In clinical practice, circulating biomarkers such as parathyroid hormone (“PTH”) and vitamin D levels are typically evaluated first as part of the fracture risk work-up before proceeding to imaging. While dual-energy X-ray absorptiometry (“DXA”) is the most used imaging modality due to its accessibility and ease, it often underestimates fracture risk in individuals with CKD. This is because DXA utilizes 2-dimensional projection images that do not assess bone quality or distinguish between outer cortical and inner trabecular bone. Accordingly, some imaging modalities can fail to capture the differences between CKD bones and non-CKD bones. That is, such images cannot be used to detect CKD versus non-CKD bones since the information is not present in the images.

Some examples of the disclosure provide advantages that address one or more of these issues, and others, by providing improved systems and methods for CKD classification. For example, some examples of the disclosure provide a more robust process of classifying bone images into CKD and non-CKD classes. As described above, some imaging modalities lack the ability (e.g., due to inadequate resolution) to identify differences between CKD and non-CKD bone images. Other imaging modalities, such as high-resolution peripheral quantitative computed tomography (“HR-pQCT”) having a nominal isotropic voxel size (60-80 μm) and low effective radiation dose (3-5 μSv), micro CT, etc., have sufficient resolution to capture differences in bone morphology between CKD and non-CKD. However, radiologists (and other practitioners) are not able to visually distinguish those differences. That is, although such differences are present between CKD and non-CKD bone images, a practitioner is unable to visually inspect, uncover, or find such differences.

An approach described herein allows for a robust classification of bones (and subjects) into CKD and non-CKD classes. For example, a machine learning model may segment bone images (e.g., having a sufficient imaging resolution, such as, an HR-pQCT image) to extract cortical bone regions of an image (e.g., removes or rejects other tissue types, such as trabecular bone). Radiomic features may be extracted from the segmented images, and refined to decrease the overall feature set. These extracted features (e.g., refined as a feature set) are used to train a classification model (e.g., a machine learning classifier). Then, images (e.g., from a real-time acquisition) having sufficient resolution may be provided to the machine learning model to segment the images, radiomic features may be extracted from those images (e.g., at least some of the same types of features used to train the classification model), and the extracted radiomic features may be provided to the trained classification model that outputs a classification as CKD or non-CKD (for the subject or bone). Leveraging radiomic features provides a consistent way to discern differences between classes (e.g., CKD versus non-CKD), which are invisible to a user using visual inspection. Further, training a classifier using machine learning segmentation can further improve the consistency, since manual segmentation (e.g., by a user) may introduce undesirable variabilities.

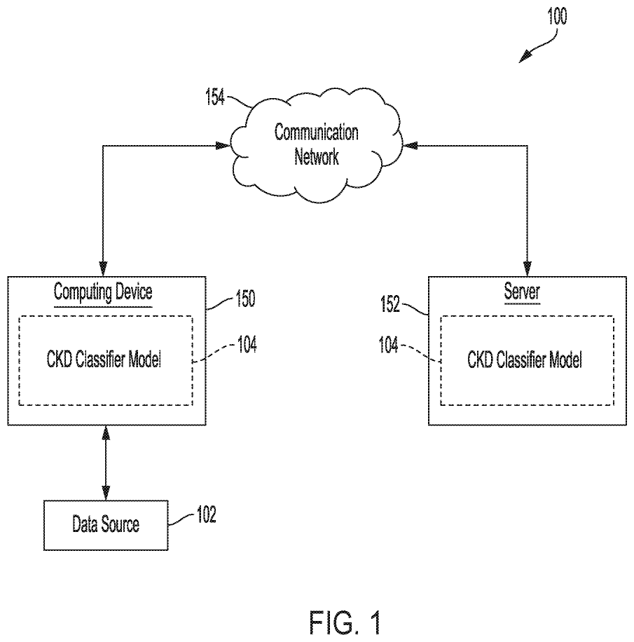

FIG. 1 shows an example of a system 100 for reconstructing medical image data in accordance with some examples described in the present disclosure. As shown in FIG. 1, a computing device 150 can receive one or more types of data (e.g., CT image data) from a data source 102. In some examples, computing device 150 can execute at least a portion of a CKD classifier model 104 to generate medical image data (e.g., cortical bone HR-pQCT images) from data received from the data source 102.

Additionally, or alternatively, in some examples, the computing device 150 can communicate information about data received from the data source 102 to a server 152 over a communication network 154, which can execute at least a portion of a CKD classifier model 104. In such examples, the server 152 can return information to the computing device 150 (and/or any other suitable computing device) indicative of an output of a CKD classifier model 104.

In some examples, computing device 150 and/or server 152 can be any suitable computing device or combination of devices, such as a desktop computer, a laptop computer, a smartphone, a tablet computer, a wearable computer, a server computer, a virtual machine being executed by a physical computing device, and so on. The computing device 150 and/or server 152 can also reconstruct images from the data.

In some examples, data source 102 can be any suitable source of data (e.g., measurement data, images reconstructed from measurement data, processed image data), such as a medical imaging system (e.g., a CT system, a PET system, MRI system, an x-ray, etc.), another computing device (e.g., a server storing measurement data, images reconstructed from measurement data, processed image data), and so on. In some examples, data source 102 can be local to computing device 150. For example, data source 102 can be incorporated with computing device 150 (e.g., computing device 150 can be configured as part of a device for measuring, recording, estimating, acquiring, or otherwise collecting or storing data). As another example, data source 102 can be connected to computing device 150 by a cable, a direct wireless link, and so on. Additionally, or alternatively, in some examples, data source 102 can be located locally and/or remotely from computing device 150, and can communicate data to computing device 150 (and/or server 152) via a communication network (e.g., communication network 154).

In some examples, communication network 154 can be any suitable communication network or combination of communication networks. For example, communication network 154 can include a Wi-Fi network (which can include one or more wireless routers, one or more switches, etc.), a peer-to-peer network (e.g., a Bluetooth network), a cellular network (e.g., a 3G network, a 4G network, etc., complying with any suitable standard, such as CDMA, GSM, LTE, LTE Advanced, WiMAX, etc.), other types of wireless network, a wired network, and so on. In some examples, communication network 154 can be a local area network, a wide area network, a public network (e.g., the Internet), a private or semi-private network (e.g., a corporate or university intranet), any other suitable type of network, or any suitable combination of networks. Communications links shown in FIG. 1 can each be any suitable communications link or combination of communications links, such as wired links, fiber optic links, Wi-Fi links, Bluetooth links, cellular links, and so on.

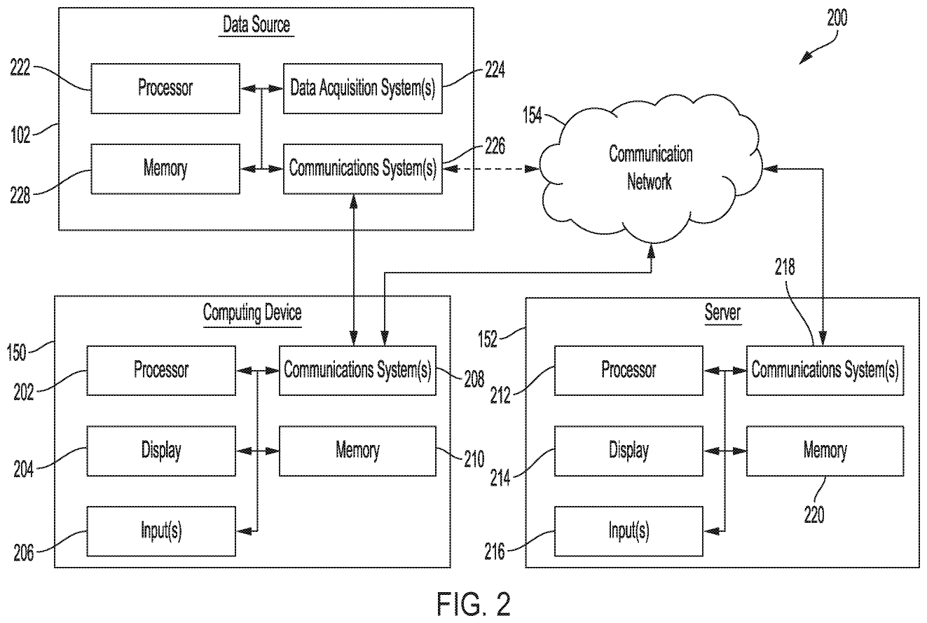

Referring now to FIG. 2, an example of hardware 200 that can be used to implement the data source 102, the computing device 150, and the server 152 in accordance with some examples of the systems and methods described in the present disclosure is shown.

As shown in FIG. 2, in some examples, the computing device 150 can include a processor 202, a display 204, one or more inputs 206, one or more communication systems 208, and/or memory 210. In some examples, processor 202 can be any suitable hardware processor or combination of processors, such as a central processing unit (CPU), a graphics processing unit (GPU), and so on. In some examples, display 204 can include any suitable display devices, such as a liquid crystal display (LCD) screen, a light-emitting diode (LED) display, an organic LED (OLED) display, an electrophoretic display (e.g., an “e-ink” display), a computer monitor, a touchscreen, a television, and so on. In some examples, inputs 206 can include any suitable input devices and/or sensors that can be used to receive user input, such as a keyboard, a mouse, a touchscreen, a microphone, and so on.

In some examples, communications systems 208 can include any suitable hardware, firmware, and/or software for communicating information over communication network 154 and/or any other suitable communication networks. For example, communications systems 208 can include one or more transceivers, one or more communication chips and/or chip sets, and so on. In a more particular example, communications systems 208 can include hardware, firmware, and/or software that can be used to establish a Wi-Fi connection, a Bluetooth connection, a cellular connection, an Ethernet connection, and so on.

In some examples, memory 210 can include any suitable storage device or devices that can be used to store instructions, values, data, or the like, that can be used, for example, by processor 202 to present content using display 204, to communicate with server 152 via communications system(s) 208, and so on. Memory 210 can include any suitable volatile memory, non-volatile memory, storage, or any suitable combination thereof. For example, memory 210 can include random-access memory (RAM), read-only memory (ROM), electrically programmable ROM (EPROM), electrically erasable ROM (EEPROM), other forms of volatile memory, other forms of non-volatile memory, one or more forms of semi-volatile memory, one or more flash drives, one or more hard disks, one or more solid state drives, one or more optical drives, and so on. In some examples, memory 210 can have encoded thereon, or otherwise stored therein, a computer program for controlling operation of computing device 150. In such examples, processor 202 can execute at least a portion of the computer program to present content (e.g., images, user interfaces, graphics, tables), receive content from server 152, transmit information to server 152, and so on. For example, the processor 202 and the memory 210 can be configured to perform the methods described herein.

In some examples, server 152 can include a processor 212, a display 214, one or more inputs 216, one or more communications systems 218, and/or memory 220. In some examples, processor 212 can be any suitable hardware processor or combination of processors, such as a CPU, a GPU, and so on. In some examples, display 214 can include any suitable display devices, such as an LCD screen, LED display, OLED display, electrophoretic display, a computer monitor, a touchscreen, a television, and so on. In some examples, inputs 216 can include any suitable input devices and/or sensors that can be used to receive user input, such as a keyboard, a mouse, a touchscreen, a microphone, and so on.

In some examples, communications systems 218 can include any suitable hardware, firmware, and/or software for communicating information over communication network 154 and/or any other suitable communication networks. For example, communications systems 218 can include one or more transceivers, one or more communication chips and/or chip sets, and so on. In a more particular example, communications systems 218 can include hardware, firmware, and/or software that can be used to establish a Wi-Fi connection, a Bluetooth connection, a cellular connection, an Ethernet connection, and so on.

In some examples, memory 220 can include any suitable storage device or devices that can be used to store instructions, values, data, or the like, that can be used, for example, by processor 212 to present content using display 214, to communicate with one or more computing devices 150, and so on. Memory 220 can include any suitable volatile memory, non-volatile memory, storage, or any suitable combination thereof. For example, memory 220 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some examples, memory 220 can have encoded thereon a server program for controlling operation of server 152. In such examples, processor 212 can execute at least a portion of the server program to transmit information and/or content (e.g., data, images, a user interface) to one or more computing devices 150, receive information and/or content from one or more computing devices 150, receive instructions from one or more devices (e.g., a personal computer, a laptop computer, a tablet computer, a smartphone), and so on.

In some examples, the server 152 is configured to perform the methods described in the present disclosure. For example, the processor 212 and memory 220 can be configured to perform the methods described herein.

In some examples, data source 102 can include a processor 222, one or more data acquisition systems 224, one or more communications systems 226, and/or memory 228. In some examples, processor 222 can be any suitable hardware processor or combination of processors, such as a CPU, a GPU, and so on. In some examples, the one or more data acquisition systems 224 are generally configured to acquire data, images, or both, and can include a medical imaging system. Additionally or alternatively, in some examples, the one or more data acquisition systems 224 can include any suitable hardware, firmware, and/or software for coupling to and/or controlling operations of a CT system. In some examples, one or more portions of the data acquisition system(s) 224 can be removable and/or replaceable.

Note that, although not shown, data source 102 can include any suitable inputs and/or outputs. For example, data source 102 can include input devices and/or sensors that can be used to receive user input, such as a keyboard, a mouse, a touchscreen, a microphone, a trackpad, a trackball, and so on. As another example, data source 102 can include any suitable display devices, such as an LCD screen, an LED display, an OLED display, an electrophoretic display, a computer monitor, a touchscreen, a television, etc., one or more speakers, and so on.

In some examples, communications systems 226 can include any suitable hardware, firmware, and/or software for communicating information to computing device 150 (and, in some examples, over communication network 154 and/or any other suitable communication networks). For example, communications systems 226 can include one or more transceivers, one or more communication chips and/or chip sets, and so on. In a more particular example, communications systems 226 can include hardware, firmware, and/or software that can be used to establish a wired connection using any suitable port and/or communication standard (e.g., VGA, DVI video, USB, RS-232, etc.), Wi-Fi connection, a Bluetooth connection, a cellular connection, an Ethernet connection, and so on.

In some examples, memory 228 can include any suitable storage device or devices that can be used to store instructions, values, data, or the like, that can be used, for example, by processor 222 to control the one or more data acquisition systems 224, and/or receive data from the one or more data acquisition systems 224; to generate images from data; present content (e.g., data, images, a user interface) using a display; communicate with one or more computing devices 150; and so on. Memory 228 can include any suitable volatile memory, non-volatile memory, storage, or any suitable combination thereof. For example, memory 228 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some examples, memory 228 can have encoded thereon, or otherwise stored therein, a program for controlling operation of data source 102. In such examples, processor 222 can execute at least a portion of the program to generate images, transmit information and/or content (e.g., data, images, a user interface) to one or more computing devices 150, receive information and/or content from one or more computing devices 150, receive instructions from one or more devices (e.g., a personal computer, a laptop computer, a tablet computer, a smartphone, etc.), and so on.

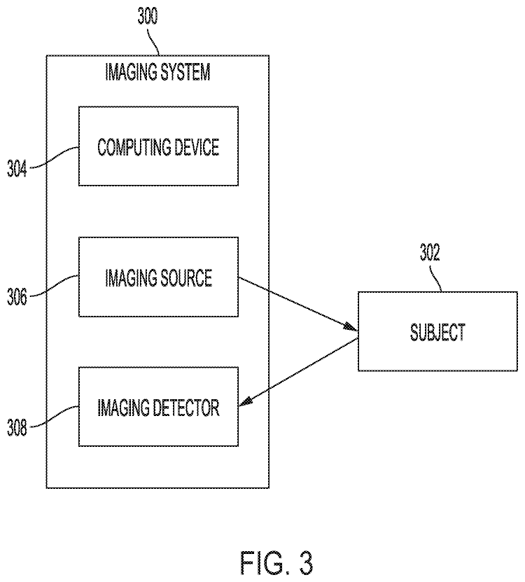

FIG. 3 shows a schematic illustration of a block diagram of an imaging system 300. The imaging system 300 can be configured to acquire one or more images of a subject 302 (e.g., a patient), in which the one or more images of the subject 302 can include one or more regions of interest. In some cases, the one or more images acquired can be of one or more portions of the subject 302, such as, for example, one or more limbs (e.g., an arm, a leg, etc.). The imaging system 300 can include a computing device 304, an imaging source 306, and an imaging detector 308. The imaging system 300, and specifically, the computing device 304 can cause the imaging source 306 to emit light (e.g., excitation light, x-rays, etc.) towards the subject 302 and receive light in response to the subject 302, which can be received at the imaging detector 308 to acquire an image of the subject 302 (e.g., imaging data that is later reconstructed). In some cases, the imaging source 306 and the imaging detector 308 can be coupled together, such that, movement of the imaging source 306 (e.g., rotation) also moves the imaging detector 308 (and vice versa).

In some cases, the imaging system 300 can be a computed tomography (“CT”) imaging system, a cone beam CT imaging system, a peripheral quantitative CT (“pQCT”) imaging system, a high resolution pQCT (“HR-pQCT”) imaging system, as micro-CT imaging system, an X-ray imaging system, a fluoroscopy imaging system, etc.

In some cases, each image of the one or more images acquired by the imaging system 300 can be high resolution images. In some cases, the one or more images acquired by the imaging system 300 can occur during an image acquisition time period. In some cases, the effective spatial resolution of each image can be greater than about 60 μm, less than about 100 μm, etc. In some cases, the effective spatial resolution can be less than about 100 μm, less than about 60 μm, less than about 20 μm (e.g., corresponding to micro-CT), etc. In some cases, the one or more images can be acquired over a period of time greater than one second, two seconds, etc. In some cases, the period of time can be greater than or equal to a corresponding physiological time window (e.g., the duration of a breath, such as during thoracic imaging).

In some cases, the one or more images can be of multiple different regions of a subject. For example, the one or more images can include an image of a first limb (e.g., arm) and an image of a second limb (e.g., a leg). In some cases, the one or more images can includes images of different regions of a limb of the subject. For example, the one or more images can include an image of a first region of the first limb (e.g., a distal region), an image of a second region of the first limb (e.g., a diaphyseal region), an image of a third region of a second limb (e.g., a distal region), and an image of a fourth region of the second limb (e.g., a diaphyseal region). In some cases, the first limb can be an arm (e.g., including a radius bone) and the second limb can be a leg (e.g., including a tibia bone). The radius and tibia are standard clinical scan sites for HR-pQCT. The distal region (e.g., approximately 4% or 7.3% proximal to the reference line) and the diaphyseal region (e.g., approximately 30% proximal to the reference line) can be selected because the two regions exhibit distinct cortical bone characteristics—the distal region tends to have thinner, more porous cortex while the diaphyseal region tends to have thicker, more uniform cortex—and thus may exhibit different predictive power for CKD classification. In some cases, the diaphyseal region, particularly of the tibia, may provide higher classification performance than the distal region.

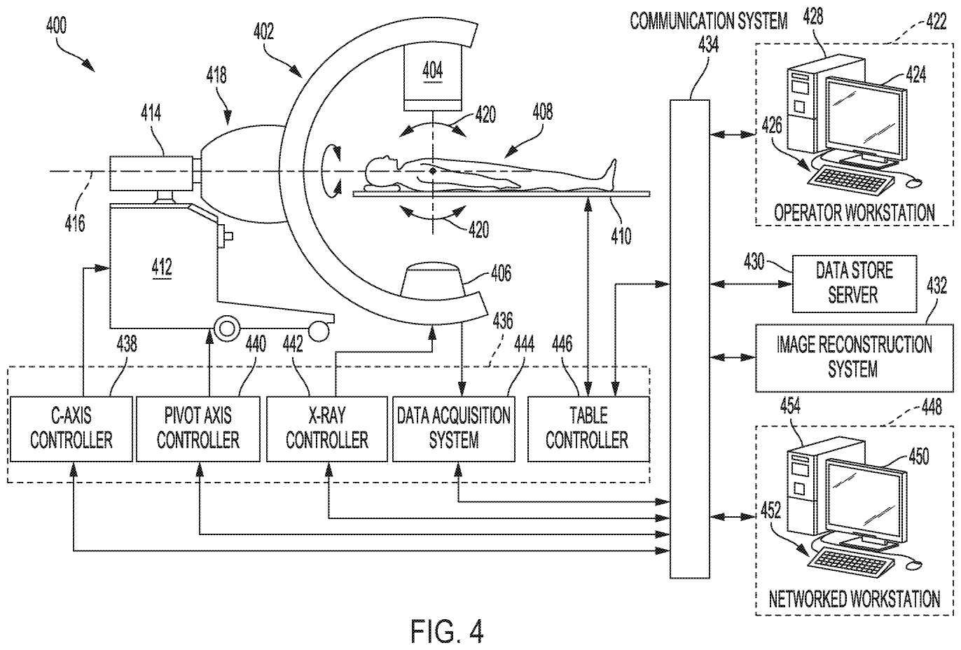

FIG. 4 shows an example of an imaging system 400, which can be a specific implementation of the imaging system 300. Accordingly, the description of the imaging system 300 pertains to the imaging system 400 and vice versa. The imaging system 400 can be used with the systems and methods of the present disclosure. The imaging system 400 can be a so-called “C-arm” x-ray imaging system. In other configurations, however, the imaging system 400 can be a fixed-position, a single-source, a bi-plane, or other architecture.

In the example of FIG. 4, the C-arm x-ray imaging system 400 includes a gantry 402 having a C-arm to which an x-ray source assembly 404 is coupled on one end and an x-ray detector array assembly 406 is coupled at its other end. The gantry 402 enables the x-ray source assembly 404 and detector array assembly 406 to be oriented in different positions and angles around a subject 408, such as a medical patient or an object undergoing examination that is positioned on a table 410. When the subject 408 is a medical patient, this configuration enables a physician access to the subject 408.

The x-ray source assembly 404 includes at least one x-ray source that projects an x-ray beam, which may be a fan-beam or cone-beam of x-rays, towards the x-ray detector array assembly 406 on the opposite side of the gantry 402. The x-ray detector array assembly 406 includes at least one x-ray detector, which may include a number of x-ray detector elements. Examples of x-ray detectors that may be included in the x-ray detector array assembly 406 include flat panel detectors, such as so-called “small flat panel” detectors, in which the detector array panel may be around centimeters in size. Such a detector panel allows the coverage of a field-of-view of approximately twelve centimeters.

Together, the x-ray detector elements in the one or more x-ray detectors housed in the x-ray detector array assembly 406 sense the projected x-rays that pass through a subject 408. Each x-ray detector element produces an electrical signal that may represent the intensity of an impinging x-ray beam and, thus, the attenuation of the x-ray beam as it passes through the subject 408. In some configurations, each x-ray detector element is capable of counting the number of x-ray photons that impinge upon the detector. During a scan to acquire x-ray projection data, the gantry 402 and the components mounted thereon rotate about an isocenter of the C-arm x-ray imaging system 400.

The gantry 402 includes a support base 412. A support arm 414 is rotatably fastened to the support base 412 for rotation about a horizontal pivot axis 416. The pivot axis 416 is aligned with the centerline of the table 410 and the support arm 414 extends radially outward from the pivot axis 416 to support a C-arm drive assembly 418 on its outer end. The C-arm gantry 402 is slidably fastened to the drive assembly 418 and is coupled to a drive motor (not shown) that slides the C-arm gantry 402 to revolve it about a C-axis, as indicated by arrows 420. The pivot axis 416 and C-axis are orthogonal and intersect each other at the isocenter of the C-arm x-ray imaging system 400, which is indicated by the black circle and is located above the table 410.

The x-ray source assembly 404 and x-ray detector array assembly 406 extend radially inward to the pivot axis 416 such that the center ray of this x-ray beam passes through the system isocenter. The center ray of the x-ray beam can thus be rotated about the system isocenter around either the pivot axis 416, the C-axis, or both during the acquisition of x-ray attenuation data from a subject 408 placed on the table 410. During a scan, the x-ray source and detector array are rotated about the system isocenter to acquire x-ray attenuation projection data from different angles. By way of example, the detector array is able to acquire thirty projections, or views, per second.

The C-arm x-ray imaging system 400 also includes an operator workstation 422, which typically includes a display 424; one or more input devices 426, such as a keyboard and mouse; and a computer processor 428. The computer processor 428 may include a commercially available programmable machine running a commercially available operating system. The operator workstation 422 provides the operator interface that enables scanning control parameters to be entered into the C-arm x-ray imaging system 400. In general, the operator workstation 422 is in communication with a data store server 430 and an image reconstruction system 432. By way of example, the operator workstation 422, data store sever 430, and image reconstruction system 432 may be connected via a communication system 434, which may include any suitable network connection, whether wired, wireless, or a combination of both. As an example, the communication system 434 may include both proprietary or dedicated networks, as well as open networks, such as the internet.

The operator workstation 422 is also in communication with a control system 436 that controls operation of the C-arm x-ray imaging system 400. The control system 436 generally includes a C-axis controller 438, a pivot axis controller 440, an x-ray controller 442, a data acquisition system (“DAS”) 444, and a table controller 446. The x-ray controller 442 provides power and timing signals to the x-ray source assembly 404, and the table controller 446 is operable to move the table 410 to different positions and orientations within the C-arm x-ray imaging system 400.

The rotation of the gantry 402 to which the x-ray source assembly 404 and the x-ray detector array assembly 406 are coupled is controlled by the C-axis controller 438 and the pivot axis controller 440, which respectively control the rotation of the gantry 402 about the C-axis and the pivot axis 416. In response to motion commands from the operator workstation 422, the C-axis controller 438 and the pivot axis controller 440 provide power to motors in the C-arm x-ray imaging system 400 that produce the rotations about the C-axis and the pivot axis 416, respectively. For example, a program executed by the operator workstation 422 generates motion commands to the C-axis controller 438 and pivot axis controller 440 to move the gantry 402, and thereby the x-ray source assembly 404 and x-ray detector array assembly 406, in a prescribed scan path.

The DAS 444 samples data from the one or more x-ray detectors in the x-ray detector array assembly 406 and converts the data to digital signals for subsequent processing. For instance, digitized x-ray data is communicated from the DAS 444 to the data store server 430. The image reconstruction system 432 then retrieves the x-ray data from the data store server 430 and reconstructs an image therefrom. The image reconstruction system 432 may include a commercially available computer processor, or may be a highly parallel computer architecture, such as a system that includes multiple-core processors and massively parallel, high-density computing devices. Optionally, image reconstruction can also be performed on the processor 428 in the operator workstation 422. Reconstructed images can then be communicated back to the data store server 430 for storage or to the operator workstation 422 to be displayed to the operator or clinician.

The C-arm x-ray imaging system 400 may also include one or more networked workstations 448. By way of example, a networked workstation 448 may include a display 450; one or more input devices 452, such as a keyboard and mouse; and a processor 454. The networked workstation 448 may be located within the same facility as the operator workstation 422, or in a different facility, such as a different healthcare institution or clinic.

The networked workstation 448, whether within the same facility or in a different facility as the operator workstation 422, may gain remote access to the data store server 430, the image reconstruction system 432, or both via the communication system 434. Accordingly, multiple networked workstations 448 may have access to the data store server 430, the image reconstruction system 432, or both. In this manner, x-ray data, reconstructed images, or other data may be exchanged between the data store server 430, the image reconstruction system 432, and the networked workstations 448, such that the data or images may be remotely processed by the networked workstation 448. This data may be exchanged in any suitable format, such as in accordance with the transmission control protocol (“TCP”), the Internet protocol (“IP”), or other known or suitable protocols.

Although the disclosure below will described in reference to the use of a biplane fluoroscopy imaging system (e.g., the “C-arm” x-ray imaging system 400), in other non-limiting examples other imaging systems can be utilized (e.g., a single-plane fluoroscopy imaging system).

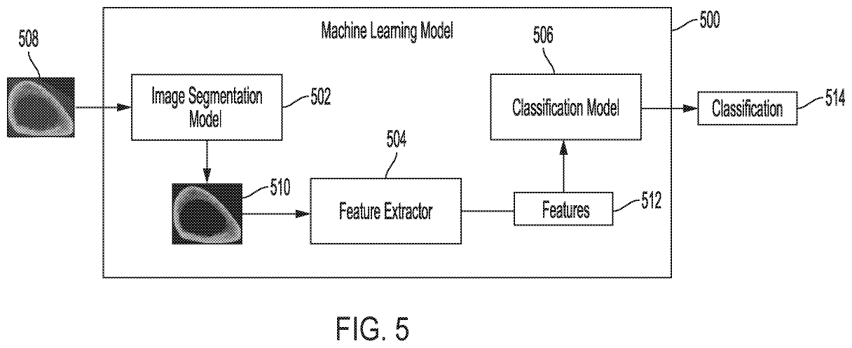

FIG. 5 shows a schematic illustration of a block diagram of a machine learning model 500, which can be used to provide a classification for a subject (e.g., a presence of a medical condition for the subject, a severity of the medical condition of the subject, the presence of an abnormality of the subject, such as, for example, a bone abnormality, etc.). For example, when the machine learning model 500 is trained, the machine learning model 500 can output a classification for a subject. In some cases, the machine learning model 500 (e.g., when trained or after training), and others, can be stored in memory of a computing device (e.g., the computing device 150, 304, etc.).

As shown in FIG. 5, the machine learning model 500 can include an image segmentation model 502, a feature extractor 504, and a classification model 506. The image segmentation model 502 can be a machine learning model (e.g., a deep learning model), which can receive an image and output a segmented image that identifies a region of interest (e.g., a specific tissue type, such as bone type, which can be cortical bone). In some cases, the image segmentation model 502 can remove portions of the inputted image that are not the region of interest (e.g., a different type of region of interest). In some specific cases, the image segmentation model 502 can identify a type of tissue (e.g., cortical bone) and remove the other tissue types from the inputted image (e.g., trabecular bone). The feature extractor 504 can extract features from images to determine texture analysis of the images (e.g., in which features from the texture analysis determine relationships between pixels in images). The feature extractor 504 can extract one or more features from one or more inputted images (e.g., segmented images, original images, raw images, etc.). In some cases, the one or more features can be radiomics features. The one or more features can include features of different orders. For example, the one or more features can include a first order feature, a second order feature, and a third order feature. In some cases, the feature extractor 504 can extract features using gray-level co-occurrence matrices (“GLCMs”), local binary patterns (“LBPs’), both GLCMs and LBPs, etc. In some examples, the one or more features can include contrast, dissimilarity, homogeneity, angular second moment (“ASM”), energy, entropy, etc. The classification model 506 can classify an input image, a plurality of input images, a subject, etc., etc., as having a medical condition (e.g., chronic kidney disease), an abnormality (e.g., a bone abnormality), a severity of a medical condition (e.g., a stage of CKD, such as stage 3, stage 4, stage 5, etc., of CKD), etc. The classification model 506 can perform the classification using the features extracted by the feature extractor 504. In some cases, when both GLCMs and LBPs are used (or two different ways to extract features), the feature extractor 504 can extract a first set of features from the segmented image using GLCM (e.g., contrast, homogeneity, energy, correlation, etc.) and a second set of features from the segmented image using LBP (e.g., uniform pattern histogram bins), and can combine the first set of features and the second set of features into a combined feature set (e.g., by concatenating the first set of features and the second set of features) that is provided to the classification model 506. In some cases, the first set of features can be extracted first, followed by extraction of the second set of features. In other cases, however, the second set of features can be extracted first, followed by extraction of the second set of features.

In some cases, features can be extracted and added to the feature set. For example, non-imaging features can be extracted (e.g., by the feature extractor 504, a different extractor, etc.). In some cases, the non-imaging features can include a blood biomarker, a serum biomarker, etc. In some specific cases, the non-imaging features can include a parathyroid hormone level, a glomerular filtration rate, a fibroblast growth factor level (e.g., fibroblast growth factor 23), an alpha-Klotho level, etc.

FIG. 5 also shows how data, such as real-time data from an imaging system (e.g., HR-pQCT images), flows or is processed by the machine learning model 500 to output a classification. For example, an image 508 is inputted into the image segmentation model 502, which outputs a segmented image 510 that identifies one or more regions of interest of the image 508. For example, the image 508 can be a bone that includes cortical bone and trabecular bone. In this case, the region of interest can be cortical bone, such that the segmented image 510 includes cortical bone (as the region of interest) but has the trabecular bone removed. The segmented image 510 is provided to the feature extractor 504 and one or more features 512 are extracted from the segmented image 510. The features 512 are provided to the classification model 506, which evaluates the features 512 (e.g., comparing the features 512 to previously determined thresholds), and outputs a classification 514. The classification 514 can indicate a presence of a medical condition, a disease, etc., an absence of the medical condition, the disease, etc. The classification 514 can indicate a severity of the medical condition, the disease, etc. For example, the classification 514 can indicate a stage of the medical condition, the disease, etc., or a lack of the stage of the medical condition, the disease, etc. As a more specific example, the classification 514 can be the presence of a stage of CKD (or a lack thereof), such as, for example, stage 3 of CKD, stage 4 of CKD, stage 5 of CKD. In some cases, the classification 514 can indicate the presence of a bone abnormality. Although FIG. 5 shows an inputted image 508 (e.g., for visual simplicity), the machine learning model 500 can receive, process, etc., a plurality of images, in a similar way, to provide the classification 514 In some cases, the machine learning model 500 can also output a confidence score (e.g., a probability value between 0 and 1) associated with the classification 514, where the confidence score indicates a likelihood that the subject or bone belongs to a particular class (e.g., CKD or non-CKD). In some cases, the confidence score can be used to adjust a sensitivity-specificity tradeoff of the classification model (e.g., by adjusting a classification threshold). In some embodiments, the classification 514 can further include a confidence value, probability score, or other likelihood metric corresponding to the determined classification. In some cases, the machine learning model 500, and specifically the classification model 506 of the machine learning model 500, can output the confidence value along with the classification 514.

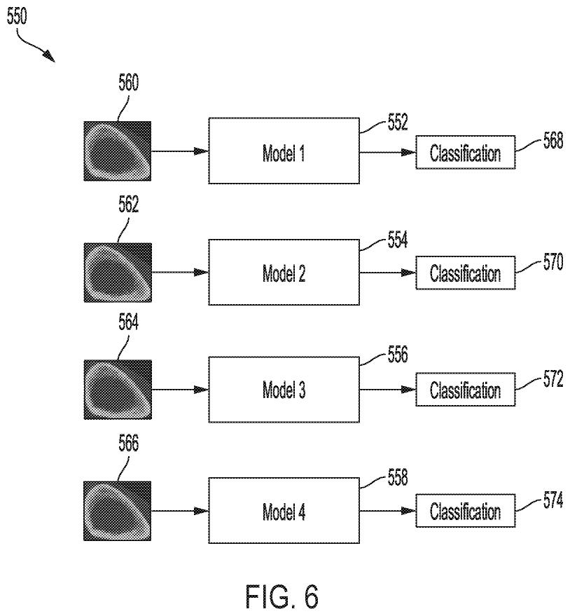

Although FIG. 5 shows the machine learning model 500 as being one machine learning model (e.g., a single machine learning model), in other cases, there can be a plurality of machine learning models, each of which is trained on a specific type of region (e.g., but each identifying or segmenting the same type of region of interest, for example, cortical bone). For example, FIG. 6 shows plurality of machine learning models 550, which can include machine learning models 552, 554, 556, 558. Each machine learning model 552, 554, 556, 558 can provide a classification for a medical condition, as described above, such as for example, the presence of a bone abnormality. Each machine learning model 552, 554, 556, 558 can be implemented in a similar way as the machine learning model 500. However, each machine learning model 552, 554, 556, 558 can be trained on a specific region of interest (e.g., a specific anatomical region of interest), but each machine learning model 552, 554, 556, 558 can evaluate the same tissue type (e.g., cortical bone). In other words, each machine learning model 552, 554, 556, 558 can be trained to identify the same tissue type (e.g., cortical bone) of different regions of interest (e.g., anatomical regions, such as, on different limbs). For example, the machine learning model 552 can be trained to identify cortical bone of the distal radius, and perform a classification using the cortical bone of the distal radius. As another example, the machine learning model 554 can be trained to identify cortical bone of the diaphyseal radius, and perform a classification using the cortical bone of the diaphyseal radius. As yet another example, the machine learning model 556 can be trained to identify cortical bone of the distal tibia, and perform a classification using the cortical bone of the distal tibia. As still yet another example, the machine learning model 558 can be trained to identify cortical bone of the diaphyseal tibia, and perform a classification using the cortical bone of the diaphyseal tibia.

In some cases, each machine learning model 552, 554, 556, 558 can receive one or more input images 560, 562, 564, 566, respectively, and can each output a classification 568, 570, 572, 574, respectively. In some cases, the computing device (e.g., the computing device 150, 304) can use one or more of the classifications 568, 570, 572, 574 to provide the final classification (e.g., for notifying a user, such as a practitioner). In some cases, using multiple models, trained on different anatomical regions can be helpful in identifying anatomical region specific differences between a disease state and a non-disease state. In other words, a disease, condition, severity, etc., may manifest differently across anatomical regions. Accordingly, a machine learning model can be region specific so as to identify and capture these differences as opposed to a generalized model (e.g., not anatomical region specific), that may miss these differences.

In some cases, the plurality of machine learning models 550 can be used as an ensemble, such that the outputs (e.g., classifications 568, 570, 572, 574) of each of the machine learning models 552, 554, 556, 558 are combined (e.g., using a majority vote, weighted sum, etc.) to produce a final classification for the subject. In other cases, the plurality of machine learning models 550 can be used to identify which anatomical region provides the highest classification performance for a given medical condition (e.g., CKD), such that the best-performing model or region can be selected for clinical use. For example, during validation, in which testing data is provided to the plurality of machine learning models 550, the computing device can select the model of the plurality of machine learning models 550 that performs best (e.g., has the highest classification accuracy).

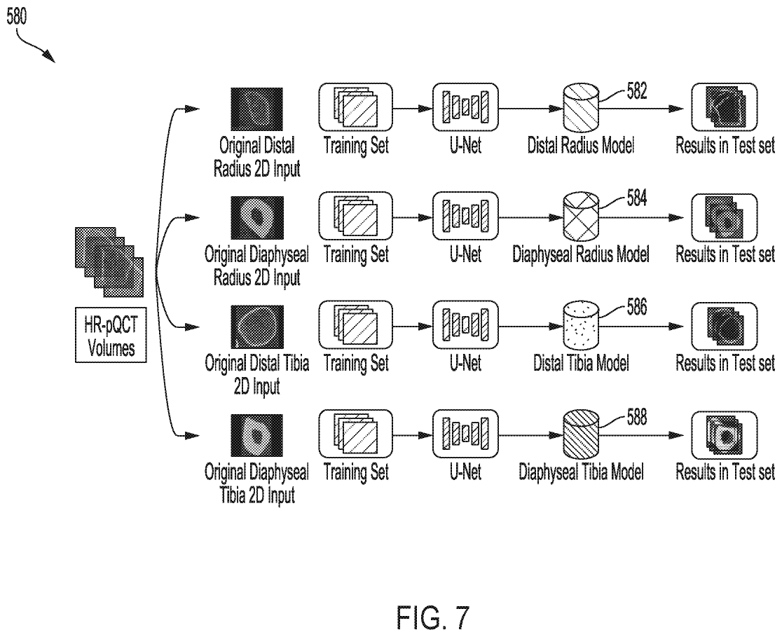

In some cases, each machine learning model 552, 554, 556, 558 can include a plurality of machine learning models (e.g. a plurality of sub machine learning models). For example, FIG. 7 shows a plurality of segmentation models 580 (e.g., machine learning models), which can be trained on a specific region of interest (e.g., an anatomical region of interest, limb specific, bone type specific, bone location specific, etc.). The plurality of segmentation models 580 can include segmentation models 582, 584, 586, 588, which can be a part of the machine learning models 552, 554, 556, 558, respectively (e.g., a sub-model thereof). For example, each segmentation model 582, 584, 586, 588 can be trained to identify a tissue type within a different anatomical region of interest. As a more specific example, the segmentation model 582 can be trained to identify cortical bone (e.g., the tissue type) within a distal radius. As another example, the segmentation model 584 can be trained to identify cortical bone (e.g., the tissue type) within a diaphyseal radius. As yet another example, the segmentation model 586 can be trained to identify cortical bone (e.g., the tissue type) within a distal tibia. As still yet another example, the segmentation model 588 can be trained to identify cortical bone (e.g., the tissue type) within a diaphyseal tibia. In some cases, having different models being trained on different segmentation anatomical regions can identify differences for a specific anatomical region (e.g., where a generalized segmentation model, not anatomical region specific, may miss the region-specific differences).

The model framework as shown in FIG. 7 provides a normalized dataset without other data processing techniques (e.g., to preserve image quality). In some cases, each machine learning model 552, 554, 556, 558 can be a deep learning model, based on a U-net architecture, binary cross-entropy, and Adam optimizer. The learning rate, batch size, and drop-out of each model 552, 554, 556, 558 can be modified to achieve a high performance for each model.

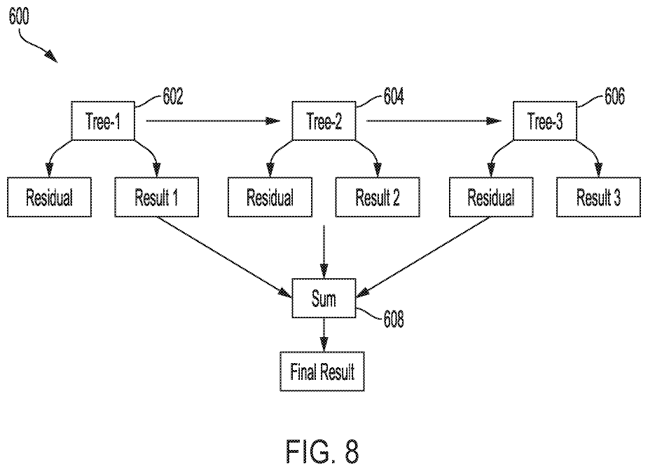

FIG. 8 shows an example of a classification model 600. The classification model 600 is an example of a classification model used in embodiments disclosed herein. For example, the classification model 600 is an example implementation of the classification model 506, in some examples. The classification model 600 can be a machine learning model (e.g., a deep learning model), and more specifically, the classification model 600 can be an ensemble machine learning model (e.g., including an ensemble of models, using ensemble learning, etc.). As shown in FIG. 8, the classification model 600 can include models 602, 604, 606, and a majority gate 608. Each model 602, 604, 606 can be a weak predication model, such as, for example, a decision tree, which can include various nodes and branches. In some cases, each node of a decision tree can be an evaluation of extracted features of the input image(s) relative to a learned threshold (e.g., where the learned threshold is determined using the extracted features during training, such as combinations of the extracted features). The majority gate 608 can receive an output from each model 602, 604, 606, which can be modified by the weight between the particular model and the majority gate 608 (e.g., the weights between each model and the majority gate being adjusted during training). At the majority gate 608 if the sum of the presence of the classification (e.g., CKD present) is greater than the sum of the absence of the classification (e.g., CKD not present), the model 600 outputs the presence of the classification as a result (e.g., the final result). If, however, at the majority gate 608, the sum of the absence of the classification is greater than the sum of the presence of the classification, then the model 600 outputs the absence of the classification as the result.

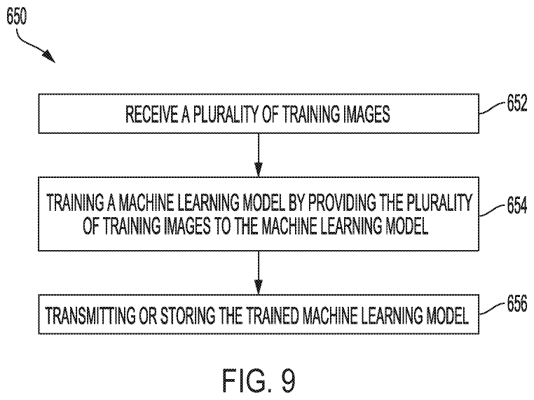

FIG. 9 shows a flowchart of a process 650 for training a machine learning model (e.g., an image segmentation model, such as the image segmentation model 502). The process 650 can be implemented using any of the systems described herein. Further, the process 650 can be implemented using one or more computing devices, as appropriate, and therefore, the process 650 can be a computer-implemented method.

At block 652, the process 650 can include a computing device receiving a plurality of training images. In some cases, the plurality of training images can include pairs of training images, in which each training image pair can include an image of a region of interest and a segmented version of the image (e.g., including only the region of interest). Accordingly, each training image pair can include a raw image and a ground truth image. In some cases, the plurality of training images can be of the same anatomical region, including, for example, the same bone of a subject, the same anatomical region within the same bone, etc. In some specific examples, the region of interest can be a radial bone, a tibial bone, a distal region of the radial bone, a distal region of the tibial bone, a diaphyseal region of the radial bone, a diaphyseal region of the radial bone, etc.

At block 654, the process 650 can include a computing device training a machine learning model by providing the plurality of images to the machine learning model. In some cases, training the machine learning model can include implementing supervised training of the machine learning model. In some cases, once trained, the trained machine learning model can segment a region of interest from an inputted image. For example, the trained machine learning model can segment region of interest having a specific tissue type from the inputted image. As a more specific example, the trained machine learning model can segment cortical bone from the region of interest (e.g., a diaphyseal region of a tribal bone). In some cases, the trained machine learning model can be anatomical region specific (e.g., trained on images from that specific anatomical region).

In some cases, the block 654 of the process 650 can include performing transfer learning. For example, the computing device can receive a first machine learning model (e.g., a standard machine learning model, a machine learning model that can segment images already, a source machine learning model, etc.) and can transfer learning from the first machine learning model into a second machine learning model. For example, this can include freezing one or more layers of the first machine learning model and placing those frozen layers (e.g., including the weights between those layers) into the second machine learning model. Then, the computing device can train the second machine learning model by providing the plurality of images (e.g., received at the block 652) to the second machine learning model without modifying the frozen layers (e.g., but modifying the other layers). In this case, the second machine learning model can be the trained machine learning model (e.g., at the block 654). In some cases, the block 654 can include, during the training process, performing model acceleration on the machine learning model (e.g., where the training after performing transfer learning is the model acceleration).

At block 656, the process 650 can include transmitting or storing the trained machine learning model. In some cases, this can include storing the trained machine learning model in memory of a computing device.

Although the process 650 has been shown for training one machine learning model (e.g., an image segmentation model), the process 650 can be used to train a plurality of machine learning models, for example, a plurality of image segmentation models. For example, the process 650 can be used to train the plurality of machine learning models 550, including, for example, each model 552, 554, 556, 558.

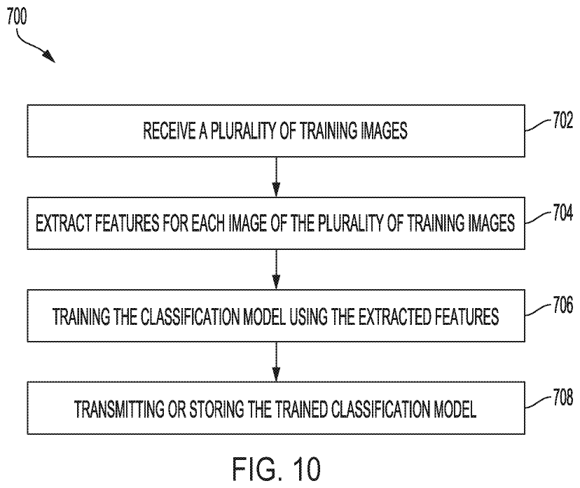

FIG. 10 shows a flowchart of a process 700 for training a classification model (e.g., the classification model 506). The process 700 can be implemented using any of the systems described herein. Further, the process 700 can be implemented using one or more computing devices, as appropriate, and therefore, the process 700 can be a computer-implemented method. In some cases, the classification model can be part of a machine learning model (e.g., the machine learning model 500) or can be separate from a machine learning model (e.g., an image segmentation model). The classification model, when trained, can classify one or more inputted images, a subject (e.g., associated with the one or more input images, etc.), as having a classification including a presence of a medical condition (e.g., CKD, a bone abnormality, etc.), a disease, etc., an absence of the medical condition, the disease, etc., a severity of the medical condition (e.g., a stage of the medical condition), a severity of the disease, a lack of the severity of the medical condition, a lack of the severity of the diseases, etc.

At block 702, the process 700 can include a computing device receiving a plurality of training images. In some cases, each image of the plurality of images can be of the same anatomical region, including, for example, the same bone of a subject, the same anatomical region within the same bone, etc. Each image of the plurality of images can be a segmented image (e.g., received from a trained image segmentation model), which can be of the specific anatomical region. In some cases, each segmented image can include a specific tissue type (e.g., cortical bone) and can lack one or more other tissue types (e.g., trabecular bone). In some cases, each image can be labeled as being from a first class (e.g., having the medical condition, such as CKD) or a second class (e.g., lacking the medical condition, such as CKD).

At block 704, the process 700 can include the computing device extracting features from each image of the plurality of training images. In some cases, this can include using a feature extractor (e.g., the feature extractor 504) to extract the features. In some cases, this can include the computing device using GLCM matrices, LPBs, combinations thereof, etc., to extract the features. In some cases, the block 704 can include the computing device refining the extracted features to produce refined extracted features. In some cases, this can include the computing device removing one or more features (e.g., types of features) from the feature set (e.g., removing poorly performing features). For example, the computing device can remove each feature of the extracted features that has a variance below a threshold (e.g., 0.2) and has an intercorrelation above a threshold (e.g., 0.8). In other words, the computing device can keep each feature of the extracted features that has a variance above the threshold (e.g., 0.2) and has an intercorrelation below the threshold (e.g., 0.8). In some cases, therefore, the extracted features can be refined extracted features (e.g., to be used in the other blocks of the process 700).

In some cases, the block 704 can include extracting one or more non-imaging features and combining them with the extracted imaging features (e.g., by concatenating the non-imaging features and the imaging features together). In some cases, the non-imaging features can include a blood biomarker, a serum biomarker, etc.

At block 706, the process 700 can include the computing device training the classification model using the extracted features (e.g., refined extracted features, refined feature set of the extracted features, etc.). The extracted features can be grouped as a first set of features of the first class (e.g., CKD) and a second set of features of the second class (e.g., no CKD). For example, the extracted features from each image labeled as having the first class can be grouped in the first set of features and the extracted features from each image labeled as having the second class can be grouped in the second set of features. In some cases, the extracted features can include concatenated features derived from combining one or more features of a first set (e.g., using a first extraction method) with one or more features of a second set (e.g., using a second extraction method). For example, a first set of features (e.g., extracted using GLCM) can be concatenated with a second set of features (e.g., extracted using LBP) to output a single feature vector (e.g., which is ultimately inputted to the classification model). In some cases, the block 706 can include a gradient boosting classifier, such as, for example, XGBoost, to sequentially generate a plurality of models (e.g., weak prediction models, decision trees, etc.) For example, the computing device can generate a first decision tree, then can generate a second decision tree that is trained to reduce residual error or loss associated with the first tree, then can generate a third decision tree that is trained to reduce the residual error or loss associated with the first tree (or second tree, or both), and then can generate a fourth decision tree, and so on. The trained ensemble of decision trees can then be used to classify an image, a plurality of images, or a subject as being of a first class (e.g., CKD) or a second class (e.g., non-CKD). For example, by providing each output of each decision tree to a majority gate of the trained ensemble.

At block 708, the process 700 can include transmitting or storing the trained classification model. In some cases, this can include storing the classification machine in memory of a computing device. Although the process 700 has been shown for training one classification model, the process 700 can be used to train a plurality of classification models. For example, the process 700 can be used to train a classification model for each segmentation model. In this way, a machine learning model that includes the classifying model and the image segmentation model, or the classification model and the image segmentation model being separate, but used together, can be region specific (e.g., anatomical region specific).

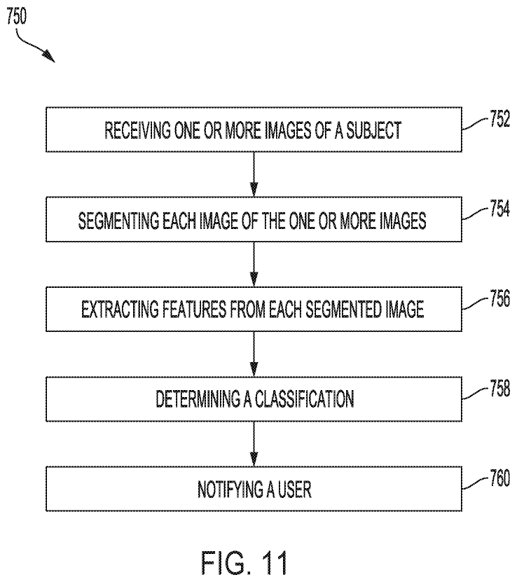

FIG. 11 shows a flowchart of a process 750 for classifying an image, a subject, etc., for example, performing a classification. The process 750 can be implemented using any of the systems described herein. For example, the process 750 can be implemented using an imaging system (e.g., the imaging system 300, the imaging system 400, etc.). In this way, the classification can be performed in short period of time after image acquisition, such that, the classification can be implemented at the point of care. In other cases, the process 750 can be implementing using a remote computing device, such as, for example, a server (e.g., the server 152). In this way, classification can occur after an image acquisition (e.g., the entire image acquisition from a subject) has been completed. In some cases, the process 750 can be implemented using one or more computing devices, as appropriate, and therefore, the process 750 can be a computer-implemented method.

At block 752, the process 750 can include a computing device receiving one or more images of a subject. In some cases, the one or more images can be of a region of interest (e.g., a particular limb, bone, etc.) or a plurality of regions of interest (e.g., different limbs, different bones, etc.). In some cases, each image of the one or more images can have the same tissue type (e.g., cortical bone). The one or more images can include at least one image of a first bone of the subject (e.g., a radial bone), at least one image of a second bone of the subject (e.g., the tibia), etc. In some cases, the one or more images can include at least one image of a first region of the first bone of the subject (e.g., a distal region of the radial bone), a second region of the first bone of the subject (e.g., a diaphyseal region of the radial bone), a first region of the second bone of the subject (e.g., a distal region of the tibia), a second region of the second bone of the subject (e.g., a diaphyseal region of the tibia), etc.

In some cases, each image of the one or more images can have a sufficient resolution. For example, the effective spatial resolution of each image can be greater than about 60 μm, less than about 100 μm, etc. In some cases, the effective spatial resolution can be less than about 100 μm, less than about 60 μm, less than about 20 μm (e.g., corresponding to micro-CT), etc. In some examples, each image of the one or more images can be a HR-pQCT image. In some cases, the one or more images can be acquired over a period of time greater than one second, two seconds, etc. In some cases, the period of time can be greater than or equal to a corresponding physiological time window (e.g., the duration of a breath, such as during thoracic imaging).

At block 754, the process 750 can include the computing device segmenting each image of the one or more images to provide a segmented image (e.g., a respective segmented image for each of the one or more images). Each segmented image can include the same tissue type (e.g., cortical bone) and can lack one or more other tissue types (e.g., trabecular bone). For example, the segmenting at the block 754 can include removing a tissue type (e.g., trabecular bone) from the image to output the segmented image. In some cases, each image can be labeled as being from a region of interest (e.g., a specific bone, a specific region of the bone). Each image can, therefore, be provided to an image segmentation model trained on the region of interest, based on the label of being from the same region of interest.

In some cases, the block 754 is performed automatically by a computing device executing a segmentation model (i.e., without manual segmentation by a user). In some cases, the block 754 can include the computing device segmenting each image of the plurality of images, based on a user input (e.g., a user interacting with a user interface device). In this way, a user can manually segment each image (or difficult images to segment), etc. However, in some cases, having an image segmentation model can segment images much faster than manual segmentation and can provide improved reproducibility, especially for classification. That is, using a paired classification model and an image segmentation model can remove user variability in, for example, segmenting particular regions within images.

At block 756, the process 750 can include the computing device extracting features from each segmented image of the one or more segmented images (e.g., segmented at the block 754). In some cases, this can include providing each segmented image to a feature extractor (e.g., the feature extractor 504). In some cases, the extracted features include the same types of extracted features used to train the classification model (e.g., at the block 758). For example, the extracted features can include a plurality of types of extracted features (e.g., entropy, strength, etc.) with the classification model having been trained on features having the plurality of types of features. In this way, the run-time extracted features correspond to the features used to train the classification model (e.g., with the computing device not needing to extract features that are not used by the classification model).

In some cases, the block 756 can include extracting one or more non-imaging features and combining them with the extracted imaging features (e.g., by concatenating the non-imaging features and the imaging features together). In some cases, the non-imaging features can include a blood biomarker, a serum biomarker, etc.

At block 758, the process 750 can include the computing device determining a classification for a subject, the one or more images of the subject, etc. In some cases, this can include receiving a classification from a classification model (e.g., the classification model 506, 600, and/or another of the classification models described herein) by providing the extracted features to the classification model. For example, when the classification model includes a plurality of decision trees, the extracted features are provided to the decision trees and the evaluations proceed accordingly (e.g., compared to the learned thresholds), and an output is provided to a majority gate, which sums the outputs for the first class and the second class (e.g., as modified by the weights from each decision tree to the majority gate). The majority gate outputs the classification as the class having the greater sum.

In some cases, the classification model can be linked with a specific image segmentation model, such that, the one or more images (e.g., received at the block 752) include and are from a region of interest and the image segmentation model and the classification model have been trained on images that include the region of interest. In this way, the image segmentation model and the classification model can be region specific (e.g., anatomical region specific) to learn and identify nuances for that specific region.

In some cases, the classification can indicate a presence of a medical condition, a disease, etc., an absence of the medical condition, the disease, etc. The classification can indicate a severity of the medical condition, the disease, etc. For example, the classification can indicate a stage of the medical condition, the disease, etc., or a lack of the stage of the medical condition, the disease, etc. As a more specific example, the classification can be the presence of a stage of CKD (or a lack thereof), such as, for example, stage 3 of CKD, stage 4 of CKD, stage 5 of CKD. In some cases, the classification can indicate the presence of a bone abnormality.

At block 760, the process 750 can include the computing device notifying a user, for example, of the classification (e.g., determined at the block 758), which can include the presence (or absence) of the medical condition (e.g., disease), a severity (or lack of severity) of the medical condition (e.g., a stage of the medical condition), etc. In some cases, this notification can include generating a report that includes the classification. In some cases, the report can additionally include an identity of the subject (e.g., by name or other identifying information), the one or more images of the subject (or a subset thereof), an annotated image of the one or more images, or the like. Further, this notification can include presenting the classification or report on a display (e.g., of a computing device), storing the classification or report in a memory accessible to the user, and/or transmitting the classification or report to another computing device (e.g., a smart phone, laptop, desktop, tablet, etc.) associated with the user for storage or display.

### EXAMPLES

The following Examples have been presented in order to further illustrate aspects of the disclosure, and are not meant to limit the scope of the disclosure in any way. The Examples below are intended to be examples of the present disclosure and these (and other aspects of the disclosure) are not to be bounded by theory.

Generally, Example 1 relates to establishing radiomic features that distinguish CKD from non-CKD bone; Example 2 relates to an integrated deep learning segmentation and machine learning classification pipeline used for classifying cortical bone in image data as being from CKD or non-CKD individuals; Example 3 relates to systematically optimizing this pipeline by testing 21 feature-classifier combinations; and Example 4 relates to further refining the pipeline by comparing feature selection strategies. In some examples, one or more of the pipelines described in these examples may be used to implement the method 750 of FIG. 11, and/or may be implemented by the computing device 150 and/or the server 152 of FIGS. 1 and 2. For example, one or more of the segmentation models described in the Examples may be used, in some examples, to implement block 754 of FIG. 11; one or more of the feature extractors described in the Examples may be used to implement block 756 of FIG. 11; and/or one or more of the classification models described in the Examples may be used to implement block 758 of FIG. 11. In other examples, one or more different segmentation models, feature extractors, and/or classification models may be used to implement these blocks of FIG. 11. In some examples, the process 650 of FIG. 9 may be used to train one or more of the segmentation models described in the Examples. In some examples, the process 700 of FIG. 10 may be used to train one or more of the classification models described in the Examples.

### Example 1

Radiomics texture feature extraction offers the potential to uncover bone disease characteristics beyond conventional measures of density and architecture. However, its use in high-resolution peripheral quantitative computed tomography (“HR-pQCT”) bone imaging is underexplored. Chronic kidney disease (“CKD”) significantly affects cortical bone, including alterations in bone quality and increased cortical porosity, though these effects can vary, even in end-stage kidney disease. This study is aimed to identify key radiomic texture features in HR-pQCT images altered by CKD in cortical bone subregions at distal and diaphyseal sites in the tibia.

HR-pQCT image stacks were obtained from 72 participants (38 non-CKD and 34 with CKD stage 5D) at 7.3% and 30% proximally from the tibial endplate, resulting in a total of 24,192 slices (168 slices per stack, 60.7 μm isotropic resolution). A pre-trained neural network segmented the cortical bone, after which each image stack was divided into proximal and distal subregions. Radiomic features were then extracted from 10 consecutive slices within each subregion. After dimensionality reduction, texture differences between CKD and non-CKD images were assessed using the top radiomic features, alongside standard cortical HR-pQCT outcomes.

The study analyzed 753 radiomic features from the distal and diaphyseal tibia in CKD and non-CKD images, identifying 11-23 top-ranked features per dataset which differed across subregions and were mainly from log-filtered and wavelet-transformed images. In non-CKD cases, features were largely derived from first-order statistics, while complex features from higher-order statistics were more prominent in CKD cases. Although standard HR-pQCT outcomes, such as volumetric bone mineral density (“vBMD”), showed limited ability to differentiate CKD from non-CKD cortical bone, top radiomic features provided a significant distinction between the two groups.

Radiomic texture analysis demonstrates enhanced sensitivity in distinguishing CKD-related cortical bone changes, offering a promising tool to detect bone quality alterations that conventional HR-pQCT metrics may overlook.

The current study aimed to use radiomics to identify key texture features in HR-pQCT images that may have value in differentiating cortical bone in CKD versus non-CKD individuals. It was hypothesized that radiomic analysis would reveal distinct cortical patterns in CKD, capturing bone quality and microarchitecture changes beyond conventional metrics. This approach—combined with machine learning—may enhance clinical imaging by establishing non-invasive biomarkers that more sensitively capture specific CKD-related bone changes to enable earlier identification of fracture risk and inform targeted fracture prevention strategies.

### Methods

HR-pQCT (XtremeCT II, Scanco Medical, Bruttisellen, Switzerland) was acquired on the participants' non-dominant arm and leg, as previously described. Bone length was measured in triplicate using a segmometer (Realmet Flexible Segmometer, NutriActiva, Minneapolis, MN) as described elsewhere. Participants were scanned supine on a movable treatment plinth and the limb of interest immobilized using manufacturer-provided carbon fiber casts. The scanner was operated at 68 kVp and 1.47 mA, capturing 168 slices (equivalent to 10.2 mm of bone length) with a voxel size of 60.7 μm. Scanner stability was verified throughout the duration of data collection by scanning phantoms with inserts of known density and volume, per manufacturer instructions. Scan stacks were positioned at 4% and 30% of the bone length proximal to the radius reference line and at 7.3% and 30% of the bone length proximal to the tibia reference line. Scans were reconstructed using manufacturer-supplied processes. Once the cortical bone was extracted, the following outcomes were recorded at the diaphyseal and distal site: volumetric BMD (“Ct.vBMD”, mgHA/cm3), area (“Ct.Ar”, mm2), thickness (“Ct.Th”, mm), and porosity (“Ct.Po”, %). μFE analysis (Scanco Medical FE software version 1.13) was used to estimate stiffness (kN/mm) and using a pixel-wise assigned modulus of 10 GPa and a Poisson's ratio of 0.3 and evaluated under axial compression as previously described.

Participant height (measured to the nearest 0.1 cm) and weight (measured to the nearest 0.1 kg) were obtained without shoes, using a calibrated stadiometer (Seca 264; Seca GmbH & Co., Hamburg, Germany) and scale (MS140-300; Brecknell, Fairmont, MN), respectively. Appendicular skeletal muscle mass relative to height (“ASM”/height²; kg/m²) and whole-body areal bone mineral density (“aBMD”) were evaluated through whole-body DXA (Norland Elite; Norland at Swissray, Fort Atkinson, WI). The same DXA scanner was used to also assess total hip and spine aBMD.

### Study Design

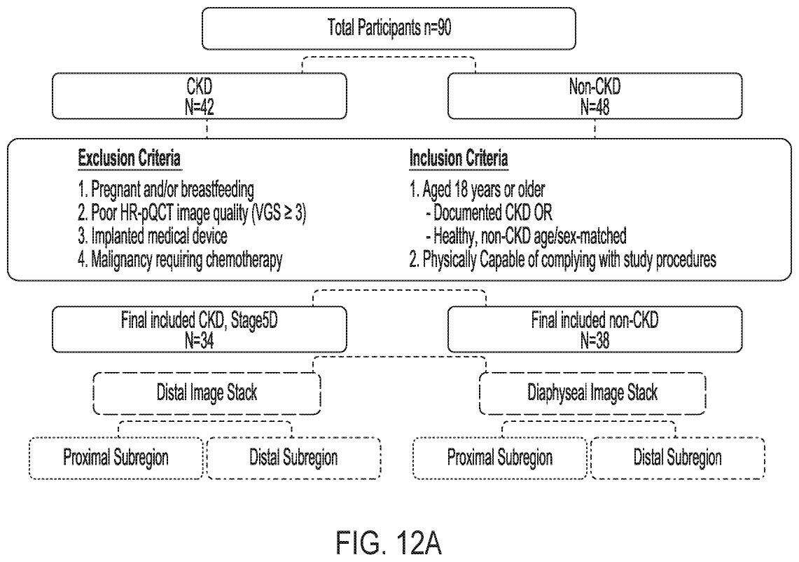

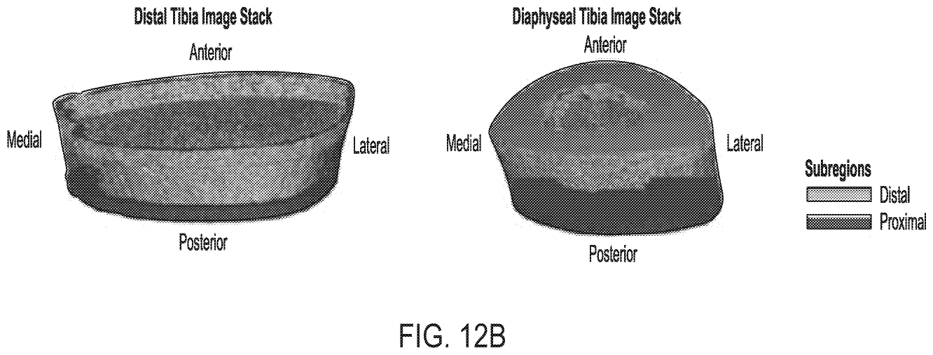

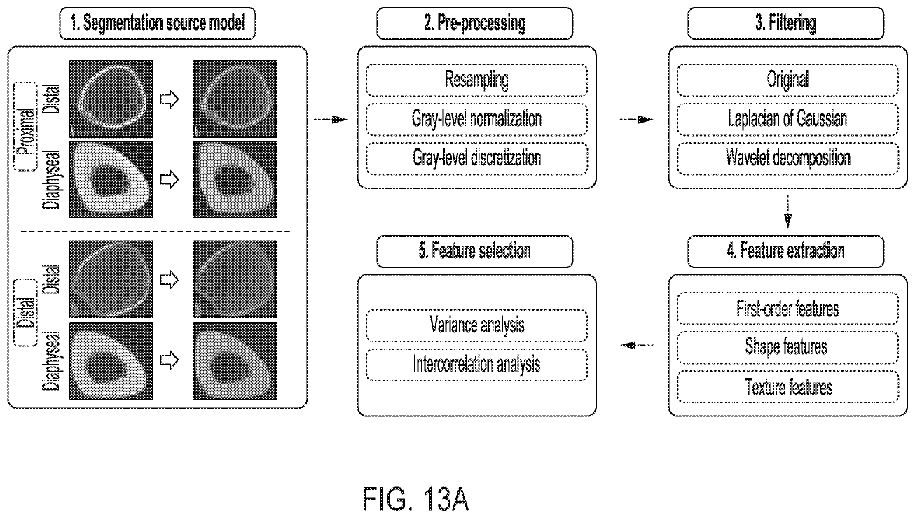

72 adults (34 CKD stage 5D and 38 age- and sex-matched non-CKD) were retrospectively identified that had undergone HR-pQCT imaging within the Function, Imaging, and Testing Resource Core of the Indiana Center for Musculoskeletal Health between 2018 and 2024. Institutional Review Board approval (Study #170755085) was obtained, and all participants provided written informed consent for their images and data to be utilized. To be included in the current analyses, participants needed to have documented CKD (CKD cohort) or no known conditions affecting musculoskeletal health (non-CKD cohort) and HR-pQCT images with a motion artifact of ≤3 (15). FIG. 12A shows the flow diagram for study inclusion.

### High-Resolution Peripheral Quantitative Computed Tomography (HR-pQCT)

HR-pQCT images of the participant's leg on the same side as their dominant arm were acquired using an XtremeCT II (Scanco Medical, Bruttisellen, Switzerland) at 7.3% (distal) and 30% (diaphyseal) of tibial length proximal from the distal tibia joint surface. The scanner operated at 68 kVp and 1.47 mA, producing 168 slices at a 60.7 μm voxel size. A manufacturer-supplied phantom was used to monitor scanner performance throughout the study. Cortical bone volumetric bone mineral density, area, thickness, and percent porosity were calculated using manufacturer processes. Bone stiffness and failure load for the cortical region was estimated through micro-finite element (μFE) analysis (Scanco Medical FE software v1.13), simulating axial compression.

### High-Resolution Peripheral Quantitative Computed Tomography (HR-pQCT)

### The Proposed Network Architecture

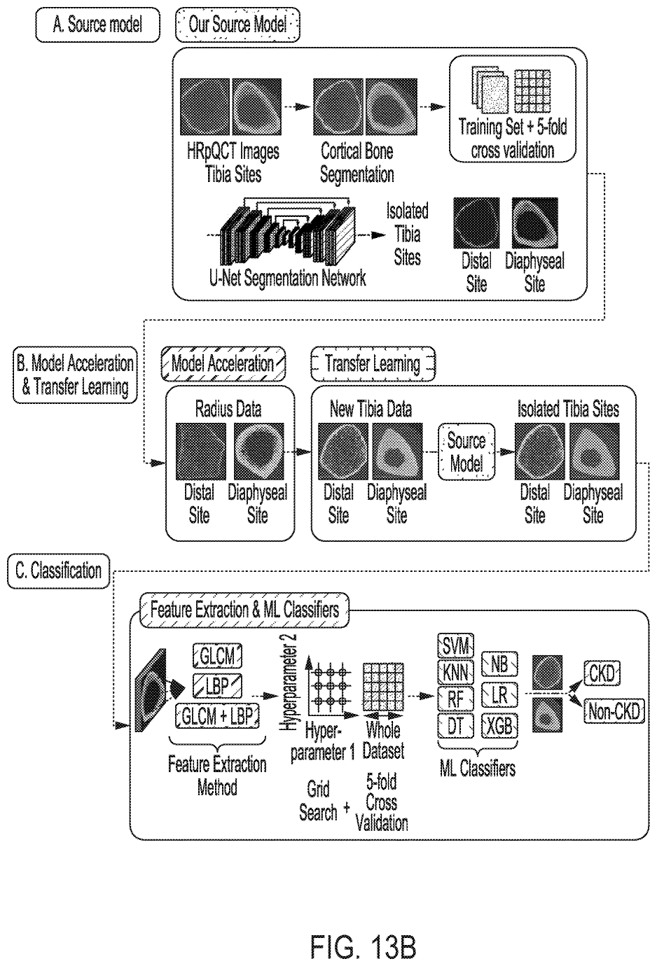

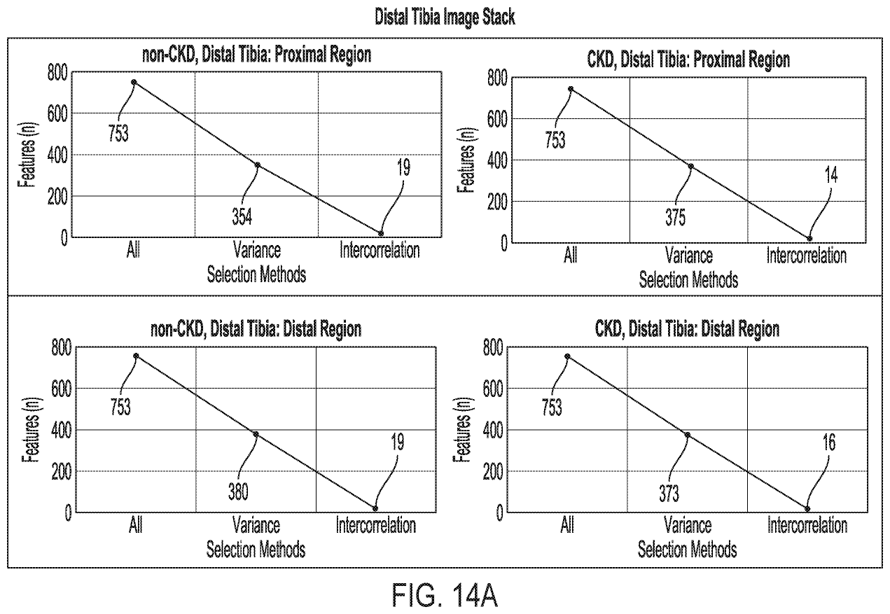

The backbone of the generator is a U-Net architecture, consisting of an encoder block that employs multiple convolutional layers to transform the input into feature space, and a decoder block that reconstructs the images from the lower-level feature information. Skip connections are implemented between various layers of the encoder and decoder to prevent the vanishing gradient problem and maintain consistency with the original input. In addition to the skip connections originally proposed in the U-Net architecture, an edge enhancer block is introduced that transfers edge information directly from the input to the final output. This architecture effectively captures both low-level details through skip connections and global structure through downsampling and upsampling operations, while the additional edge enhancement block helps preserve cortical and trabecular edge features. Moreover, a self-attention module is utilized within both the generator and discriminator to effectively capture long-range dependencies within an image. Incorporating attention blocks enables the evaluation of an image based on its global context, as opposed to the localized focus typically employed by conventional CNNs. The proposed network architecture is shown in FIG. 13A.

FIG. 13B illustrates a comprehensive workflow diagram for the machine learning approach used in analyzing bone images. The workflow is divided into three main sections: A) Source Model, B) Model Acceleration & Transfer Learning, and C) Classification. In section A, the process begins with the acquisition of HRpQCT tibia slice images, which undergo cortical bone segmentation. The segmented images are then used to create training data through k-fold cross-validation. Section B demonstrates the model acceleration and transfer learning steps, where both distal and diaphyseal site images are processed to enhance the pre-trained network's performance on the specific task of bone analysis.

Section C of FIG. 13B details the feature extraction and machine learning classification pipeline. Two feature extraction methods, GLCM (Gray Level Co-occurrence Matrix) and GLCM+LBP (Local Binary Pattern), are employed to capture textural information from the bone images. These extracted features are then feed into a grid search process for hyperparameter optimization. The workflow culminates in the application of multiple machine learning classifiers, including Support Vector Machine (“SVM”), K-Nearest Neighbors (“KNN”), Random Forest (“RF”), Decision Tree (“DT”), Naïve Bayes (“NB”), Logistic Regression (“LR”), and XGBoost (“XGB”). The final output of this classification process is a binary determination of whether the analyzed bone image corresponds to a CKD (Chronic Kidney Disease) or non-CKD case. This comprehensive workflow enables the system to process bone scan images through various computational stages, ultimately providing a classification that may assist in the diagnosis and understanding of bone conditions related to chronic kidney disease.

### Source Model-Based Acceleration for Segmentation

A pre-trained segmentation model was utilized based on U-net architecture, which has been recently detailed which was initially trained on distal and diaphyseal tibial images (source model). Additional training with distal and diaphyseal tibia images further accelerated the pre-trained network (transfer learning), following gray-level normalization and discretization (detailed below). This process enabled analysis of the gray-level range and isolation of cortical bone from soft tissue. After transfer learning, each image stack was divided into two equal subregions of ten consecutive slices for proximal and distal analysis at each site (diaphyseal, distal) (FIG. 12B). This subregion analysis was done to evaluate the presence of heterogeneity across the bone within a typical HR-pQCT imaging stack.

### Feature Extraction

Image preprocessing and feature extraction were performed using PyRadiomics (v.3.1.0). Regarding preprocessing, image resampling (in-plane resolution 0.06×0.06 mm) was performed according to current guidelines. Grey-level normalization and discretization followed: first, the grey-level values of pixel intensities were scaled from 0 to 1 through z-score normalization. After this process, exploratory extraction of the primary parameters (i.e., gray-level ranges) was performed only on the training set to avoid information leakage from the test set to select the correct bin width for discretization. In this step, the gray level range of the normalized image was analyzed using bins of 0.2, 0.3, 0.4, and 0.5. In addition to the original image, from the filtered image, i.e., after Laplacian of Gaussian (sigma=1, 2, 3, 4, 5) and wavelet decomposition was extracted. All available histogram-based first-, second-, and higher-order features were extracted, and are described in detail in the official PyRadiomics documentation.

### Feature Selection

The Python scikit-learn package was used for feature selection. Feature selection was conducted independently for each region through a multi-step process to eliminate redundant or irrelevant features. Feature filtering was conducted using a range of empirically determined thresholds (e.g., variance <0.1-0.5; Pearson correlation coefficient >0.5-0.9) across repeated iterations to identify stable, non-redundant features. FIG. 13A illustrates the complete analysis pipeline.

### Statistical Analysis

Continuous data are depicted as median and interquartile (1st-3rd) range and categorical data as counts and proportions of values. Data preparation was carried out utilizing the pandas Python library. Heatmaps and histograms were used to validate the pairwise correlation matrix of the features, display the overall feature distribution, and confirm the predominance of low correlation values. Correlation analysis between radiomic features and μFE outcomes linked to the cortical bone was performed across all participants, regardless of CKD status, to explore their relationship. For visualization, radiomics-driven, color-coded feature maps were overlaid onto the original HR-pQCT image stack. Box plots of several key selected features were generated to assess their ability to distinguish between CKD and non-CKD cortical bone. The Shapiro-Wilk test was used to assess data normality (>0.05 as normality), and differences were assessed using two sample t-tests (with Cohen's d for effect size). For non-normal distribution, the Mann-Whitney U test (with r for effect size) was used for practical impact on the clinical environment. Participant characteristics and standard cortical HR-pQCT outcomes are presented as mean±standard deviation and compared between CKD and non-CKD groups using the same processes described above. Significance was set at ≤0.05 using SPSS v28.

### Results

### Participant Characteristics

CKD patients were all in kidney failure and requiring dialysis indicating stage 5D (on hemodialysis) disease. Non-CKD and CKD did not differ in age, height, weight, or BMI (Table 1). CKD had lower whole-body BMD z-scores than non-CKD (p=0.03). Shapiro-Wilks results indicated that data from all groups exhibited a normal distribution (p>0.05). For the standard HR-pQCT cortical outcomes, the distal tibia in CKD had 13.8% lower stiffness and 13.1% lower failure load of the cortical bone measured proximally compared to non-CKD (p=0.016, 0.019). At the tibial diaphysis, the only difference between groups was for cortical thickness, which was 9.3% thinner in CKD (p=0.02) (Table 2).

TABLE 1
Participant characteristics

| | Non-CKD (n = 38) | CKD (n = 34) | P-value |
|---|---|---|---|
| Characteristics | Mean (standard deviation), n(%) | | |
| Age (years) | 54 ± 14.70 | 52.34 ± 13.35 | 0.58 |
| Sex (Female) | 18 (47%) | 14 (41%) | 0.79 |
| Height (cm) | 171.22 ± 10.18 | 169 ± 11.00 | 0.61 |
| Weight (kg) | 79.06 ± 14.70 | 84.06 ± 17.55 | 0.20 |
| BMI (kg/m²) | 26.84 ± 3.76 | 29.26 ± 6.58 | 0.07 |
| Whole body aBMD | 0.980 ± 0.128 | 0.976 ± 0.129 | 0.197 |
| Whole body z-score | 0.39 ± 1.14 | −0.30 ± 1.17 | 0.009 |
| Whole body t-score | 0.03 ± 1.24 | 0.74 ± 1.48 | 0.021 |
| Femoral neck | 0.834 ± 0.124 | 0.793 ± 0.153 | 0.211 |
| aBMD | | | |
| Femoral neck z- | 0.19 ± 0.85 | −0.49 ± 0.97 | 0.002 |
| score | | | |
| Femoral neck t- | −0.72 ± 0.93 | −1.32 ± 1.09 | 0.012 |
| score | | | |

TABLE 2
Comparison of the conventional cortical 782 HR-pQCT between
the non−CKD and CKD groups’ results.

| | | Cortical | Mean ± standard deviation | | | |
|---|---|---|---|---|---|---|
| Bone | Location | Outcome | Non-CKD | CKD | P-value | Cohen's d |
| | | Ct.vBMD | 892.34 ± 73.65 | 862.24 ± 94.18 | 0.163 | −0.360 |
| | | (mgHA/cm³) | | | | |
| | | Ct.Ar (mm) | 145.51 ± 35.36 | 132.36 ± 30.36 | 0.126 | −0.396 |
| | | Ct.Th (mm) | 1.59 ± 0.35 | 1.47 ± 0.31 | 0.158 | −0.365 |
| | | Ct.Pm (mm) | 108.91 ± 12.48 | 108.85 ± 11.58 | 0.985 | −0.005 |
| | | Ct.Po (%) | 0.03 ± 0.02 | 0.03 ± 0.02 | 0.997 | 0.001 |
| | Distal | Ct.PoDm | 0.24 ± 0.03 | 0.22 ± 0.03 | 0.064 | −0.481 |
| | | (mm) | | | | |
| Tibia | | | | | | |
| | | Ct.Stiff.Dist | 95.96 ± 28.34 | 94.36 ± 26.49 | 0.807 | 0.058 |
| | | (kN/mm) | | | | |
| | | Ct.Failure | 8.24 ± 2.39 | 8.17 ± 2.27 | 0.906 | −0.028 |
| | | Load.Dist | | | | |
| | | (kN) | | | | |
| | | Ct.Stiff. | 148.97 ± 37.48 | 128.37 ± 31.93 | 0.016 | 0.588 |
| | | Prox | | | | |
| | | (kN/mm) | | | | |
| | | Ct.Failure | 12.78 ± 3.11 | 11.11 ± 2.71 | 0.019 | −0.571 |
| | | Load.Prox | | | | |
| | | (kN) | | | | |
| | Diaphyseal | Ct.vBMD | 1027.43 ± 23.80 | 1011.86 ± 45.75 | 0.095 | −0.440 |
| | | (mgHA/cm³) | | | | |

In Table 2 a P<0.05 means statistical significance. μFE outcomes of stiffness and failure load considered both trabecular and cortical bone compartments. Ct.vBMD=cortical volumetric bone mineral density; Ct.Ar=cortical area; Ct.Th=cortical thickness; Ct.Pm=cortical perimeter; Ct.Po=cortical porosity; Ct.PoDm=cortical pore diameter; Ct.Stiff.dist=distal total stiffness; Ct.Fload.dist=distal total failure load; Ct.Stiff.prox (kN)=proximal total stiffness; Ct.Fload.prox (kN)=proximal total failure load.

### Feature Selection

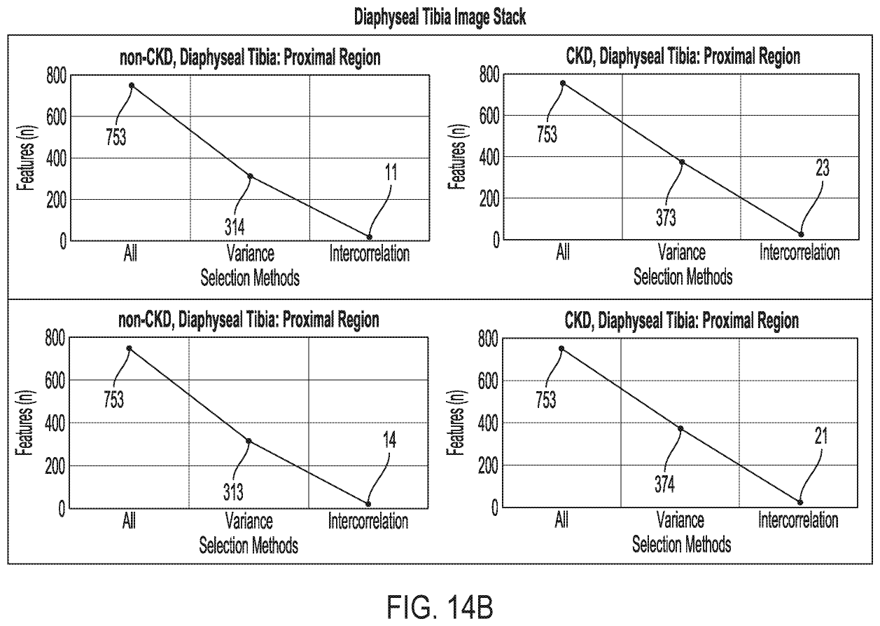

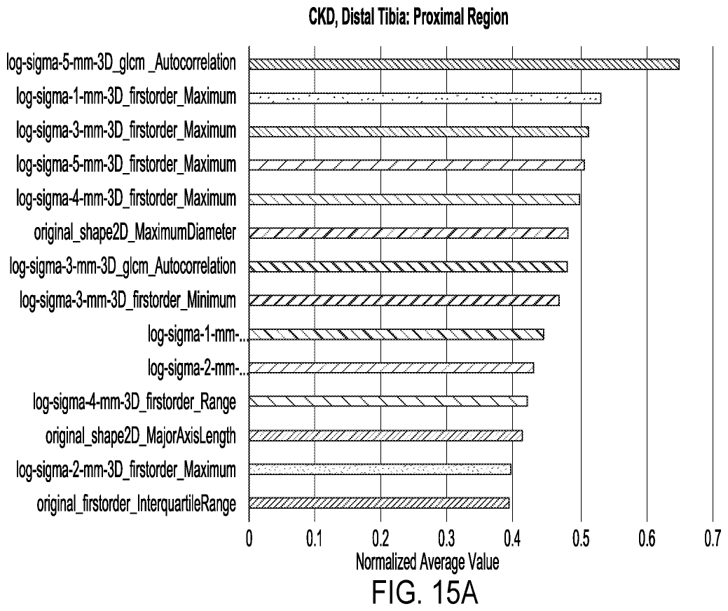

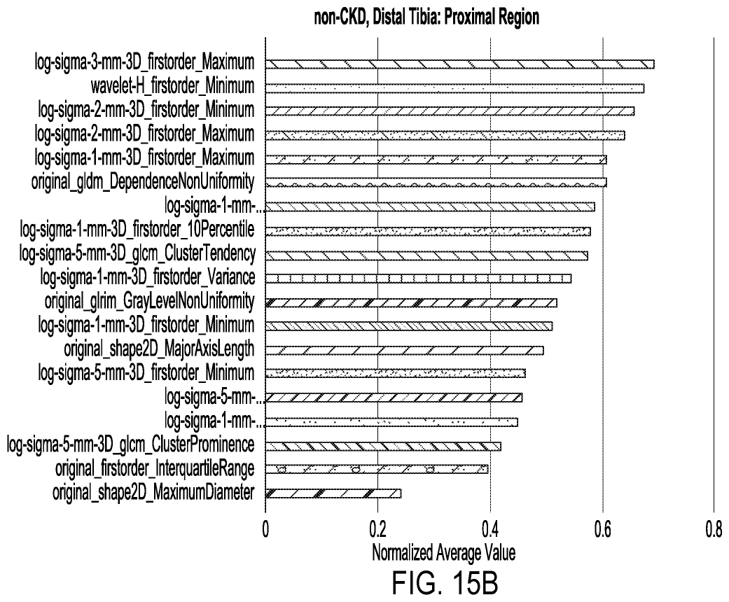

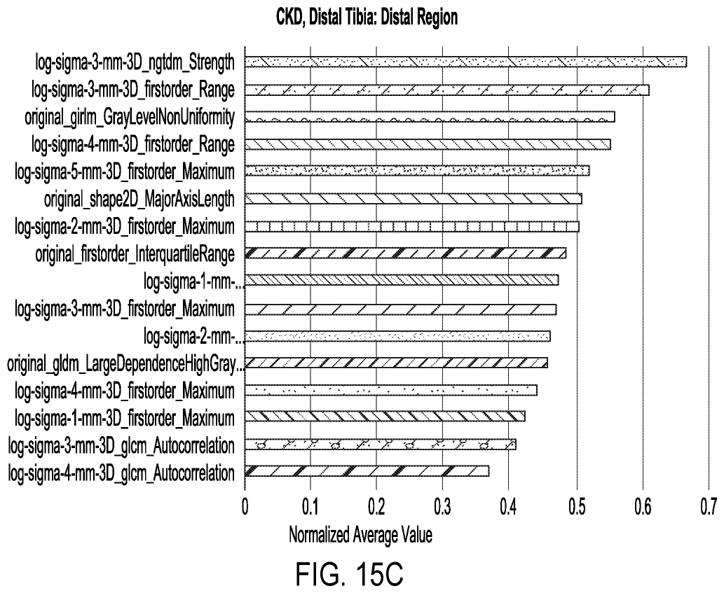

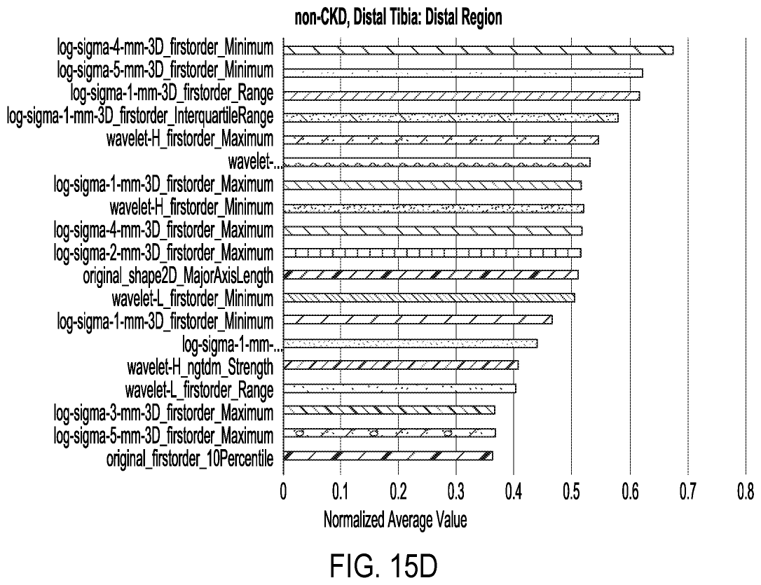

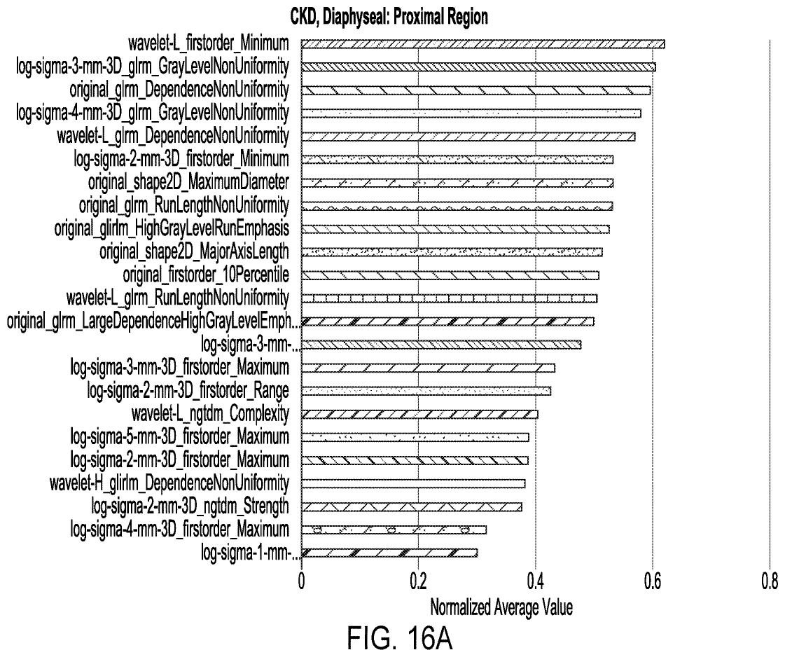

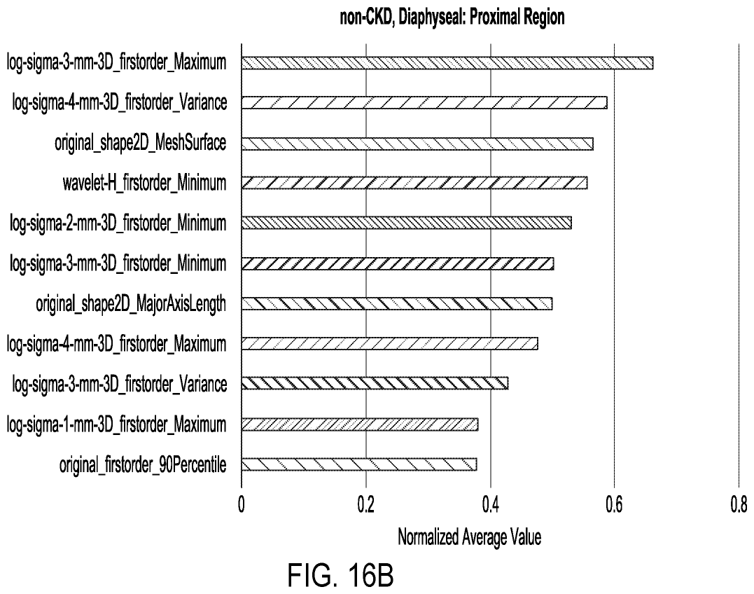

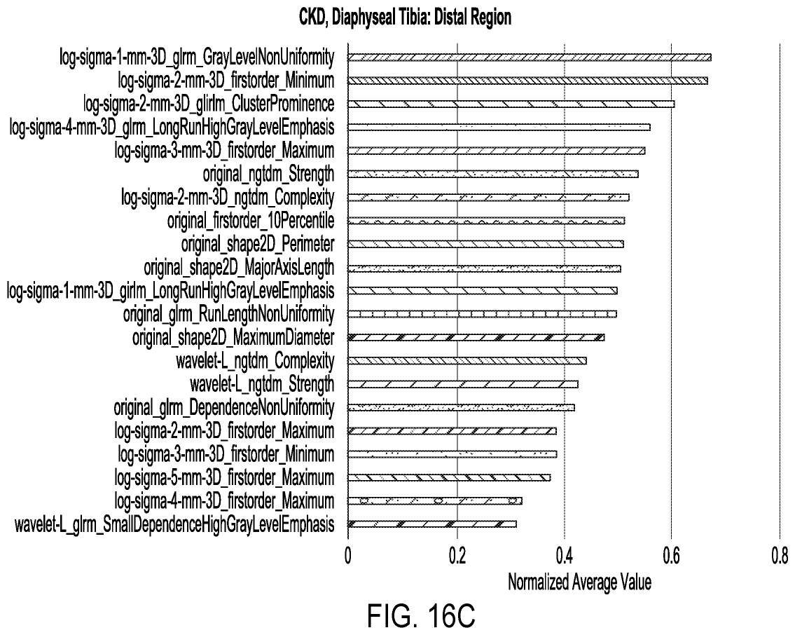

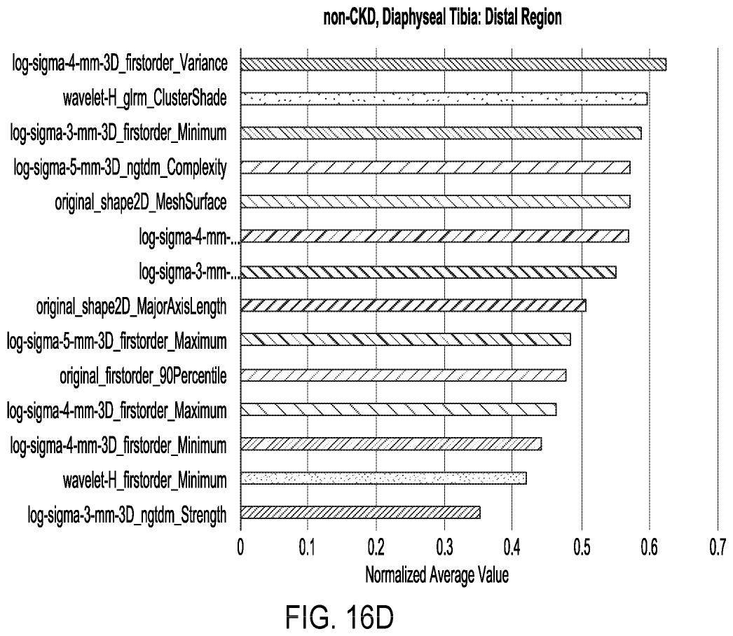

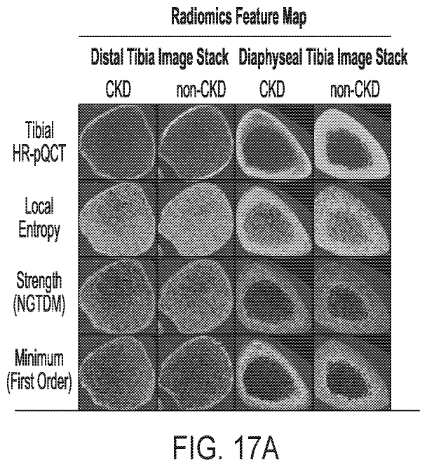

A bin width of 0.2 yielded the best feature extraction results. From both the distal and diaphyseal tibia in CKD and non-CKD image stacks, 753 features were extracted across the proximal and distal subregions. After filtering using optimized thresholds for low variance (below 0.2) and highly inter-correlated features (above 0.8), 11 to 23 key features were selected per subregion per tibial site. FIGS. 14A and 14B shows the remaining features after this process. A full list of selected features, normalized and ranked by average, can be found in FIG. 15A-D, and FIG. 16A-D. The top five features per subregion for CKD and non-CKD are presented below.

### Distal Tibia-Proximal Subregion

For CKD (FIG. 15A), the top 5 ranked features were Autocorrelation (GLCM, sigma-5) and Maximum (First order) from Log-filtered images at sigma-1, 3, 4, and 5, respectively. For non-CKD in the same subregion (FIG. 15B), top 5 features included: Maximum (First order) derived from Log-filtered images (sigma=3); Minimum (First order) derived from wavelet-transformed images (High pass filter); Minimum (First order) derived from Log-filtered images (sigma=2); and Maximum (First order) derived from Log-filtered images at sigma=1 and 2.

### Distal Tibia-Distal Subregion

The top five ranked features for CKD (FIG. 15C) were Strength (Neighboring Gray Tone Difference Matrix, NGTDM) derived from Log-filtered images (sigma-3); Range (First order) derived from Log-filtered images (sigma-3); Gray Level Non-Uniformity (“GLRLM”) derived from the original images; Range (First order, sigma=1) and Maximum (First order, sigma=5) from Log-filtered images. For non-CKD (FIG. 15D), the selected features include Minimum (First order) derived from Log-filtered images sigma=4 and sigma=5; Range (First order) derived from Log-filtered images (sigma=1); Interquartile Range (First order) derived from Log-filtered images (sigma-1); Maximum (First order) derived from wavelet-transformed images (High pass filter).

### Diaphyseal Tibia-Proximal Subregion

The top 5 CKD features (FIG. 16A) included Minimum (First order) from wavelet-transformed images (Low pass filter); Gray Level Non-Uniformity (Gray Level Run Length Matrix, “GLRLM”) from Log-filtered images (sigma=3); Dependence Non-Uniformity (Gray Level Dependence Matrix, “GLDM”) from original images; Gray Level Non-Uniformity (“GLRLM”) from Log-filtered images (sigma=4); Dependence Non-Uniformity (“GLDM”) from wavelet-transformed images (Low pass filter). For non-CKD (FIG. 16B): Maximum (First order) from Log-filtered images (sigma=3); Variance (First order) from Log-filtered images (sigma=4); Mesh Surface (2D shape-based) from the original images; Minimum (First order) from wavelet-transformed images (High pass filter); Minimum (First order) derived from Log-filtered images (sigma=2).

### Diaphyseal Tibia-Distal Subregion

The top 5 ranked features for CKD (FIG. 16C) were Gray Level Non-Uniformity (“GLDM”, sigma-1), Minimum (First-order, sigma-2), Cluster Prominence (“GLCM”, sigma=2), Long Run High Gray Level Emphasis (“GLRLM”, sigma-4), and Maximum (First-order, sigma=3), all from Log-filtered images. For non-CKD (FIG. 16D), the features were Variance (First order) derived from Log-filtered images (sigma-4); Cluster Shade (“GLCM”) derived from wavelet-transformed images (High pass filter); Minimum (First order) derived from Log-filtered images (sigma=3); Complexity (“NGTDM”) derived from Log-filtered images (sigma=5); Mesh Surface (2D shape-based) derived from the original images.

### Validation of Feature Independence and Correlation Analysis

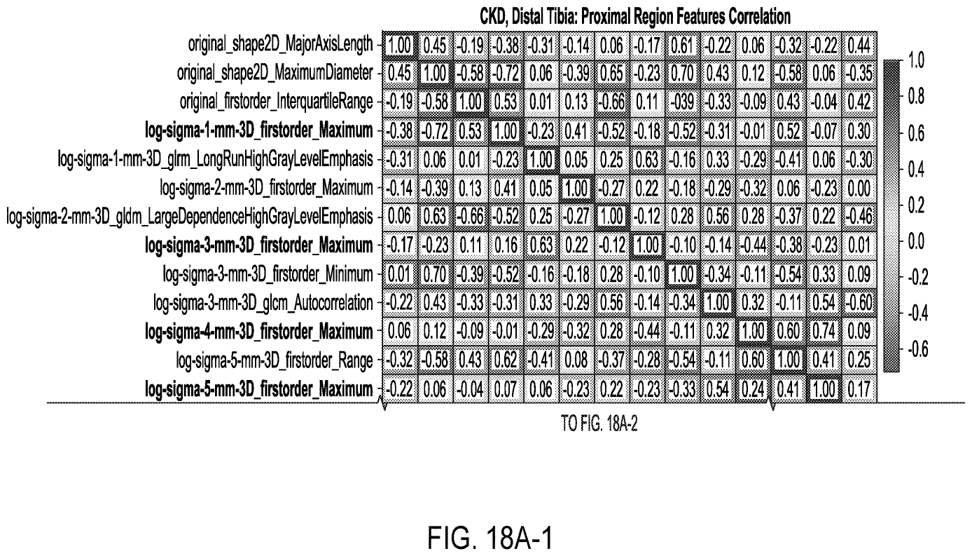

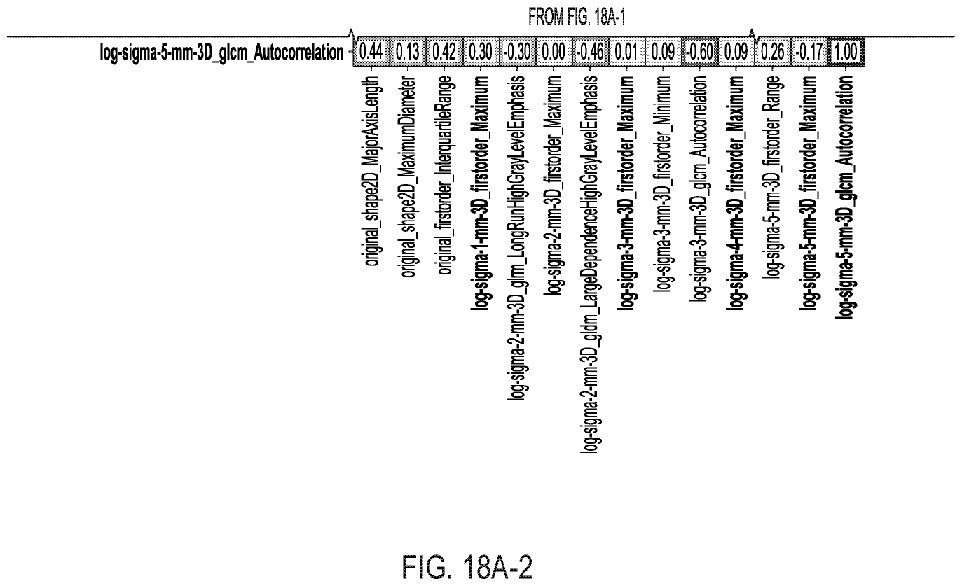

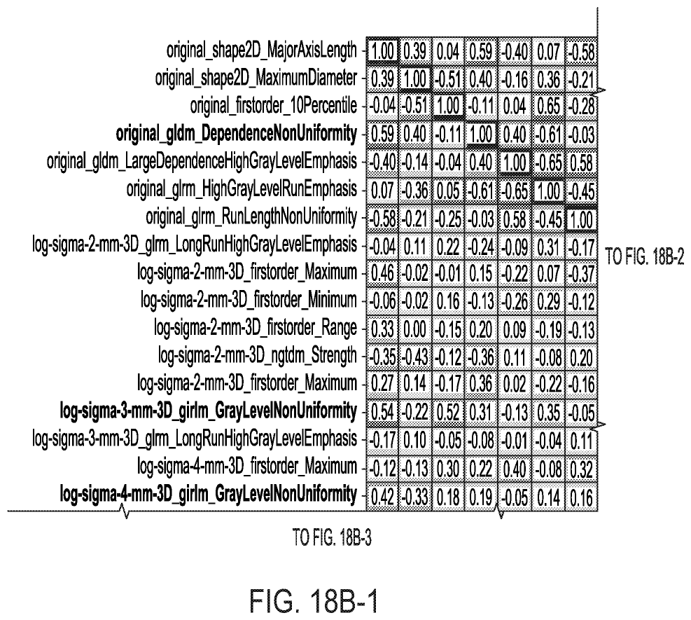

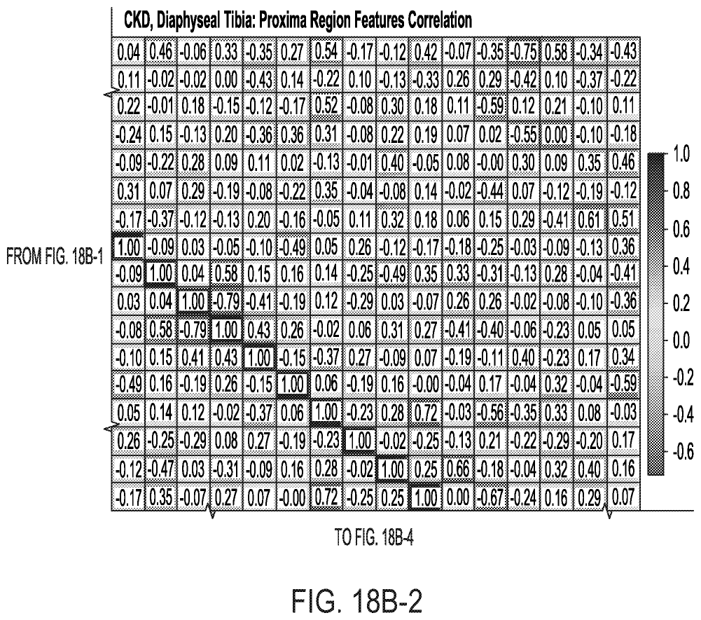

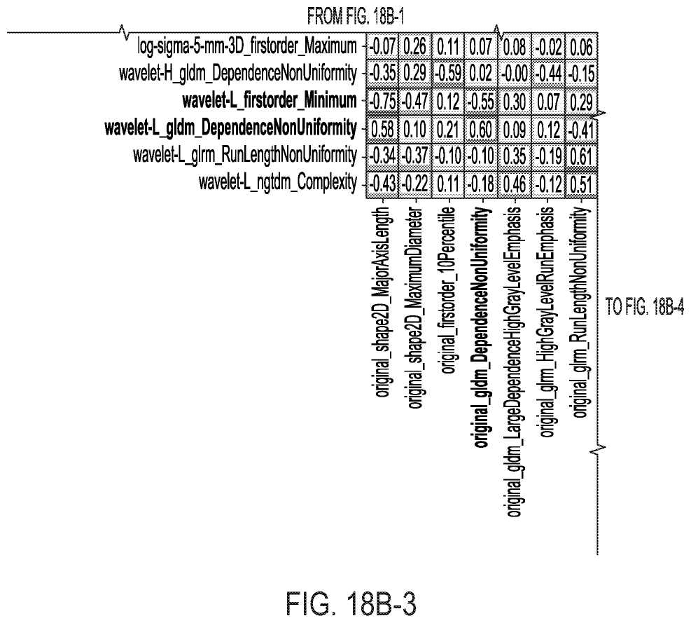

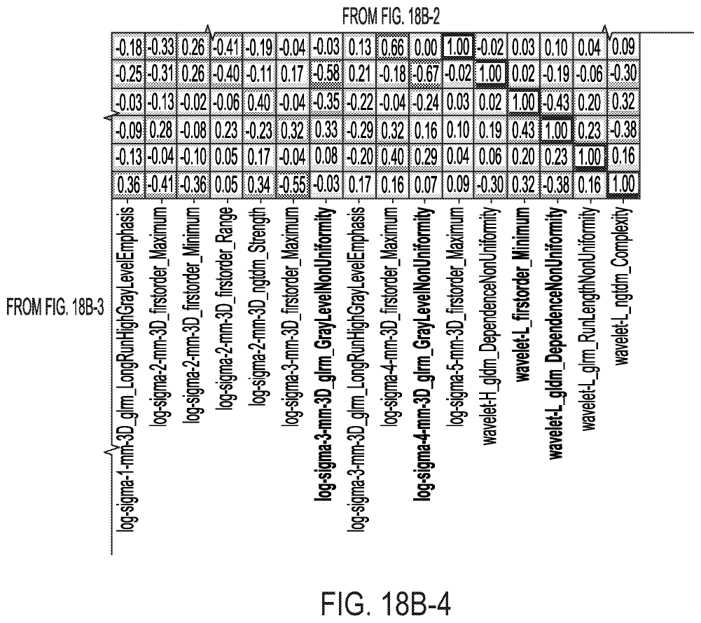

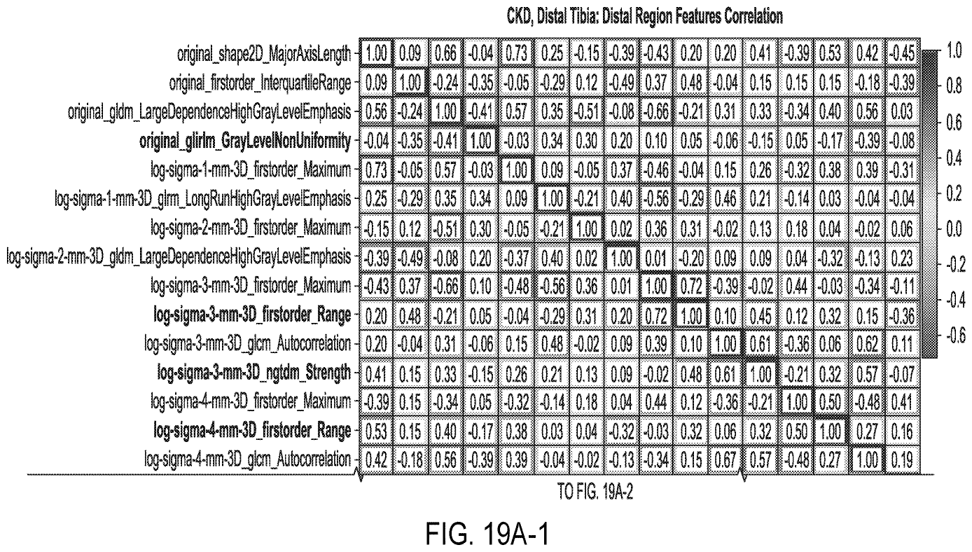

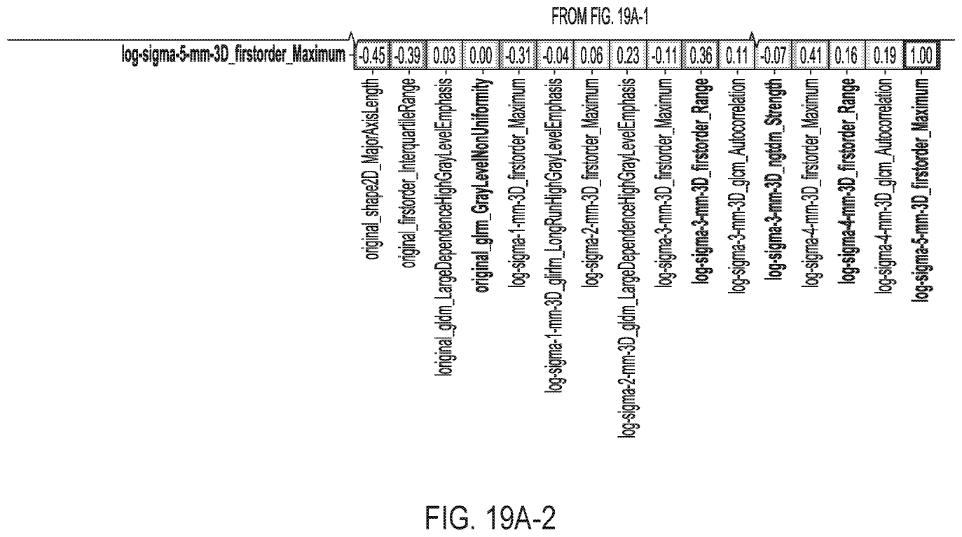

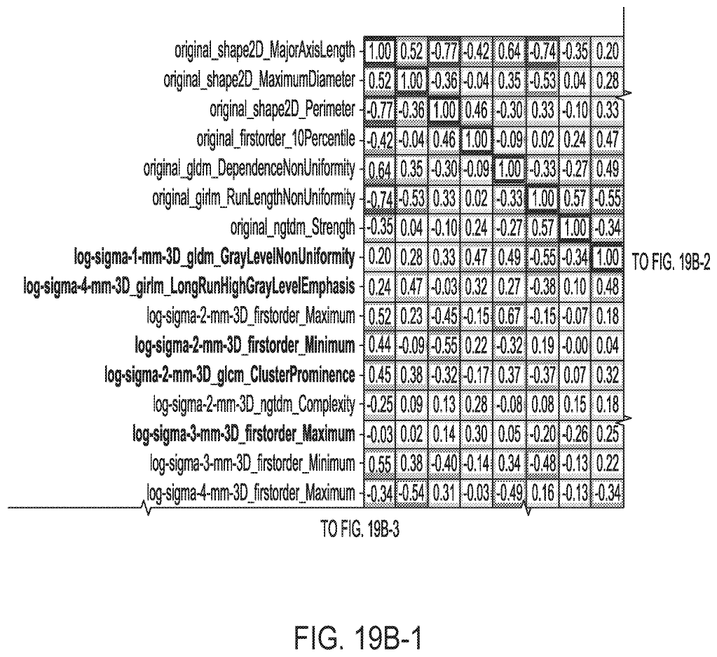

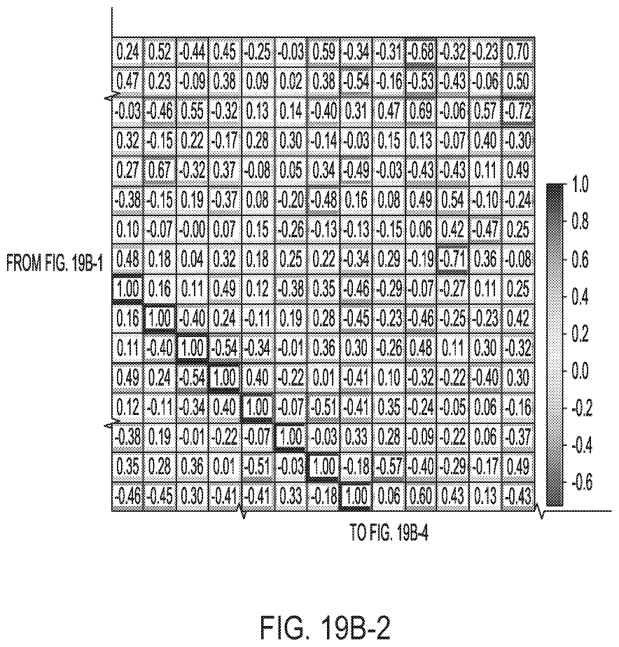

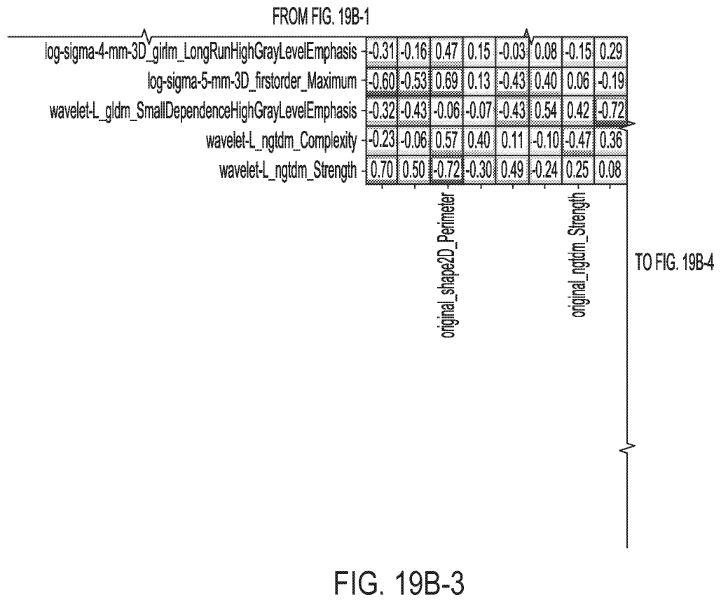

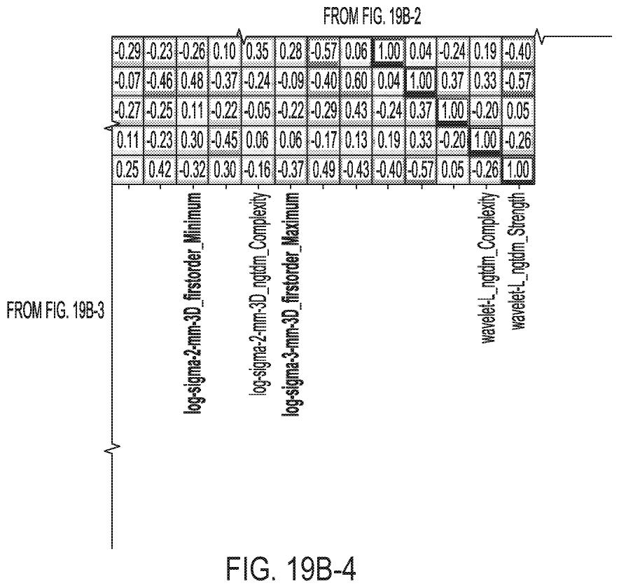

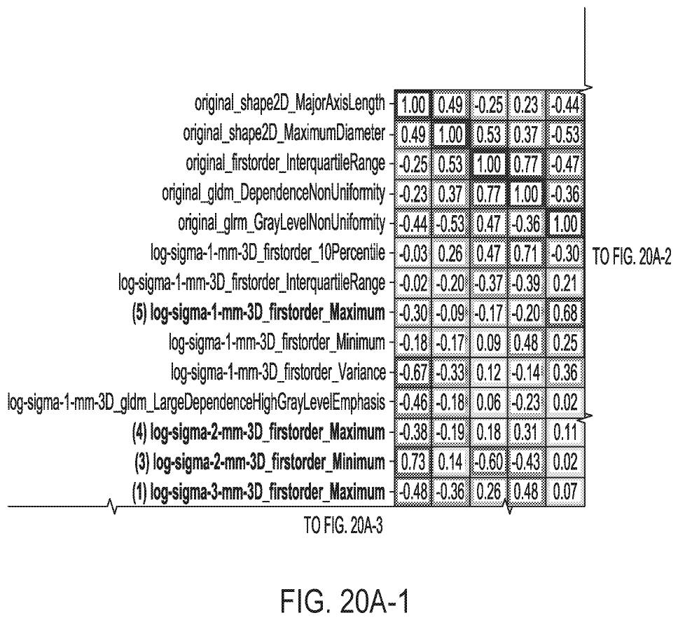

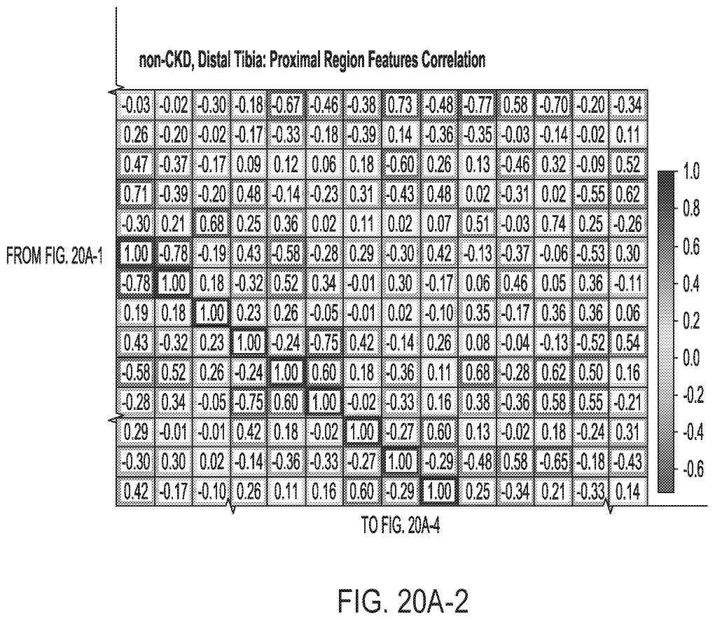

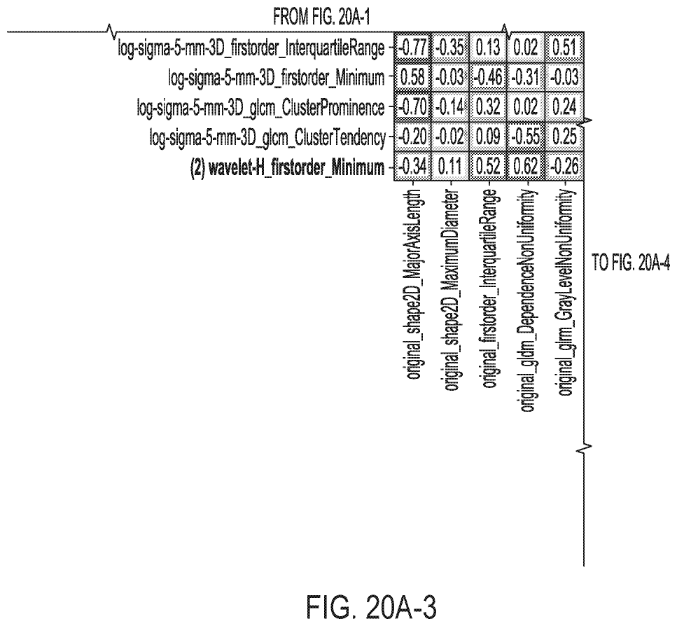

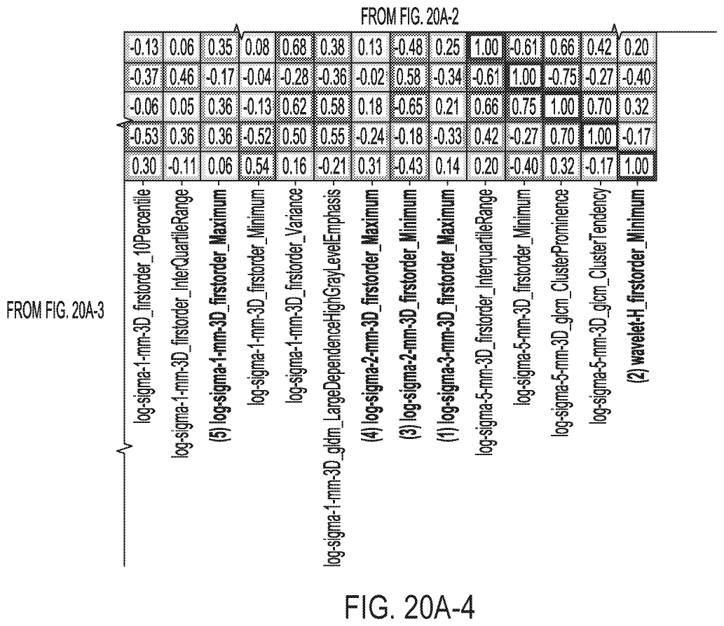

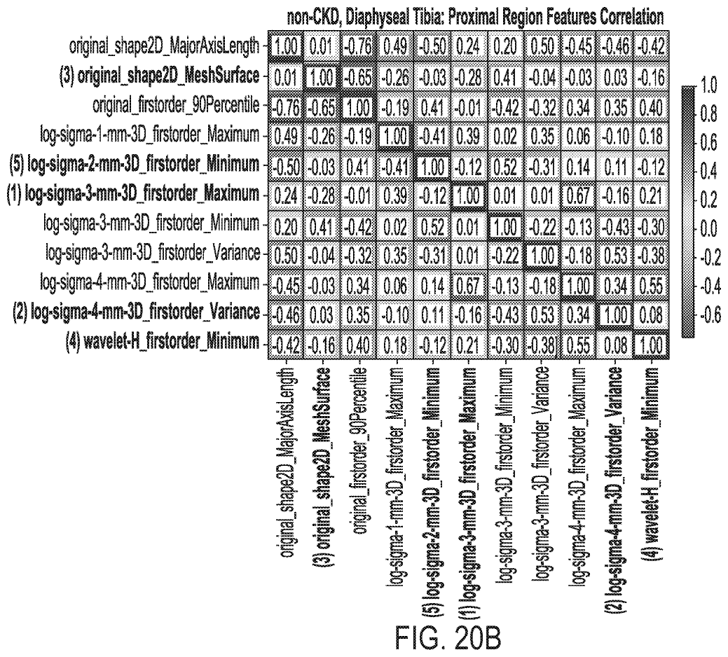

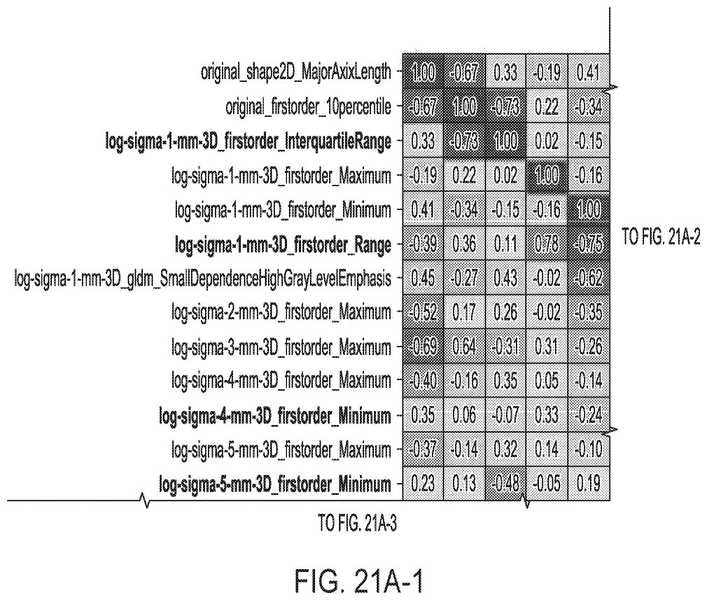

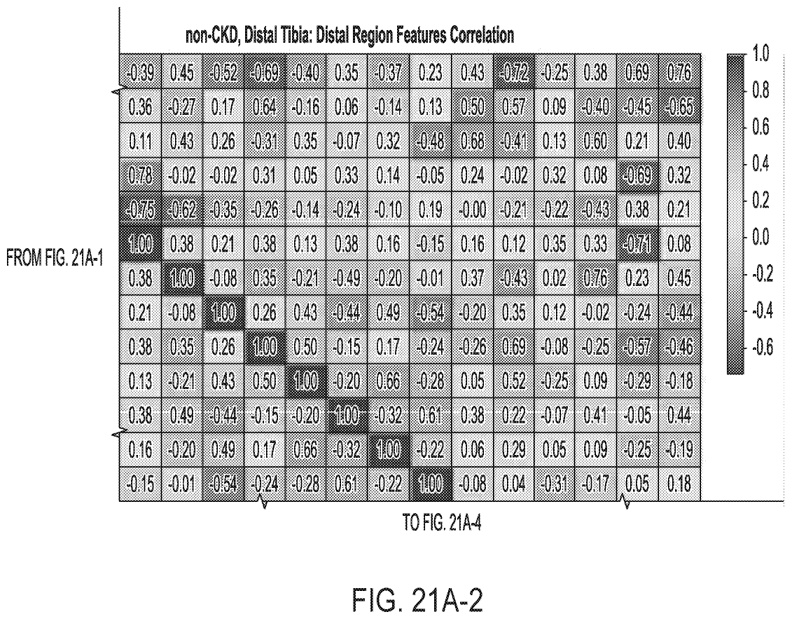

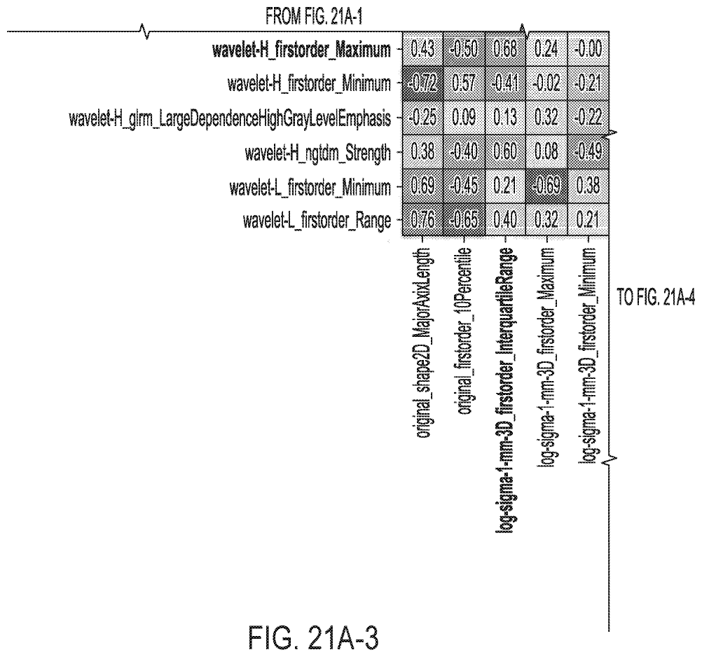

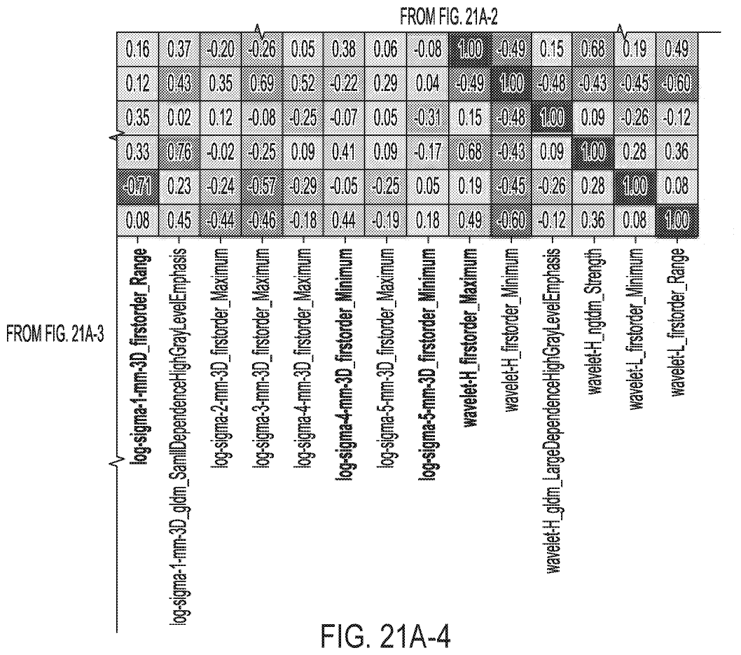

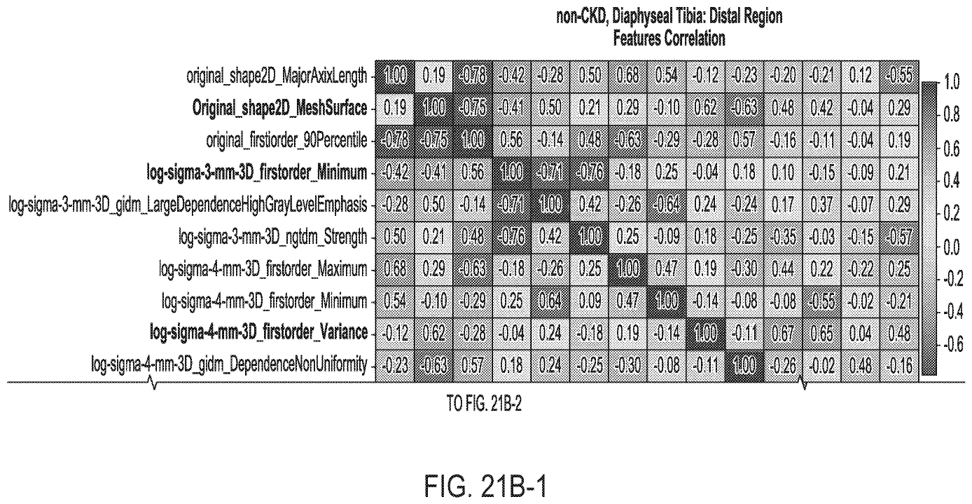

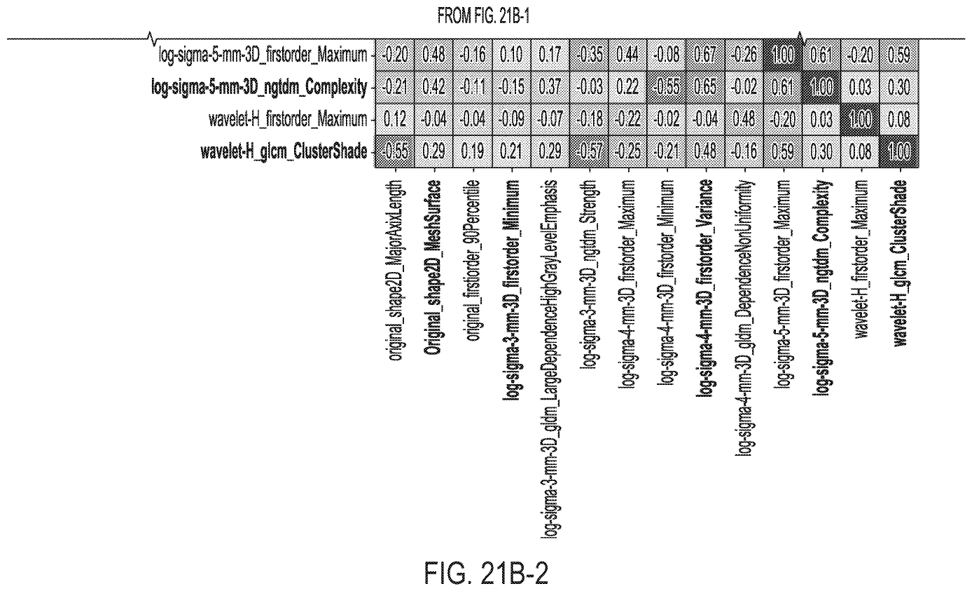

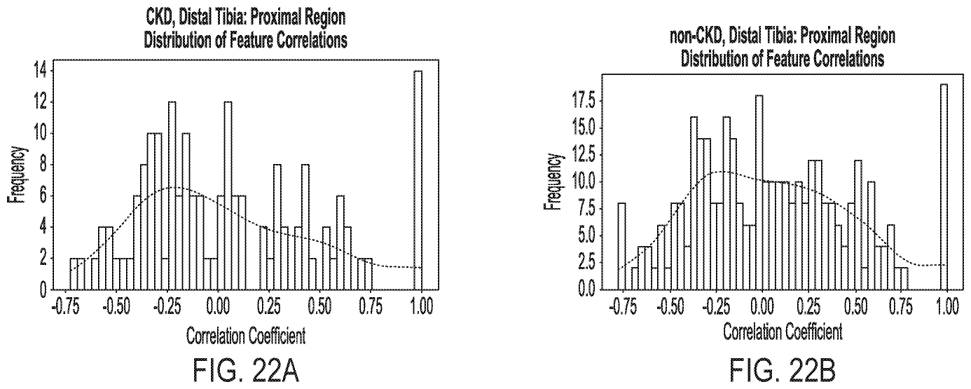

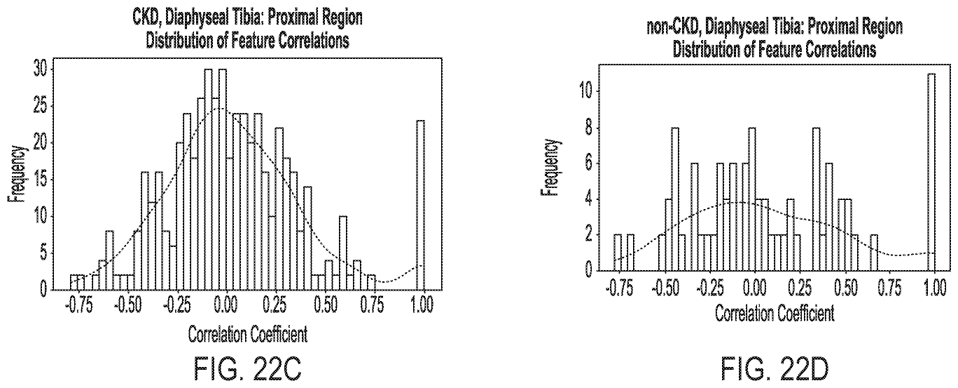

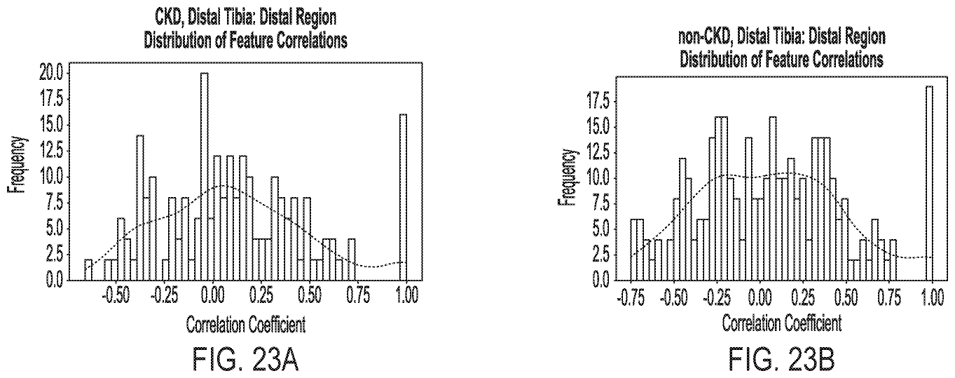

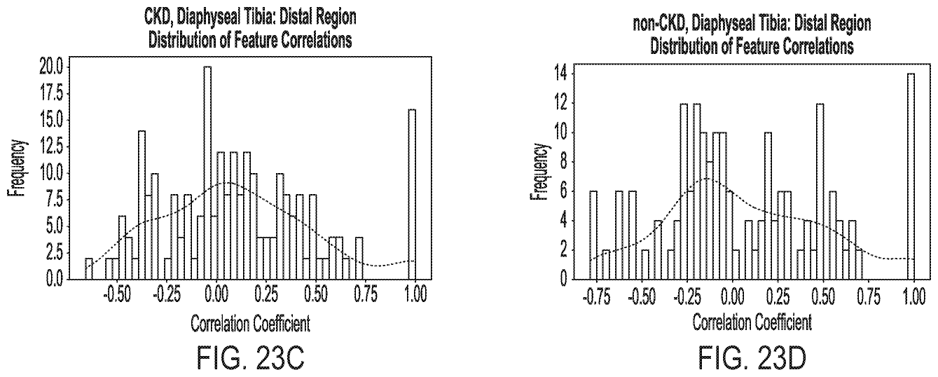

Heatmaps confirm that the selected CKD features exhibit minimal inter-correlation after removing low variance and high inter-correlation, ensuring high feature independence and robustness (FIGS. 18-21). As expected, the histogram shows a spike at a correlation coefficient of 1, representing each feature's self-correlation. The distribution centers around zero, indicating high feature independence, with most correlation coefficients between −0.75 and 0.75 (FIGS. 22-23). No significant differences were found between the features Strength/Minimum and μFE outcomes of the cortical compartment which can be seen in Tables 3 and 4 below.

| | | | Finite | | |
|---|---|---|---|---|---|
| | | | Element | | |
| Bone | Location | Feature | (μFE) | Correlation (95% CI) | P-value |
| Distal | Distal | Strength | Ct.Stiff.dist | −0.128 [−0.438, 0.209] | 0.444 |
| | | (NGTDM) | (kN/mm) | | |
| | | | Ct.Fload.dist | 0.110 [−0.227, 0.423] | 0.511 |
| | | | (kN) | | |
| | | Minimum | Ct.Stiff.dist | 0.040 [−0.292, 0.364] | 0.810 |
| | | (First order) | (kN/mm) | | |
| | | | Ct.Fload.dist | −0.030 [−0.355, 0.302] | 0.859 |
| | | | (kN) | | |
| | Proximal | Strength | Ct.Stiff.prox | 0.031 [−0.301, 0.356] | 0.855 |
| | | (NGTDM) | (kN/mm) | | |
| | | | Ct.Fload.prox | −0.048 [−0.371, 0.285] | 0.775 |
| | | | (kN) | | |
| | | Minimum | Ct.Stiff.prox | −0.116 [−0.428, 0.221] | 0.488 |
| | | (First order) | (kN/mm) | | |
| | | | Ct.Fload.prox | 0.107 [−0.230, 0.420] | 0.524 |
| | | | (kN) | | |
| Diaphyseal | Distal | Strength | Ct.Stiff.dist | −0.096 [−0.255, 0.433] | 0.569 |
| | | (NGTDM) | (kN/mm) | | |
| | | | Ct.Fload.dist | −0.110 [−0.441, 0.246] | 0.534 |
| | | | (kN) | | |
| | | Minimum | Ct.Stiff.dist | −0.197 [−0.509, 0.162] | 0.265 |
| | | (First order) | (kN/mm) | | |
| | | | Ct.Fload.dist | 0.196 [−0.162, 0.509] | 0.267 |
| | | | (kN) | | |
| | Proximal | Strength | Ct.Stiff.prox | −0.297 [−0.584, 0.056] | 0.088 |
| | | (NGTDM) | (kN/mm) | | |
| | | | Ct.Fload.prox | 0.275 [−0.079, 0.568] | 0.115 |
| | | | (kN) | | |
| | | Minimum | Ct.Stiff.prox | 0.072 [−0.282, 0.409] | 0.685 |
| | | (First order) | (kN/mm) | | |
| | | | Ct.Fload.prox | −0.075 [−0.411, 0.280] | 0.675 |
| | | | (kN) | | |

Tale 3 shows a correlation of top radiomic features with finite element outcomes of the non-CKD group in the proximal/distal subregion of the distal/diaphyseal tibia site

In Table 3, a P<0.05 means statistical significance. μFE outcomes of stiffness and failure load considered both trabecular and cortical bone compartments. Ct.Stiff.dist=distal total stiffness, Ct.Fload.dist=dist total failure load, Ct.Stiff.prox (kN)=proximal total stiffness, Ct.Fload.prox (kN)=proximal total failure load.

| | | | Finite | | |
|---|---|---|---|---|---|
| | | | Element | | |
| Bone | Location | Feature | (μFE) | Correlation (95% CI) | P-value |
| Distal | Distal | Strength | Ct.Stiff.dist | −0.142 [−0.471, 0.221] | 0.429 |
| | | (NGTDM) | (kN/mm) | | |
| | | | Ct.Fload.dist | 0.123 [−0.240, 0.456] | 0.496 |
| | | | (kN) | | |
| | | Minimum | Ct.Stiff.dist | 0.174 [−0.190, 0.496] | 0.333 |
| | | (First order) | (kN/mm) | | |
| | | | Ct.Fload.dist | −0.153 [−0.480, 0.211] | 0.396 |
| | | | (kN) | | |
| | Proximal | Strength | Ct.Stiff.prox | −0.081 [−0.422, 0.279] | 0.653 |
| | | (NGTDM) | (kN/mm) | | |
| | | | Ct.Fload.prox | 0.084 [−0.277, 0.424] | 0.644 |
| | | | (kN) | | |
| | | Minimum | Ct.Stiff.prox | 0.132 [−0.231, 0.463] | 0.464 |
| | | (First order) | (kN/mm) | | |
| | | | Ct.Fload.prox | −0.132 [−0.463, 0.232] | 0.465 |
| | | | (kN) | | |
| Diaphyseal | Distal | Strength | Ct.Stiff.dist | 0.059 [−0.339, 0.439] | 0.772 |
| | | (NGTDM) | (kN/mm) | | |
| | | | Ct.Fload.dist | −0.036 [−0.420, 0.359] | 0.858 |
| | | | (kN) | | |
| | | Minimum | Ct.Stiff.dist | −0.168 [−0.524, 0.237] | 0.401 |
| | | (First order) | (kN/mm) | | |
| | | | Ct.Fload.dist | 0.159 [−0.246, 0.517] | 0.427 |
| | | | (kN) | | |
| | Proximal | Strength | Ct.Stiff.prox | 0.092 [−0.310, 0.465] | 0.650 |
| | | (NGTDM) | (kN/mm) | | |
| | | | Ct.Fload.prox | −0.084 [−0.459, 0.316] | 0.676 |
| | | | (kN) | | |
| | | Minimum | Ct.Stiff.prox | 0.004 [−0.386, 0.394] | 0.983 |
| | | (First order) | (kN/mm) | | |
| | | | Ct.Fload.prox | −0.005 [−0.394, 0.386] | 0.981 |
| | | | (kN) | | |

Tale 4 shows a correlation of top radiomic features with finite element outcomes of the CKD group in the proximal/distal subregion of the distal/diaphyseal tibia site

In Table 4, a P<0.05 means statistical significance. μFE outcomes of stiffness and failure load considered cortical bone compartments. Ct.Stiff.dist=distal total stiffness, Ct.Fload.dist=dist total failure load, Ct.Stiff.prox (kN)=proximal total stiffness, Ct.Fload.prox (kN)=proximal total failure load.

Discriminating CKD vs. Non-CKD Using Top Radiomic Features

For subregions that showed a normal distribution in the proximal subregion of the distal tibia in both CKD (P=0.600) and non-CKD (P=0.176) groups for the Strength feature, the t-test (P<0.434, Cohen's d=0.251 (95% CI [−0.373, 0.872]) was applied. For all other subregions not satisfying normal distribution (P values ranging from 0.002 to 0.045), the Mann-Whitney U test was used, which showed statistically and practically significant differences between the two groups for both the Strength and Minimum features (P<0.001, Effect size r=from 0.813 to 0.856).

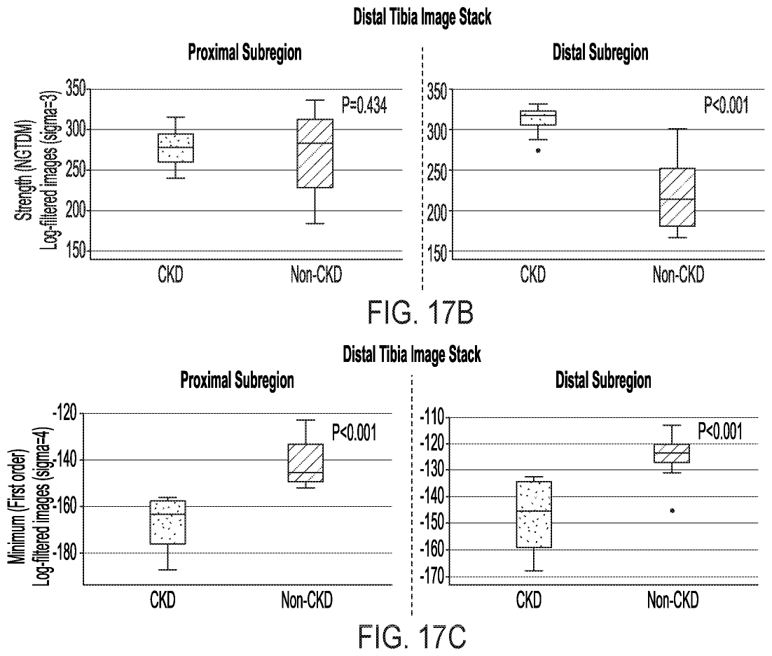

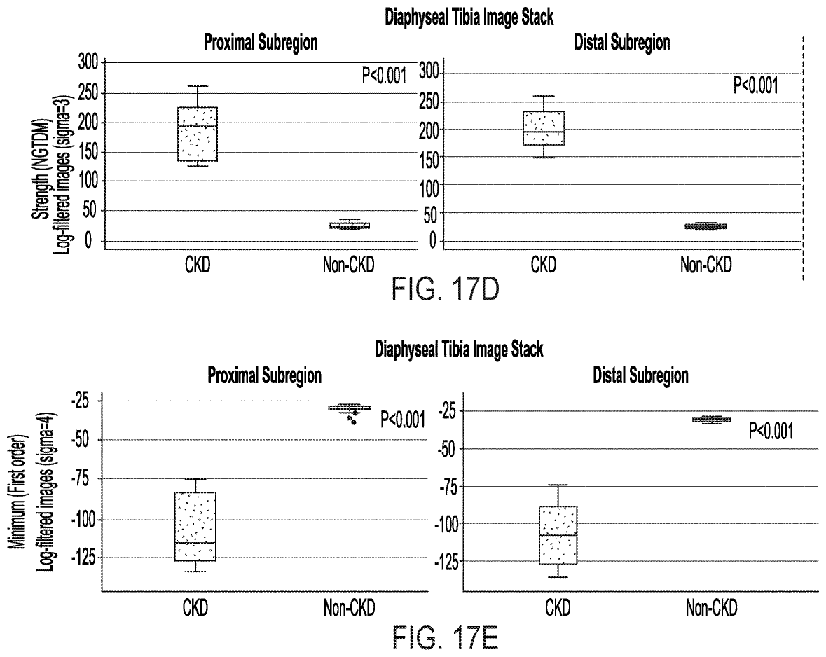

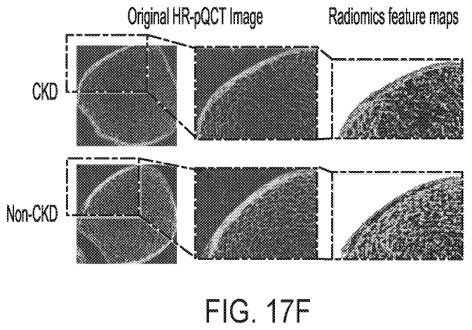

As shown in FIGS. 17A-E, the features chosen for evaluation were selected based on their ability to capture key aspects of bone texture in CKD and non-CKD cortical bone. Entropy was selected for its role in highlighting texture complexity, a known indicator of structural degradation. Higher entropy is shown in the image in red and yellow which is prominent in CKD bone, while lower intensities (in blue and purple) appear in smoother, more uniform areas which is predominant in non-CKD bone (FIG. 17A). NGTDM-Strength (FIG. 17A), the top-ranked feature for CKD cortical bone at the distal tibia image stack (FIG. 15C), quantifies the intensity of texture strength, particularly in irregular and complex regions. This feature was significantly higher in CKD compared to non-CKD at the distal subregion (P<0.001) but not the proximal subregion (normal distribution, P=0.434, Cohen's d=0.251 (95% CI [−0.373, 0.872])) of the distal tibia (FIG. 17B). For the diaphyseal stack, NGTDM-Strength was significantly higher in CKD vs. non-CKD in both subregions (both P<0.001). The Minimum feature (FIGS. 17A, 17C, 17E), a top radiomics feature in non-CKD cortical bone (FIGS. 15B, 15D), reflects the ability to capture areas of low intensity associated with more homogeneous bone tissue. Non-CKD cases exhibited higher values for this feature compared to CKD in the distal stack (FIG. 17C, proximal and distal subregions both P<0.001) and diaphyseal stack (FIG. 17E, proximal and distal subregions both P<0.001). All subregions aside from the proximal subregion of the distal image stack did not satisfy normal distribution thus the Mann-Whitney U test was used, and effect sizes ranged from 0.813-0.856). Furthermore, while the original images appear visually similar between groups, the radiomics maps show lower Strength values in CKD, indicating greater cortical heterogeneity and revealing textural differences not apparent in conventional images (FIGS. 7A-10B).

FIGS. 10A-10B show the visualization of radiomic feature map (Strength) in CKD and non-CKD cortical bone. Radiomics maps based on the Strength feature show lower values in CKD bone compared to non-CKD, indicating greater cortical heterogeneity. These subtle differences, not apparent in the original HR-pQCT images, reflect underlying structural degradation associated with CKD-related bone disease.

### Discussion

The findings highlight distinct radiomic features of tibial cortical bone in individuals with CKD, which were notably heterogeneous across subregions. Standard HR-pQCT outcomes, such as vBMD, were limited in distinguishing between CKD and non-CKD. In contrast, top radiomic features demonstrated higher discriminatory power with larger effect sizes, supporting future machine learning model development defining the radiomic bone phenotype in CKD.

Standard HR-pQCT analysis revealed limited distinctions between CKD and non-CKD cortical bone. CKD patients showed a 13.8% lower stiffness and 13.1% lower failure load in the proximal cortical compartment of the distal tibia, and a 9.3% thinner cortical thickness at the tibial diaphysis, highlighting standard HR-pQCT may miss some important bone changes, calling for more advanced analysis methods.

Radiomics provided additional insights, capturing heterogeneity within specific image regions and revealing complex texture alterations associated with CKD. For example, in non-CKD bones, top features were primarily derived from first-order statistics, reflecting basic intensity distribution, while CKD features were derived from higher-order statistics, indicating underlying changes in bone composition and microarchitecture. Specifically, the “first-order minimum” intensity, representing the lowest voxel intensity in a given region, was lower in CKD bone across all tibial subregions, suggesting less dense tissue, potentially due to porous or degraded bone. Although the original HR-pQCT images showed no perceivable visual differences between CKD and non-CKD images, the radiomic map revealed higher cortical heterogeneity in CKD. This aligns with expected pathophysiological changes such as increased porosity and disrupted intracortical organization. Such findings support the biological relevance of radiomic features in detecting early cortical deterioration which may be overlooked by conventional assessments.

In CKD, top radiomics features, such as NGTDM strength, were derived from advanced statistical methods (GLCM, GLRLM, GLDM, NGTDM), capturing subtle textural variations. NGTDM strength, which measures contrast in relation to neighboring voxels, was higher in the distal subregion of the distal tibia and all diaphyseal subregions, suggesting more heterogeneous tissue in CKD bone, potentially linked to compromised bone quality. These support the clinical relevance of subregional texture analysis in CKD bone. Importantly, the feature selection focused on robust metrics with low variation, utilizing an automated deep-learning pipeline for cortex segmentation, enhancing reproducibility, and reducing manual segmentation error. This can be important for clinical and research applications, as previous studies have shown that radiomic features can vary based on imaging parameters, including exposure settings (kV, mAs), filter type, and imaging distance, underscoring the importance of robust feature selection in radiomics.

Subregional analysis of tibial stacks (proximal and distal at both distal and diaphyseal sites) further illustrated that key radiomic features varied within the same image stack. For example, Autocorrelation (GLCM) and Strength (NGTDM) characterized CKD bone in the distal tibia, while Maximum and Minimum (First order) features were prominent in non-CKD bone. At the diaphyseal tibia, CKD features included Minimum (First order) and Gray Level Non-Uniformity (GLDM), whereas non-CKD bone was characterized by Maximum and Variance (First order).

This subregional heterogeneity underscores the possible need for a more localized approach to texture analysis, revealing nuanced changes within areas of interest. Move Correlation analysis between Strength/Minimum and μFE outcomes showed no significant relationships with biomechanical properties, meaning that the two features may be more related to collagen/mineral organization or water content.

In summary, the study demonstrates the potential of radiomics to provide a detailed assessment of CKD-related bone changes, identifying distinct texture features between the proximal- and distal-subregions within the same stack that distinguish CKD from non-CKD bone. This approach offers a more comprehensive evaluation of bone quality than standard HR-pQCT outcomes alone and supports use of machine learning models for improved fracture risk prediction and management in CKD.

### Example 2

Integrating deep learning and machine learning for improved CKD-related cortical bone assessment in HRpQCT images: A pilot study.

High resolution peripheral quantitative computed tomography (“HR-pQCT”) offers detailed bone geometry and microarchitecture assessment, including cortical porosity, but assessing chronic kidney disease (“CKD”) bone images remains challenging. This proof-of-concept study merges deep learning and machine learning to 1) improve automatic segmentation, particularly in cases with severe cortical porosity and trabeculated endosteal surfaces, and 2) maximize image information using machine learning feature extraction to classify CKD-related skeletal abnormalities, surpassing conventional DXA and CT measures.

30 individuals (20 non-CKD, 10 stage 3 to 5D CKD) were included who underwent HR-pQCT of the distal and diaphyseal radius and tibia and contributed data to develop and validate four different AI models for each anatomical site. Manually annotated cortical bone was used to train each segmentation deep-learning model. Textural features were extracted via Gray-Level Co-occurrence Matrix (“GLCM”) and classified as CKD or non-CKD using XGBoost with each segmentation model. For comparison, manufacturer-supplied segmentation was used to extract cortical geometry, microarchitecture, and finite element analysis (“FEA”) outcomes. Model performance was confirmed using the test dataset and a separate independent validation cohort which included HR-pQCT imaging from 42 additional individuals (18 non-CKD, 24 CKD stage 5D).

For segmentation, the diaphyseal location showed strong performance on test datasets, with Mean IoUs of 0.96 and 0.95, and accuracies of 0.97 for both radius and tibia sites in CKD. Model 4 developed from the diaphyseal tibia region excelled in classifying test and independent validation datasets, achieving F1 scores of 0.99 and 0.96, AUCs of 0.99 and 0.94, sensitivities of 0.99, and specificities of 0.99 and 0.92. No single parameter, including BMD and cortical porosity, among conventional CT outcomes consistently differentiated CKD from non-CKD across all anatomical sites.

Integrating HR-pQCT with deep and machine learning, this innovative approach enables precise automatic segmentation of severely deteriorated endocortical surfaces and enhances sensitivity to CKD-related cortical bone changes compared to standard DXA and HR-pQCT outcomes.

Unlike many other skeletal diseases, chronic kidney disease (“CKD”) primarily impacts cortical bone through the formation/expansion of cortical pores (pathological holes inside the cortex), cortical thinning, and trabecularization of endocortical bone surfaces. These features of CKD related cortical bone loss negatively impact mechanical properties essential for fracture resistance. Dual-energy Xray absorptiometry (“DXA”) remains the standard clinical imaging assessment for predicting fracture risk. Still, DXA often fails to adequately discriminate fracture risk in CKD, even in cases of normal or high bone mineral density (“BMD”). This is likely due to its inability to distinguish between bone types (cortical vs. trabecular), and as a result, DXA in the setting of renal disease has long been. Thus, it is necessary to identify early skeletal consequences of CKD, particularly those connected to the cortical bone, to allow for timely intervention that could reduce high fragility fracture rates in CKD.

High resolution peripheral quantitative computed tomography (“HR-pQCT”) has emerged as a powerful imaging modality allowing detailed bone geometry and microarchitecture, including cortical porosity assessments using a nominal isotropic voxel size (60.7 μm). Initial CKD studies have shown that HR-pQCT can allow for detailed measurements of cortical bone properties, such as cortical bone mineral density (“BMD”), porosity, and thickness. However, in cases of notable cortical thinning, severe porosity, and endocortical trabecularization-common features in CKD-standard automated segmentation can fail at extracting the cortex. This necessitates manual inspection of the 168-slice stacks and correction by an expert or trained user, introducing variability and resulting in additional time investment. While precise segmentation is a critical first step in image analysis, maximizing image information through techniques like textural feature extraction using machine learning could complement or surpass current cortical bone outcomes that rely on geometry and density. Textural analysis is a promising method for evaluating spatial patterns that indicate tissue heterogeneity. Textural analysis can significantly benefit from machine learning processes refined pattern recognition capabilities. Deep learning has greatly advanced medical imaging, especially in bone segmentation, by detecting intricate patterns in HR-pQCT images. In this approach according to this example, deep learning is used to enhance segmentation accuracy. However, for the next step of analyzing the texture features in these segmented images, machine learning was used. Machine learning, particularly XGBoost, is better suited for smaller datasets and provides clearer insights into which features are important for classifying CKD related bone abnormalities. By combining deep learning for segmentation with machine learning for classification, the strengths of both techniques were maximized.

The primary objective of this proof-of-concept study is to develop an integrated AI framework that utilizes deep learning for segmentation and machine learning for classification, incorporating textural features from HR-pQCT images of patients with advanced CKD and non-CKD individuals. This combined approach aims to accurately and reliably detect cortical bone abnormalities related to CKD compared to age- and sex-matched non-CKD control images. It is hypothesized that machine learning classification can differentiate CKD from non-CKD bone in both the distal and diaphyseal radius and tibia. This approach is expected to surpass standard DXA and HR-pQCT assessments, with potential benefits for patient management and personalized treatment planning, underscoring its clinical significance in CKD evaluation.

2. Methods. 2.1. Study participants and high-resolution peripheral quantitative computed tomography. Fifteen CKD patients who underwent HR-pQCT at the Musculoskeletal Function, Imaging, and Tissue Resource Core (FIT Core) of the Indiana Center for Musculoskeletal Health between 2018 and 2022 were initially included in the study. All participants provided written informed consent under Institutional Review Board approval from Indiana University. CKD patients were recruited either through ongoing studies or as part of the Core's ‘all-comer’ cohort and were flagged as ‘CKD’ in the FIT Core database. Inclusion criteria required participants to be 18 years or older with CKD stage 3 or higher. No exclusions were made based on race, ethnicity, or gender. Exclusions applied to pregnant or breastfeeding individuals, those with active implanted medical de-vices, or patients undergoing chemotherapy. Additionally, age- and sex-matched 29 non-CKD individuals were retrospectively identified from the FIT Core database.

As no public CKD HR-pQCT datasets were available for testing the model performance, additional data from CKD and non-CKD participants meeting inclusion criteria were collected from Jan. 1, 2023, to Mar. 31, 2024. This ‘independent validation cohort’ included 42 individuals, with 24 CKD stage 5D patients and 18 non-CKD participants used to test model performance.

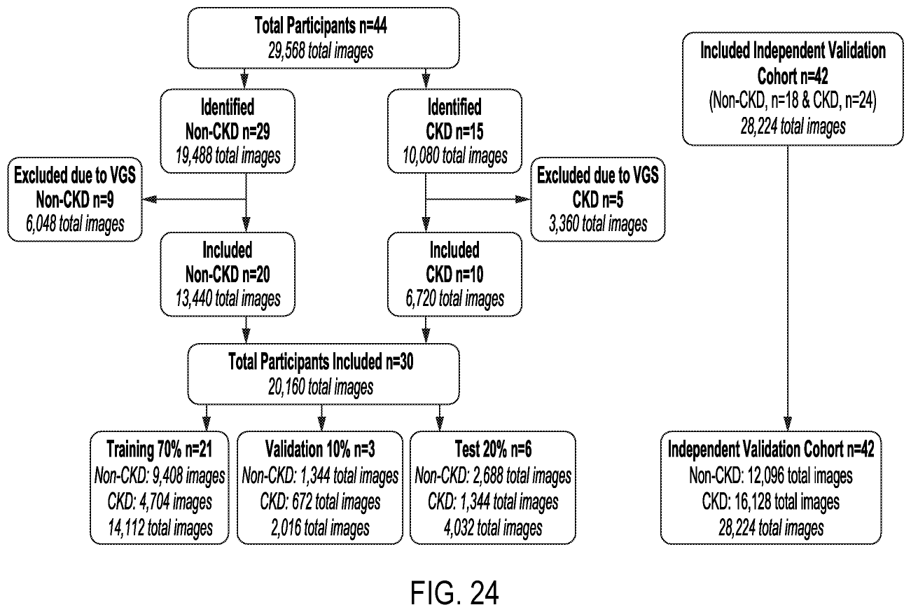

HR-pQCT (XtremeCT II, Scanco Medical, Bruttisellen, Switzerland) was acquired on the participants' non-dominant arm and leg. Scan stacks were positioned at 4% and 30% of the bone length proximal to the radius reference line, and at 7.3% and 30% of the bone length proximal to the tibia reference line. Motion was assessed using a visual grading score (“VGS”) ranging from 1 (no artifacts) to 5 (significant artifacts). Images with a VGS score ≥3 were excluded. Consequently, 5 CKD and 9 non-CKD participants were excluded from the study cohort due to scores of 3 or higher in the distal radius and tibia, and diaphyseal radius and tibia. The final study dataset included scans from 10 CKD and 20 non-CKD participants (20,160 DICOM images), while the independent validation dataset comprised scans from 24 CKD and 18 non-CKD participants (28,224 DICOM images) FIG. 24. Participants' height (measured to the nearest 0.1 cm) and weight (measured to the nearest 0.1 kg) were obtained. Appendicular skeletal muscle mass relative to height (ASM/height²; kg/m²) and whole-body areal bone mineral density (“aBMD”) were evaluated through whole-body DXA (Norland Elite; Norland at Swissray, Fort Atkinson, WI). The same DXA scanner was used assess total hip and spine aBMD.

Standard HR-pQCT outcomes were assessed by reconstructing raw scans and extracting cortical bone using manufacturer-supplied scripts with a low-pass Gaussian filter (sigma 0.8, support 1.0 voxel) and a fixed threshold of 450 mgHA/cm. The following conventional outcomes were recorded at the diaphyseal and distal site: volumetric BMD (Ct.vBMD, mgHA/cm3), area (Ct.Ar, mm²), thickness (Ct.Th, mm), and porosity (Ct.Po, %). μFE analysis (Scanco Medical FE software version 1.13) was used to estimate stiffness (kN/mm) using a pixel-wise assigned modulus of 10 gPa and a Poisson's ratio of 0.3 under axial compression as previously described (Arias-Moreno et al., 2019).

2.2. Data preprocessing. Separate models for segmentation and classification of CKD and non-CKD were developed and tested using distinct datasets for each anatomical site (distal and diaphyseal radius and tibia). The data was divided into training (70%, 4704 images for CKD, 9408 images for non-CKD), validation (10%, 1344 images for non-CKD, 672 images for CKD), and testing (20%, 2688 images for non-CKD, 1344 images for CKD) cohorts. Efforts were made to maintain the same average age and sex of patients throughout all the datasets. Datasets were split by patient rather than by image to prevent the assignment of the same patients or the mixing of patients' images between the training, validation, and test datasets. The following four AI models were developed:
1. Model 1: Distal radius segmentation & classification model
2. Model 2: Diaphyseal radius segmentation & classification model
3. Model 3: Distal tibia segmentation & classification model
4. Model 4: Diaphyseal tibia segmentation & classification model

FIG. 24 shows a flow diagram for image inclusion. HR-pQCT from 44 participants were retrospectively considered in the current study. Exclusions were made for nine non-chronic kidney disease (non-CKD) participants and five CKD participants who had a visual grading score (VGS) for motion artifacts of three or above in at least one location (distal or diaphyseal radius or tibia). The study ultimately included HR-pQCT volumes from 30 participants, encompassing the distal and diaphyseal radius and tibia, totaling 20,160 individual images (non-CKD=20 [13,440 images], CKD=10 [6720 images]). The final dataset was randomly divided into a training cohort (70%), a validation cohort (10%), and a testing cohort (20%), comprising a 7:1:2 ratio for each stage of the project. An independent validation cohort of n=18 and n=24 (28,224 images) individuals whose images were not used during model development or in the initial validation stage were included to test model performance.

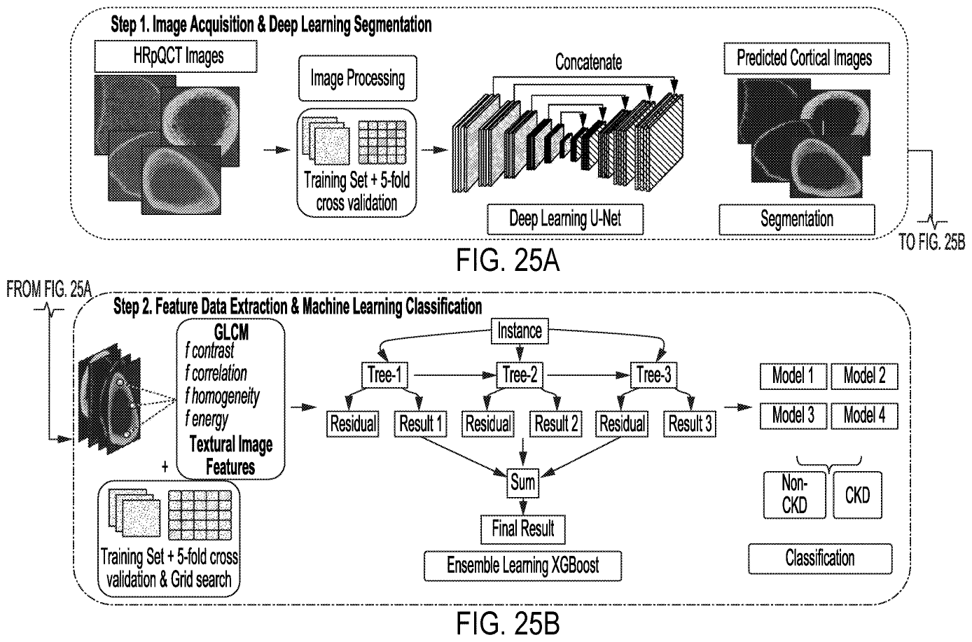

FIG. 25 shows a workflow of the two-Stage cortical bone analysis using HR-pQCT. A. The process initiates with the preprocessing of axial HR-pQCT scans, followed by segmentation of non-CKD and CKD cortical bones using a U-Net model trained using 5-fold cross-validation to make the model robust. B. The isolated cortical bones, shown as grayscale images that maintain the original pixel values, are then used for GLCM feature extraction. These features are subsequently trained using 5-fold cross-validation and grid search for optimal performance. Subsequently, an XGBoost machine learning classification is employed to determine distinctive attributes between non-CKD and CKD cortical bones. Model 1=Distal radius; Model 2=Diaphyseal radius; Model 3=Distal tibia; Model 4=Diaphyseal tibia.

2.3. Manual annotations. Volumes were first cropped to contain only the tibia or radius, removing the fibula or ulna, respectively. The cortical bone was segmented from the axial images by applying a threshold followed by manual correction using 3D Slicer (https://www.slicer.org) to create manual annotations. Two independent experts reviewed the annotated masks, and any discrepancies were resolved through consensus discussions. Each image was then resized to 512×512 pixels without image augmentation and normalized to ensure consistent intensity values. Segmentation models generated binary masks for the cortical region, excluding trabecular bone and soft tissue. These masks were applied to the original images to isolate the cortical region, preserving the original CT intensity values.

2.4. Stage 1. Enhanced cortical bone segmentation via deep learning. A deep learning approach was employed to enhance the segmentation of the cortical bone, particularly in cases with severe cortical abnormalities (FIG. 25A). The U-net architecture, known for its effectiveness in image segmentation, serves as the foundation for the model due to its previous success in medical image segmentation tasks. To find the proper hyperparameters and ensure reliability and generalizability, a 5-fold cross-validation strategy was used. Hyperparameters (Adam optimizer, learning rate set to 0.001, a batch size of 16, loss function of binary cross entropy) were chosen for both cohorts. After processing the cortical bone images, the two groups (CKD, non-CKD) for each of the four models (distal and diaphyseal radius and tibia) underwent a training phase. The training process was repeated, with the models being adjusted each time, until no further improvement was observed in their performance on a separate validation dataset across multiple training epochs, meaning that the entire training run was repeated until validation performance stopped improving. The model that achieved the lowest validation loss during this process was then selected for testing on the performance datasets. The segmentation model performances were evaluated using several well-defined metrics described in detail in the statistical analysis section before initiating the classification stage (stage 2). The model segmentation masks were combined with the original corresponding images to isolate the cortical region and guide further image analysis.

2.5. Stage 2. Utilizing machine learning for CKD vs. non-CKD image classification. 2.5.1. Gray level co-occurrence matrix (GLCM) feature extraction In the initial phase of stage 2, features were extracted from the segmented cortices of the HR-pQCT images (FIG. 25B). Using the Gray Level Co-Occurrence Matrix (GLCM), texture of the cortical bone region was analyzed by quantifying the occurrence of pixel value pairs at specified distances. The study focused on the following GLCM parameters: contrast, homogeneity, energy, and correlation.

2.5.2. Machine learning classification with XGBoost. After extracting texture features, XGBoost (eXtreme Gradient Boosting) was employed, a robust machine learning process. In simple terms, XGBoost is an advanced system that learns from data, such as texture patterns via GLCM, to improve its predictive accuracy over time. XGBoost excels at identifying patterns within large datasets. The model's settings were optimized using a grid search with variations in select parameters: number of estimator (50, 100, 200), maximum depth (3, 5, 7), and learning rate (0.01, 0.1, 0.2). This process identifies the best combination of hyperparameters to balance model accuracy with 5-fold cross-validation. The computations were per-formed on a system equipped with an Intel® Xeon® CPU @ 2.30 GHz and a GPU A100.

2.6. Independent validation. The internal validation dataset was used to independently validate the model's ability to distinguish between CKD and non-CKD cortical bone images. Segmentations were automatically performed using the approach in stage 1. This was followed by classification described in stage 2.

2.7. Statistical analysis. Participant characteristics and conventional cortical HR-pQCT out-comes are presented as mean±standard deviation. The Shapiro-Wilk test was employed to assess the normality of the data. For datasets exhibiting a normal distribution within each group, independent t-tests and chi-squared tests were applied as relevant for analysis. A significance threshold of p<0.05 was applied.

Several metrics were employed to assess segmentation model performance, including the Dice similarity coefficient (DSC), mean Intersection over Union (IoU), accuracy, and Hausdorff Distance. The DSC is a metric for segmentation accuracy and was used to assess the model's ability to identify bone regions within HR-pQCT images. The DSC quantifies the level of overlap between the segmented regions predicted by the model and the ground truth annotations, with a higher DSC indicating superior segmentation performance. The mean IoU, another spatial overlap metric, was also used to gauge the degree of overlap between the segmented regions and ground truth annotations. Accuracy was used to assess overall segmentation model performance. Average HD measures the mean of the maximum distance between any point on the first set (endosteal surface of original data) and its nearest point on the second set (endosteal surface of predicted binary mask). The HD proves invaluable in validating CKD-related image-based texture variation by calculating the distance between each point in overlapped images of two sets, given its proficiency in quantifying the similarity or dissimilarity of intricate structures. In addition, we identified systemic and random errors in HR-pQCT-derived automated contour segmentation.

Model performance for classification was evaluated using standard metrics. Area Under the Receiver Operating Characteristic Curve (AUC-ROC) was first calculated to measure the model's ability to distinguish CKD cortical bone from non-CKD cortical bone images. A higher AUC-ROC value indicates better classification performance and the model's effectiveness in distinguishing between the two groups. Additional metrics derived from the confusion matrix, such as accuracy, precision, recall, and the F1 score, were used to evaluate the model's performance in classifying CKD and non-CKD im-ages in both the original and independent validation datasets. To validate model consistency, performance metrics were compared, including True Positive Rate (TPR, sensitivity) and True Negative Rate (TNR, specificity), between the test set and an independent validation set. These metrics were assessed in terms of the model's accuracy in predicting CKD and non-CKD images. XGBoost classifier performance was evaluated in Python 3.7 using Keras and TensorFlow. The best performing models were chosen for each task to quantify the entire integrated pipeline performance, and the resulting error in the cortices is presented. SPSS v28 was used for statistical analysis.

3. Results. 3.1. Participant characteristics and conventional HR-pQCT outcomes Participant characteristics are detailed in Table 5. Eight of the 10 CKD patients were classified as CKD stage 5D and receiving hemodialysis; the remainder were CKD stage 3. The study featured participants from diverse racial backgrounds and included individuals self-reporting as non-Hispanic White (n=17), non-Hispanic Black (n=11), Hispanic White (n=1) and Asian (n=1). Shapiro-Wilks results indicated that data from all groups exhibited a normal distribution (p>0.05), allowing us to proceed with further analyses. No individual standard cortical HR-pQCT outcome could effectively distinguish between cortical bone characteristics in non-CKD and CKD cases in our cohort across each site. Because our CKD cohort contained CKD types 3 and 5D, we conducted a sub-analysis to evaluate any differences between the HR-pQCT outcomes when only CKD 5D vs. non-CKD were considered. It was observed that no changes in statistical outcomes was found when doing this evaluation. Thus, we moved forward with the 10 CKD patients containing both stage 3 and 5D for the remaining evaluation.

3.2. Stage 1: accuracy of the segmentation models. The segmentation and classification accuracy reported herein reflects an analysis of multiple cross-sectional images per subject, high-lighting the texture-gradient boost's capability to discern CKD presence at the image level rather than subject diagnosis. The DSC, Mean IoU, accuracy, and Average HD values from the segmentation models are presented in Table 6. All models of four sites employed the binary cross-entropy loss function. Early stopping was also used to prevent overfitting and identify the optimal epoch, and each model was assessed on the 1344 test set images. Overall, the diaphyseal cortical CKD models (radius, tibia) outperformed the distal cortical CKD models (radius, tibia) with the following metrics: DSC=0.97, 0.96 vs. 0.88, 0.91; mean IoU=0.96, 0.95 vs. 0.84, 0.86; accuracy=0.97, 0.97 vs. 0.96, 0.95; respectively. Qualitatively, nearly all outcomes from the trained models corresponded visually with the ground truth masks and did not overestimate the manually segmented masks. Each DSC training graph of the segmentation process was produced.

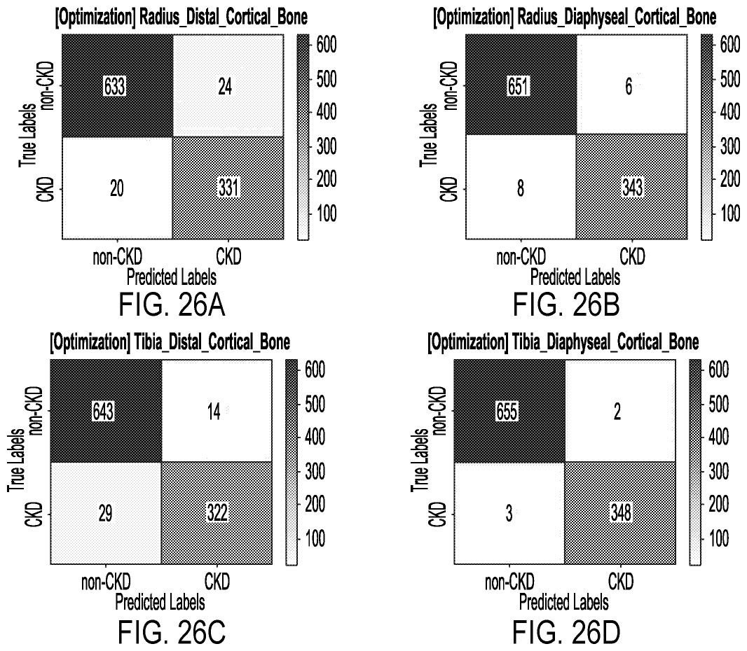

3.3. Stage 2: evaluation of the classification models. Extracted GLCM texture features from the segmented cortical HR-pQCT images were used as inputs to the ensemble XGBoost machine learning model. The model's hyperparameters were optimized (number of estimators: 200, learning rate: 0.2, maximum depth: 5) via the grid search method and compared it with the XGBoost default parameters. Table 6 presents performance of XGBoost with optimized hyper-parameters. With optimization, the diaphyseal tibia model almost achieved peak performance with a score of 99% across precision, recall, F1-score, accuracy, and AUC-ROC. The confusion matrix for the classification models was assessed based on a 5-fold validation technique with (FIGS. 26A-D) and without optimized hyperparameters. In short, the confusion matrix data shows better classification performance following hyper-parameter adjustment, with classification at the diaphyseal radius out-performing all sites. Upon close examination, it is evident that non-CKD cases misclassified as CKD exhibited increased cortical porosity and visually thinner cortices. Conversely, CKD cases mis-classified as non-CKD were associated with lower pore numbers and thicker, more robust cortices. Notably, the misclassified images do not originate from a single individual but from several individuals within each group.

3.4. Evaluation of independent validation dataset. Results of predicting independent validation datasets using XGBoost based on hyperparameter optimization showed the highest evaluation scores at the diaphyseal tibia. Tibial locations performed better than radial locations. In particular, Model 4 accurately predicted nearly 4028 CKD images out of 4032 images (24 CKD patients) in the independent validation dataset. Compared to the test set, all performance metrics on the independent validation set dropped slightly, which could be due to variations in dataset characteristics or differences in texture image patterns of individuals. Finally, sensitivity and specificity were similar between the independent validation dataset and the study test dataset.

| | Mean (standard deviation), n (%) | | | | | |
|---|---|---|---|---|---|---|
| | | | | Independent Validation | | |
| | Healthy | CKD | | Healthy | CKD | |
| | Volunteers | Patients | | Volunteers | Patients | |
| Characteristics | (n ± 20) | (n ± 10) | P-value | (n ± 18) | (n ± 24) | P-value |
| Age (years) | 53.23 ± 11.9 | 54.06 ± 10.38 | 0.91 | 54.55 ± 8.37 | 51.63 ± 14.51 | 0.42 |
| Height (cm) | 169.10 ± 11.82 | 173.43 ± 10.15 | 0.32 | 172.85 ± 8.53 | 165.48 ± 11.19 | 0.16 |
| Weight (kg) | 80.39 ± 15.44 | 79.57 ± 14.91 | 0.76 | 77.48 ± 11.79 | 85.93 ± 18.46 | 0.03 |
| BMI (kg/m²) | 26.82 ± 4.53 | 26.45 ± 4.22 | 0.37 | 25.87 ± 3.00 | 30.43 ± 7.07 | 0.01 |
| Whole body | 0.09 ± 0.45 | −0.37 ± 1.02 | 0.21 | −0.24 ± 1.39 | −0.88 ± 1.58 | 0.18 |
| Total T-score | | | | | | |
| Whole body | 0.56 ± 0.67 | −0.13 ± 1.02 | 0.05 | 0.04 ± 1.12 | −0.45 ± 1.22 | 0.19 |
| Total Z-score | | | | | | |
| Sex (Female) | 10 (50%) | 5 (50%) | 0.80 | 9 (50%) | 10 (42%) | 0.71 |

Table 5 shows subject demographics

The p-values between non-CKD and CKD patients were determined utilizing t-tests or chi-squared tests. Values are shown as means±standard deviation or as counts (percentages). P-values are bolded when significances is reached. BMI=body mass index. T- and Z-scores were determined by DXA.

TABLE 6
performance of cortical bone segmentation
using the original test dataset

| | | Segmentation Performance Metrics | | | | |
|---|---|---|---|---|---|---|
| | | | | | | Average |
| | | | | Mean | | Hausdorff |
| Model | Location | Group | DSC | IoU | Accuracy | Distance |
| Model 1 | Radius | Non-CKD | 0.88 | 0.86 | 0.95 | 24.51 |
| | Distal | CKD | 0.85 | 0.84 | 0.96 | 34.28 |
| Model 2 | Radius | Non-CKD | 0.96 | 0.96 | 0.97 | 12.70 |
| | Diaphyseal | CKD | 0.97 | 0.96 | 0.97 | 15.20 |
| Model 3 | Tibia | Non-CKD | 0.91 | 0.85 | 0.95 | 18.24 |
| | Distal | CKD | 0.91 | 0.86 | 0.95 | 23.83 |
| Model 4 | Tibia | Non-CKD | 0.95 | 0.92 | 0.96 | 29.12 |
| | Diaphyseal | CKD | 0.96 | 0.95 | 0.97 | 35.01 |

In Table 6, a probability threshold of 0.5 was used to evaluate the DSC, IoU, accuracy and Hausdorff Distance. The highest values in each column are bolded. CKD=chronic kidney disease, DSC=dice similarity coefficient, Mean IoU=mean intersection over union.

| | | | Classification Performance Metrics | | | | |
|---|---|---|---|---|---|---|---|
| | | | | | F1 | | AUC− |
| Model | Location | Group | Precision | Recall | score | Accuracy | ROC |
| Model | Radius | Non- | 0.97 | 0.96 | 0.97 | 0.96 | 0.98 |
| 1 | | CKD | | | | | |
| | Distal | CKD | 0.93 | 0.94 | 0.94 | 0.94 | |
| Model | Radius | Non- | 0.99 | 0.98 | 0.99 | 0.99 | 0.99 |
| 2 | | CKD | | | | | |
| | Diaphyseal | CKD | 0.98 | 0.98 | 0.98 | 0.98 | |
| Model | Tibia | Non- | 0.96 | 0.93 | 0.97 | 0.95 | 0.95 |
| 3 | | CKD | | | | | |
| | Distal | CKD | 0.96 | 0.92 | 0.94 | 0.92 | |
| Model | Tibia | Non- | 0.99 | 0.99 | 0.99 | 0.98 | 0.99 |
| 4 | | CKD | | | | | |
| | Diaphyseal | CKD | 0.99 | 0.99 | 0.99 | 0.99 | |

Table 7 shows the performance of XGBoost machine learning classification with hyperparameters optimization distinguishing between non-CKD and CKD cortical bone from HR-pQCT images using the test dataset.

In Table 7, XGBoost is a gradient-boosted machine-learning decision tree or classifier. A probability threshold of 0.5 was used to evaluate the precision, recall, F1 score, accuracy, AUC_ROC. The highest values in each column are bolded. CKD=chronic kidney disease, dSC=dice coefficient similarity, AUC-ROC=area under the receiver operating characteristic curve, XGBoost=Extreme Gradient Boosting.

FIGS. 26A-D show a confusion matrix for binary (non-CKD, CKD) classification using the optimized XGBoost classification models in the study cohort. The classification model was based on 5-fold validation. Confusion matrices are shown for the (A) distal radius, (B) diaphyseal radius, (C) distal tibia, and (D) diaphyseal tibia sites. The number within each box represents the number of images classified.

4. Discussion. Chronic kidney disease-related bone changes include changes in bone quality and can overlap with normal variations in non-CKD individuals, particularly when BMD is an outcome, necessitating novel imaging techniques. Our two-stage integrated approach uses HR-pQCT volumes from CKD patients and age/sex matched non-CKD individuals. The first stage could overcome the challenges of automatically separating cortical from trabecular bone in cases of thin and trabeculated endosteal surfaces (CKD), resulting in a segmentation pipeline that required no manual correction. When analyzing the cortical bone of our pilot cohort, no singular standard HR-pQCT cortical outcome showed significant differences between groups, even when limited to stage 5D patients. Implementing the second stage of the model, which leveraged textural features and thus maximized the image data from the HR-pQCT, enabled differentiation of cortical bone in CKD vs. non-CKD individuals, surpassing conventional imaging outcomes. This proof-of-concept study provides important insights into the potential of machine learning to detect subtle differences in cortical bone, surpassing standard imaging outcomes, even in a clinically heterogeneous cohort.

This work presents a fully automated process for segmentation of cortical bone at all four commonly used HR-pQCT sites which was trained using normative and diseased (CKD) images. In the initial stage of the approach, the incorporation of deep learning enabled the model to discern patterns and variations in bone structure characteristic of CKD, resulting in a robust, fully automated segmentation scheme that required no manual intervention. Specifically, the DSC and mean IoU for the CKD group's diaphyseal sites (radius: DSC=0.97, Mean IoU=0.96; tibia: DSC=0.96, Mean IoU=0.95) underscore the model precision. Moreover, the consistent accuracy across all groups and the quantified Average HD of 12.70 and 15.20 particularly in the diaphyseal radius further substantiates the reliability of our automated segmentation with the distance of ground truth masks. Despite being based on a limited sample size, the automated segmentation performed exceptionally well, achieving the highest DSC in the diaphyseal radius cortical bone (non-CKD: 0.98, CKD: 0.97) and the lowest DSC in the distal radius cortical bone (non-CKD: 0.88, CKD: 0.88) compared to expert annotations. The disparity in performance metrics between diaphyseal and distal sites can be explained by the dimensions of the trainable area. The diaphyseal sections present a larger training region due to thicker cortices, common to both CKD and non-CKD subjects, as opposed to the more limited cortical areas of the distal bone. The findings on average HD in the study suggest that in patients with CKD, the endosteal and periosteal edges of cortical bone tend to be less smooth due to increased trabecularization and porosity than those without CKD. These changes result in larger HD measurements in CKD patients, reflecting greater irregularity. In this study, no standard HR-pQCT cortical parameter consistently distinguished CKD from non-CKD across all sites, reflecting CKD's heterogeneous impact on the skeleton. To address this, GLCM texture analysis was integrated within the classification framework, complementing standard measurements. GLCM effectively extracts statistical data on pixel distribution by analyzing pixel pairs in a set direction and distance. One finding in the study is that GLCM-based analysis detected differences across all four anatomical sites, unlike standard HR-pQCT outcomes.

CKD can adversely affect the cortical matrix, altering the properties of mineral, collagen, and water content in the bone's cortex. The GLCM approach potentially captures these local and subtle disruptions to the matrix which are not fully appreciated in standard measurements and go beyond microstructural porosity. For example, despite insignificant differences in porosity as shown by t-tests, GLCM effectively identified textural anomalies allowing the model to distinguish between CKD and non-CKD images. The classification performance of the XGBoost models, optimized through hyperparameter adjustments, shows strong results across both the testing set and an independent validation set. When misclassified cases were visually inspected, slices misclassified as non-CKD showed no severe deterioration. In contrast, cases misclassified as ‘CKD’ showed patterns of trabecularization and cortical bone loss. Despite a slight decrease in performance metrics in the independent validation set as shown in Table 6, the models maintained high effectiveness. This indicates robustness and suggests that the superior initial performance in the testing set helped preserve high performance levels even in the validation set. For example, while Model 1 showed a decrease in precision from 0.97 to 0.87 for the non-CKD group from the testing to the validation set, the performance was still substantial. Similarly, Model 4 maintained nearly perfect metrics in both sets, especially in terms of TPR (as sensitivity) of 0.99. The slight drop in performance for the independent validation set may be due to differences in the dataset characteristics or variation in the disease severity's texture image patterns between datasets. Nonetheless, the consistency in high performance across different datasets highlights the model” reliability. HR-pQCT, while not yet FDA-approved for clinical diagnostics at the time of this study, remains a powerful research tool and is actively used in several clinical trials. This is particularly valuable for CKD patients, as standard imaging methods like DXA often fail to capture early bone changes. The machine learning approach herein leverages HR-pQCT to enhance the analysis of bone images by extracting textural features, improving the detection of CKD-related bone fragility. Integrating AI tools may streamline complex analyses as HR-pQCT becomes more widely adopted in clinical settings. Such advancements may support earlier interventions and more targeted treatment plans, ultimately improving clinical outcomes. Future research with larger datasets and additional model refinements may further validate this approach, enhancing its potential to become a mainstay in bone health related assessments particularly in cases such as CKD where bone changes encompass both quantity and quality changes in the cortical bone.

6. Conclusion. By implementing an automated system that integrates deep learning and machine learning, a method is described that accurately segments diseased and normative cortical bone without manual correction and can effectively distinguish diseased cortical bone changes from non-CKD normative bone. The broader implications of this study could be significant, as our integrated network demonstrates precision in classifying the distinctive cortical bone changes associated with CKD (stages 3-5D) and distinguishing them from normal patterns in age and sex-matched otherwise healthy individuals. Ongoing work will evaluate the technique in earlier CKD stages, refine the classification process, and assess its ability to differentiate between CKD stages.

### Example 3

Improving Assessment for Bone Fragility in CKD Using Machine Learning Classifiers and Radiomics Applied to HR-pQCT Tibia Scans

Chronic kidney disease (CKD) alters cortical bone structure and composition, increasing fracture risk. These changes are not uncommon in the non-CKD population and not detected by dual-energy X-ray absorptiometry (DXA). This study evaluated whether radiomics combined with machine learning can better detect CKD-related cortical bone fragility phenotypes in CKD patients using high-resolution peripheral quantitative computed tomography (HR-pQCT) images. HR-pQCT images (60.7 μm isotropic, 168-slice stack height, acquired at 7.3% and 30% proximal to the tibial endplate) were analyzed from 72 participants (38 non-CKD, 34 advanced CKD), totaling 24,192 slices. Tibial cortical bone was segmented using a pre-trained neural network optimized through model acceleration and transfer learning. Three radiomics feature extraction engines were paired with seven classifier methods to identify the optimal configuration for CKD-related fragility classification. Data were split into 80% training, 10% validation, and 10% hold-out testing. eXtreme Gradient Boosting (XGBoost) achieved the highest performance using Gray Level Co-Occurrence Matrix (GLCM) and Local Binary Pattern (LBP) textural features from distal and diaphyseal tibia cortical images, with sensitivities of 99.29% and 99.84%, and specificities of 100% and 99.91%, respectively. A hybrid XGBoost-GLCM-LBP, approach further reduced the false negative rate from 12.49% (GLCM) and 1.21% (LBP) to 0.78% (Hybrid) at the distal tibia, and from 2.76% (GLCM) and 0.52% (LBP) to 0.09% (Hybrid) at the diaphyseal tibia. The hybrid model may support more sensitive image-based assessment of skeletal fragility, ultimately aiding fracture risk prediction and management in dialysis-dependent patients.

1. Introduction. Individuals with chronic kidney disease (CKD) are much more likely to suffer from fragility fractures, with a risk up to 4 times higher compared to those without CKD, and this risk increases as the disease progresses. Unlike many other bone disorders, CKD mainly affects cortical bone, leading to higher cortical porosity, thinner cortex, and alterations in the composition of the cortical matrix itself. These changes reduce bone strength and increase fracture risk. In clinical practice, circulating biomarkers such as parathyroid hormone (PTH) and vitamin D levels are typically evaluated first as part of the fracture risk work-up before proceeding to imaging but the sensitivity and specificity for predicting underlying bone histology or fracture is poor. Although two-dimensional dual-energy X-ray absorptiometry (DXA) is commonly used to assess fracture risk, it underestimates fracture risk in patients with CKD. In CKD, BMD measurements can be misleading, as vascular calcifications-common in this population—can artificially inflate lumbar spine BMD values, and DXA cannot distinguish between cortical and trabecular compartments.

Among skeletal sites, the tibia—particularly its distal and diaphyseal regions—represents a clinically relevant, weight-bearing bone. Lower limb fractures including those of the tibia, are more frequently reported than upper limb fractures in advanced CKD patients undergoing dialysis, highlighting the importance of focusing on this region for CKD-related bone fragility assessment. Secon generation high-resolution peripheral quantitative computed tomography (HR-pQCT) provides detailed images of bone microarchitecture, including cortical morphometry, with a nominal isotropic voxel size (60.7 μm) and low effective radiation dose (3 μSv) (11). In previous examples, it was observed that conventional HR-pQCT metrics—such as cortical volumetric BMD (vBMD), porosity, and thickness—did not consistently distinguish CKD from non-CKD cases across both anatomical radius and tibia sites. In contrast, the textural-based radiomic features captured subtle, spatially heterogeneous patterns in cortical bone that were not well-reflected by existent HR-pQCT bone parameters but differed significantly between groups. These findings suggest that radiomics offer complementary cortical bone features beyond BMD and even high resolution morphometric outcomes, enabling more sensitive detection of CKD-related cortical bone abnormalities.

In the present study, the use of radiomics-based feature extraction was expanded and classification to HR-pQCT images in patients with CKD to determine how two texturally-related radiomics feature extraction methods, or a hybrid of them, applied through a series of ML modeling approaches to yield the best-performing model for classifying patients as having CKD related bone fragility using tibial HR-pQCT images. It is hypothesized that both feature extraction and ML classifier choice significantly influence the performance of CKD-related bone fragility classification, and that determining the highest-performing combination would enhance model robustness and accuracy.

2. Methods. 2.1 Ethics. Data and images were acquired as part of the observational Function, Imaging, and Testing (FIT) Core study which has Institutional Review Board Approval from Indiana University (Study #170755085). All participants provided written informed consent for their deidentified images and data to be used.

2.1.1 Study Design. The CKD patients receiving hemodialysis were imaged as part of ongoing prospective studies specifically evaluating patients age greater than 18 with advanced CKD undergoing dialysis. The control subjects ‘non-CKD’ were matched by age (+/−5 years, and sex) and recruited as part of the Indiana Center for Musculoskeletal Clinical Research Center FIT core. Prior to scanning, all individuals for both cohorts provided written informed consent for the use of their imaging in subsequent studies. A total of 72 adults were included in this study, comprising 34 individuals with CKD receiving dialysis and 38 age- and sex-matched non-CKD controls. CKD stage 5D (hemodialysis) were recruited from three independent cohorts: 19 from the “Effects of long interdialytic intervals on cardiovascular functional capacity (ECON) trial (14),” 9 from the ongoing “Redefining cardiovascular risk assessment in dialysis patients (ROCK-D) study,” and 6 from the “SPARK” study.

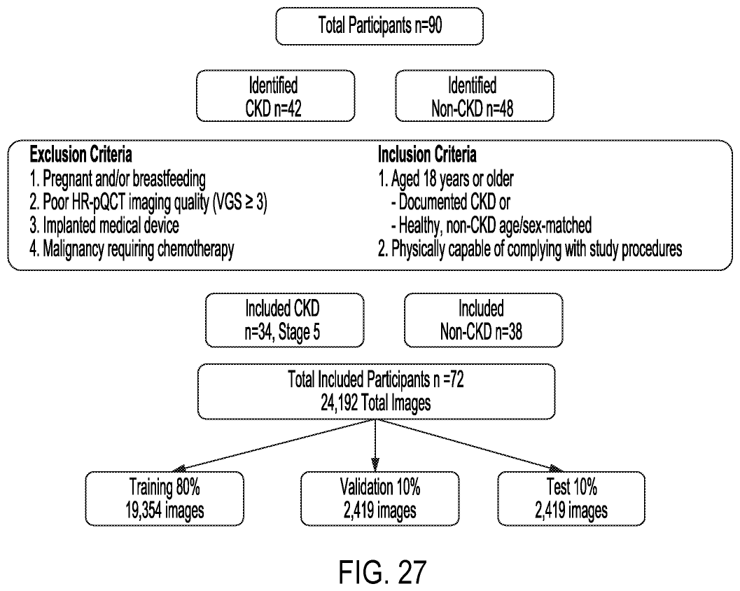

Existing HR-pQCT imaging was used with a motion artifact score (using the Visual Grading Score, VGS) of ≤3 (15) (FIG. 27), inclusive of the scans from 8 CKD and 20 non-CKD participants from the prior example. Whole-body areal BMD, T-scores, and Z-scores were obtained from DXA scans (Norland Elite; Norland at Swissray, Fort Atkinson, WI) conducted as part of the FIT Core protocol and were used to compare bone density between the CKD and non-CKD groups.

2.1.2. High-Resolution Peripheral Quantitative Computed Tomography (HR-pQCT). HR-pQCT images of the tibia were obtained from scans of the leg performed using a XtremeCT II scanner (Scanco Medical, Bruttisellen, Switzerland). Scan stacks were centered at 7.3% (distal) and 30% (diaphyseal) of tibial bone length proximal to a reference line placed at the center of the distal tibia joint surface. The scanner operated at 68 kVp and 1.47 mA, capturing 168 slice image stacks with an isotropic voxel size of 60.7 μm. A calibration phantom provided by the manufacturer was used to ensure scanner consistency throughout the duration of the study. All bone geometry and microstructure parameters (volumetric BMDs, areas, cortical and trabecular thickness, and porosity at distal and diaphyseal tibia sites) and subsequent of bone strength estimations including bone stiffness and failure load are analyzed using Micro finite element analysis (μFEA) exclusively on tibial images (see Table 9).

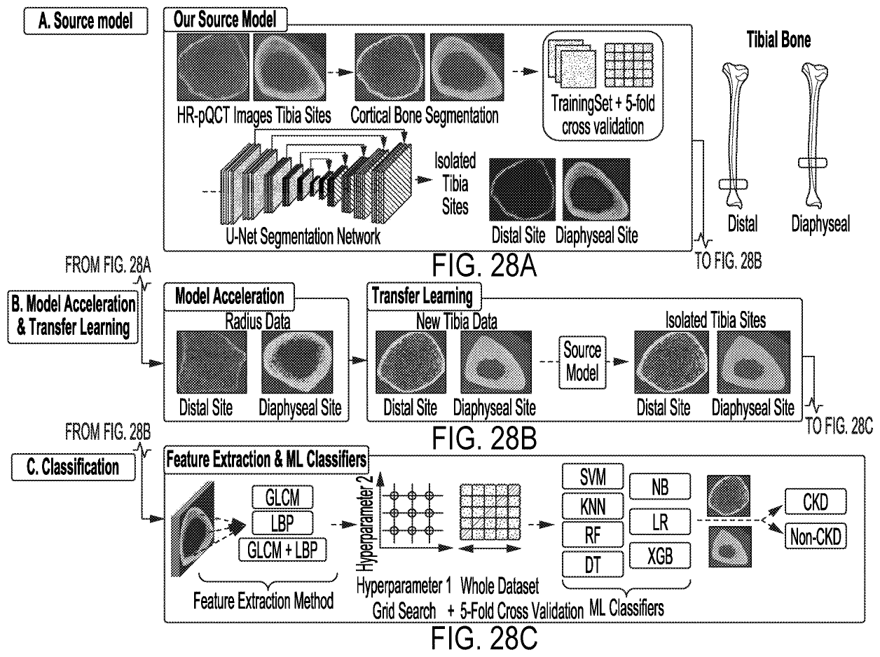

2.2. Cortical Bone Segmentation with Deep (Accelerated and Transferred) Learning. Cortical bone was segmented away from trabecular bone compartment and surrounding soft tissue using deep learning. Two pre-trained neural network-based segmentation models were previously developed using HR-pQCT images of the distal and diaphyseal tibial sites (FIG. 28A). The models were subsequently re-trained on a separate set of tibial images from this newly recruited cohort of participants. All HR-pQCT images were pre-processed by gray level normalization and discretization (bin widths=0.1-0.5) using Pandas and Scikit-learn libraries in Python (17, 18), to enhance sensitivity to subtle cortical differences associated with CKD. The final re-trained model served as the initial backbone for transfer learning, an approach that allows a model to apply previously learned knowledge to new but related data, enabling fine-tuning on newly acquired tibial HR-pQCT images from the applicable study cohort (FIG. 28B).

2.3. Textural feature extraction and outcome classification approach. 2.3.1. Feature Extraction Methods. The initial phase involved extracting features from individual slices within the segmented cortical bone using GLCM (24 features grouped into 4 categories: contrast, homogeneity, energy, and correlation) and LBP (26 features derived from uniform pattern histogram bins) methods executed within the scikit-learn library. The impact of these feature extraction methods on classifying CKD-related bone fragility was evaluated under three models: Model 1 using only GLCM, Model 2 using only LBP, and Model 3 combining both GLCM and LBP (19, 21, 22). The extracted radiomics features and magnitudes were normalized with a mean of zero and standard deviation of one (z-score transformation).

2.3.2. Machine Learning Classifiers. Seven different machine learning classifiers were employed: support vector machine (SVM), knearest neighbors (KNN), random forest (RF), decision tree (DT), naïve Bayes (NB), logistic regression (LR), and eXtreme Gradient Boosting (XGBoost), each using Python's scikit-learn package and inputting slicewise information from feature extraction methods. Among 72 participants' distal and proximal tibia HR-pQCT images, 80% were retained for training, 10% for validation, and an additional 10% held out for testing. The data were partitioned at the patient level to avoid leakage of images from the same patient across different datasets (FIG. 28C).

Classifier performance was evaluated based on several metrics, including accuracy, defined as (TP+TN)/(TP+TN+FP+FN), along with AUC, sensitivity, specificity, positive predictive value (PPV), and negative predictive value (NPV). Weighted averages for sensitivity and specificity were also reported to account for class imbalance. False negative rate (FNR) was calculated as FN/(FN+TP), based on the confusion matrix derived from test set predictions.

Hyperparameter tuning relevant for each classifier was performed using grid search with 5-fold cross-validation applied on the training to optimize the selection of textural feature variables that result in the greatest classification performance (as guided by AUC averaged across the 5 folds). In total, 21 combinations of feature extraction and classification approaches were evaluated. The best performing 2 to 3 top models were validated in the 10% validation set, reporting the full set of performance metrics. The final performance of the top model was assessed on the held-out test dataset.

2.6. Statistical Analyses. Continuous data are depicted as median and interquartile (1st-3rd) range and categorical variables were presented as counts and proportions. Participant characteristics and conventional cortical HR-pQCT outcomes are reported as mean±standard deviation. The Shapiro-Wilk test was employed to assess normality. Continuous variables were compared using two-sample t-tests or Mann-Whitney U tests, as appropriate based on data normality. Categorical variables were compared using Chi-squared tests. Statistical significance was set at p≤0.05. All analyses were performed using SPSS version 28.

2.7. Machine learning environment. The training was conducted in a computer environment with an Intel® Xeon® CPU @ 2.30 GHz and a GPU A100 card. All models were implemented using TensorFlow with Keras, and reproducibility was ensured through fixed randomization seeds and version tracking.

3. Results. 3.1. Participant and Scan Characteristics. All CKD participants were classified as stage 5D and requiring maintenance hemodialysis. eGFR was not assessed for classification, as it is not accurate in dialysis patients.

There were no significant differences in age, height, weight, or areal BMD (measured by DXA at the whole-body site) between the CKD and non-CKD groups (Table 8). Whole-body BMD Z-scores were significantly lower in the CKD group compared to the non-CKD group (p=0.037), whereas T-scores did not differ significantly between groups (p=0.058). Shapiro-Wilk tests confirmed normal distribution for all conventional HR-pQCT-derived parameters reported in Table 9. For conventional HR-pQCT cortical measures, CKD participants exhibited 18.7% lower stiffness and 18.0% lower failure load at the distal tibia compared to non-CKD participants (both p=0.002) (Table 2). No other distal tibia parameters differed significantly between groups. At the diaphyseal site, the only significant difference was a 9.3% reduction in cortical thickness in the CKD group (p=0.023).

| | Mean (standard deviation), n (%) | | |
|---|---|---|---|
| | | Healthy Volunteers | |
| Characteristics | CKD (n = 34) | (n = 38) | P-value |
| Age (years) | 52.3 ± 13.4 | 54.0 ± 14.7 | 0.58 |
| Sex (Female) | 14 (41%) | 18 (47%) | 0.79 |
| Height (cm) | 169.0 ± 11.0 | 171.2 ± 10.2 | 0.61 |
| Weight (kg) | 84.1 ± 17.6 | 79.1 ± 14.7 | 0.20 |
| BMI (kg/m²) | 29.3 ± 6.6 | 26.8 ± 3.8 | 0.07 |
| Whole body total t- | −0.7 ± 1.4 | −0.1 ± 1.1 | 0.05 |
| score | | | |
| Whole body total z- | −0.3 ± 1.2 | 0.3 ± 1.0 | 0.03 |
| score | | | |

Table 8 shows participant characteristics

In Table 8, the p-values between patients with CKD and non-CKD were determined utilizing t-tests or chi-squared tests. Values are shown as means±standard deviation or as counts (percentages). BMI=body mass index. t- and z-scores were determined by DXA.

| | | Cortical | Mean ± Standard Deviation | | | |
|---|---|---|---|---|---|---|
| Bone | Location | Outcome | CKD | Non-CKD | P-value | Cohen's d |
| Tibia | Distal | Ct.vBMD | 862.24 ± 94.18 | 892.34 ± 73.65 | 0.163 | −0.360 |
| | | (mgHA/cm³) | | | | |
| | | Ct.Ar (mm) | 132.36 ± 30.36 | 145.51 ± 35.36 | 0.126 | −0.396 |
| | | Ct.Th (mm) | 1.47 ± 0.31 | 1.59 ± 0.35 | 0.158 | −0.365 |
| | | Ct.Pm (mm) | 108.85 ± 11.58 | 108.91 ± 12.48 | 0.985 | −0.005 |
| | | Ct.Po (%) | 0.03 ± 0.02 | 0.03 ± 0.02 | 0.997 | 0.001 |
| | | Ct.PoDm | 0.22 ± 0.03 | 0.24 ± 0.03 | 0.064 | −0.481 |
| | | (mm) | | | | |
| | | Stiffness | 176.40 ± 4580.18 | 216.99 ± 5950.25 | 0.002 | −0.751 |
| | | (kN/mm) | | | | |
| | | Failure load | 15.26 ± 3844.69 | 18.61 ± 4892.31 | 0.002 | 0.747 |
| | | (kN) | | | | |
| | Diaphyseal | Ct.vBMD | 1011.86 ± 45.75 | 1027.43 ± 23.80 | 0.095 | −0.440 |
| | | (mgHA/cm³) | | | | |
| | | Ct.Ar (mm) | 283.06 ± 89.49 | 295.02 ± 50.06 | 0.408 | −0.217 |
| | | Ct.Th (mm) | 5.44 ± 1.03 | 6.00 ± 0.81 | 0.023 | −0.608 |
| | | Ct.Pm (mm) | 82.28 ± 8.46 | 80.68 ± 7.21 | 0.435 | 0.204 |
| | | Ct.Po (%) | 0.01 ± 0.00 | 0.01 ± 0.00 | 0.298 | 0.273 |
| | | Ct.PoDm | 0.21 ± 0.04 | 0.22 ± 0.03 | 0.089 | −0.449 |
| | | (mm) | | | | |
| | | Stiffness | 301.60 ± 65112.61 | 314.51 ± 54483.73 | 0.418 | −0.214 |
| | | (kN/mm) | | | | |
| | | Failure load | 26.17 ± 5774.08 | 27.23 ± 4726.09 | 0.351 | −0.242 |
| | | (kN) | | | | |

Table 9 shows participant characteristics

In Table 9, the comparison of the conventional HR-pQCT between the non-CKD and CKD groups. P<0.05 means statistical significance. μFE outcomes of stiffness and failure load considered both trabecular and cortical bone compartments. Failure load values are reported as absolute magnitudes for clarity, since the directionality of the simulated compressive load is not clinically meaningful. Ct.vBMD=cortical volumetric bone mineral density; Ct.Ar=cortical area; Ct.Th=cortical thickness; Ct.Pm=cortical perimeter; Ct.Po=cortical porosity; Ct.PoDm=cortical pore diameter.

3.2. Evaluation of the classification models. The optimal hyperparameters were derived by hyperparameter tuning in the training set: KNN with n_neighbors=5, DT with max_depth=10, RF with n_estimators=200 and max_depth=10, and XGBoost with n_estimators=300, max_depth=5, and learning_rate=0.1. The hyperparameter settings for the remaining classifiers are provided in Supplementary Materials Section 1.3. All results reported in this section reflect classifier performance on the held-put test set, after model selection using the validation set.

3.2.1. The GLCM feature extractor with ML-classifiers. Using the held-out test set, the top three classifiers using feature extractor GLCM on the distal tibia region are XGBoost, RF, and DT, which were the same as in the case for the diaphyseal tibia region. Among the three classifiers using GLCM features, XGBoost achieved the highest AUCROC at both tibial sites. In the distal tibia, XGBoost showed an accuracy of 0.900 and AUC-ROC of 0.974, which were 0.004 and 0.003 higher than RF (accuracy: 0.896, AUC-ROC: 0.971), and 0.037 and 0.106 higher than DT (accuracy: 0.863, AUC-ROC: 0.868). At the diaphyseal tibia, XGBoost reached an accuracy of 0.979 and AUC-ROC of 0.997, exceeding RF by 0.006 and 0.001 (RF: 0.973, 0.996), and DT by 0.031 and 0.049 (DT: 0.948, 0.948). The FNR of incorrectly classifying CKD images as non-CKD for distal and diaphyseal tibia was i) XGBoost: 12.49%, 2.76%, ii) RF: 13.18%, 3.27%, and iii) DT: 14.81%, 5.08%, respectively.

3.2.2. The LBP feature extractor with ML-classifiers. The top three classifiers using feature extractor LBP on the distal tibia region are XGBoost, RF, and KNN, which is the same in the case of the diaphyseal tibia region. Among the three classifiers using LBP features, XGBoost achieved the highest performance across both tibial sites. In the distal tibia, XGBoost reached an accuracy of 0.989 and AUC-ROC of 0.999, which were 0.003 higher in accuracy than RF (0.986) and 0.010 higher than KNN (0.979), while the AUC-ROC was the same as both RF and KNN (0.999). At the diaphyseal tibia, XGBoost achieved an accuracy of 0.994 and AUC-ROC of 0.999, which was 0.001 higher in accuracy than RF (0.993) and 0.004 higher than KNN (0.990), while the AUC-ROC was the same as RF and 0.001 higher than KNN (0.998). The FNR of incorrectly classifying CKD images as non-CKD for distal and diaphyseal tibia is i) XGBoost: 1.21%, 0.52%, ii) RF: 1.29%, 0.95%, and iii) KNN: 1.98%, 0.52%, respectively (Fig. S2, S4).

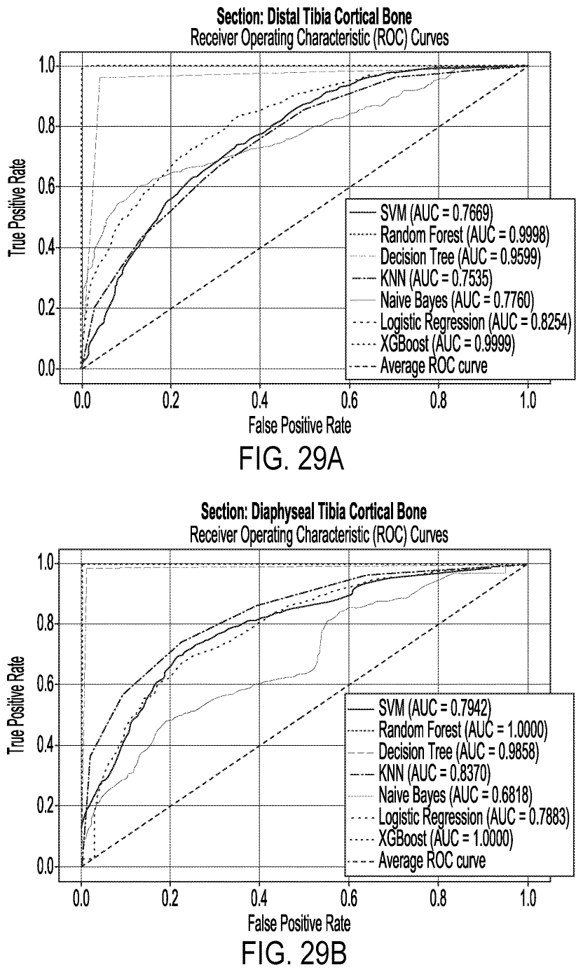

3.2.3. The GLCM & LBP hybrid feature extractor with ML-classifiers. The best-performing machine learning classifiers among the 21 tested combinations were the XGBoost classifiers fused with hybrid GLCM and LBP feature extraction, achieving AUC-ROC of 99.20% and 99.99% for the distal tibia, and 99.99% and 99.80% for the diaphyseal tibia in the held-out test set (Tables 10, 11). The corresponding AUC-ROC values was 0.999 for both RF and XGBoost at the distal and diaphyseal tibia sites, compared to 0.959 and 0.986 for DT, respectively (FIGS. 29A-B).

| GLCM + | GLCM + LBP & Tibia Distal Cortical Bone Classification Performance Metrics | | | | | | |
|---|---|---|---|---|---|---|---|
| LBP | Sensitivity | Specificity | FNR | PPV | NPV | Accuracy | AUC-ROC |
| SVM | 0.748 | 0.630 | 0.252 | 0.651 | 0.730 | 0.686 | 0.766 |
| RF | 0.991 | 0.993 | 0.008 | 0.992 | 0.992 | 0.992 | 0.999 |
| DT | 0.960 | 0.960 | 0.040 | 0.957 | 0.963 | 0.960 | 0.959 |
| KNN | 0.665 | 0.695 | 0.335 | 0.668 | 0.692 | 0.681 | 0.754 |
| NB | 0.794 | 0.485 | 0.206 | 0.587 | 0.718 | 0.633 | 0.776 |
| LR | 0.675 | 0.794 | 0.325 | 0.752 | 0.726 | 0.737 | 0.825 |
| XGBoost | 0.992 | 0.999 | 0.007 | 0.999 | 0.993 | 0.996 | 0.999 |

### Table 10 shows ML classifier performance on GLCM & LBP-processed tibia distal cortical compartment on the held-out test set

In Table 10, the FNRs were directly computed from the confusion matrices using the formula FN/(FN+TP), not by subtracting the rounded sensitivity values, such as RF, DT, XGBoost, ensuring greater numerical accuracy than using 1—sensitivity derived from the table. SVM=Support Vector Machine; RF=Random Forest; DT=Decision Tree; KNN=K-nearest neighbors; NB=Naïve Bayes; LR=Logistic Regression; XGBoost=Extreme Gradient Boosting; AUC-ROC=area under the receiver operating characteristic curve; FNR=False Negative Rate; PPV=Positive Predictive Value; NPV=Negative Predictive Value.

| GLCM + | | | | | | | |
|---|---|---|---|---|---|---|---|
| LBP | GLCM + LBP & Tibia Diaphyseal Cortical Bone Classification Performance Metrics | | | | | | |
| Model | Sensitivity | Specificity | FNR | PPV | NPV | Accuracy | AUC-ROC |
| SVM | 0.790 | 0.661 | 0.210 | 0.682 | 0.773 | 0.723 | 0.794 |
| RF | 0.999 | 0.999 | 0.001 | 0.999 | 0.999 | 0.999 | 0.999 |
| DT | 0.983 | 0.989 | 0.017 | 0.988 | 0.984 | 0.986 | 0.986 |
| KNN | 0.735 | 0.782 | 0.256 | 0.756 | 0.762 | 0.759 | 0.837 |
| NB | 0.816 | 0.448 | 0.184 | 0.578 | 0.724 | 0.625 | 0.682 |
| LR | 0.676 | 0.768 | 0.324 | 0.729 | 0.720 | 0.724 | 0.788 |
| XGBoost | 0.999 | 0.998 | 0.001 | 0.998 | 0.999 | 0.999 | 0.999 |

Table 11 shows ML classifier performance on GLCM & LBP-processed tibia diaphyseal cortical compartment on the held-out test set

In Table 11, the FNRs were directly computed from the confusion matrices using the formula FN/(FN+TP), not by subtracting the rounded sensitivity values, such as RF, DT, and XGBoost, ensuring greater numerical accuracy than using 1—sensitivity derived from the table. SVM=Support Vector Machine; RF=Random Forest; DT=Decision Tree; KNN=K-nearest neighbors; NB=Naïve Bayes; LR=Logistic Regression; XGBoost=Extreme Gradient Boosting; AUC-ROC=area under the curve of the receiver operating characteristic; FNR=False Negative Rate; PPV=Positive Predictive Value; NPV=Negative Predictive Value.

FIG. 27 shows a flow Diagram for Image Inclusion.

FIG. 28 shows a workflow of the Two-Stage Tibia Cortical Bone Analysis Using HR-pQCT Volumes. The process initiates with the preprocessing of axial HR-pQCT tibia scans of two sites (distal and diaphyseal), followed by the transfer learning of the validated cortices model based on model acceleration trained by the radius cortical bone. Subsequently, the predicted image was connected to radiomics process using feature extraction techniques such as GLCM or LBP or the combination GLCM with LBP, to extract image features in CKD and non-CKD. Then each image features were deployed to each classifier to compare their model performance and to find the best classification AI model.

FIG. 29 shows AUC-ROC curves for discriminating CKD patients from non-CKD participants using HR-pQCT cortical bone radiomics. (A) Distal tibia and (B) diaphyseal tibia cortical regions were analyzed across various classification models ranging from SVM to XGBoost, using combined GLCM+LBP radiomic features derived from transfer deep learning with model acceleration.

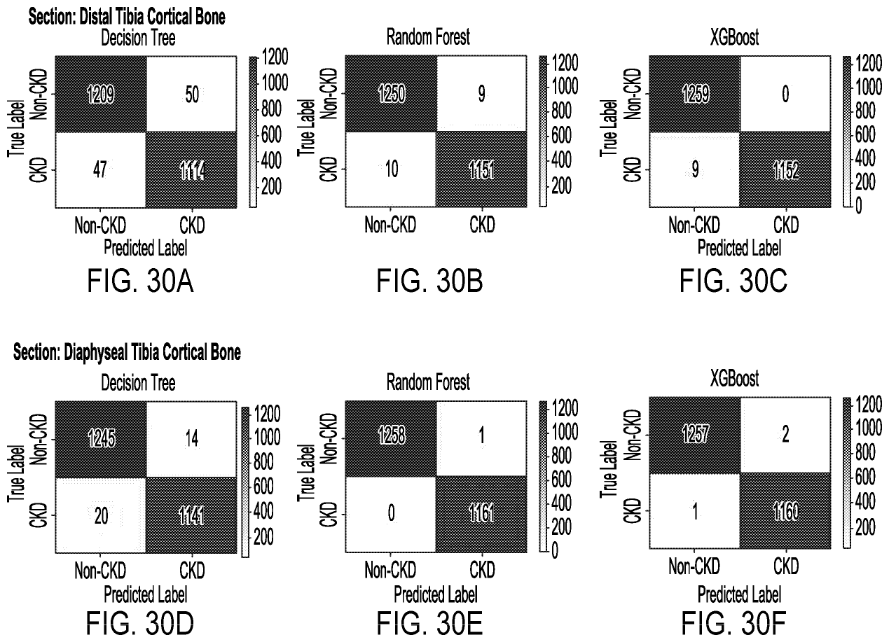

FIGS. 30A-F show confusion matrices for binary (non-CKD, CKD) classification using the top three ML classifiers from (A) Decision Tree, (B) Random Forest, and (C) XGBoost based on distal tibia cortical bone, and (D) Decision Tree, (E) Random Forest, and (F) XGBoost based on diaphyseal tibia cortical bone. All models were trained and evaluated using combined GLCM+LBP features on the hold-out test set. The numbers within each box represent the number of images classified into each category.

In the distal tibia sites using classifier XGBoost, the hybrid method of the fused GLCM and LBP achieved the highest accuracy of 0.996 from 0.900 of GLCM and 0.989 of LBP. Also, the XGBoost using the hybrid method outperformed other ML classifiers across all evaluation metrics shows superior performance over all other combinations of GLCM- or LBP-feature extractor, reducing misclassification of CKD images from FNR: of 12.49% (GLCM) and 1.21% (LBP) to 0.78% (Hybrid) for the distal tibia, as depicted in FIGS. 30A-C.

At the diaphyseal sits using classifier XGBoost, the hybrid approach of the combined feature extractors GLCM and LBP overall outperformed other combinations using the feature extractor GLCM or LBP, especially almost similar to the results derived from the classifier RF with the combined feature extractor-GLCM and LBP in terms of evaluation metrics, reducing misclassification of CKD images from FNR: of 2.76% (GLCM) and 0.52% (LBP) to 0.09% (Hybrid) for the diaphyseal tibia, as shown in FIGS. 30D-F. In comparing between all the outcomes of the distal tibia site with the diaphyseal tibia site, the latter showed better results.

Identified by the optimal model XGBoost combined the GLCM with LBP, some images in the CKD dataset were inaccurately classified as non-CKD, and conversely, some non-CKD images were misclassified as CKD. All the cross-sectional images of these misclassifications are depicted in FIG. 30C. Upon close examination, it becomes evident that non-CKD cases misclassified as CKD often exhibit increased cortical porosity and visually thinner cortices. Conversely, CKD cases misclassified as non-CKD are typically associated with little porosity and thicker, more robust cortices. Notably, the misclassified images do not originate from a single individual but rather from several different individuals within each group.

4. Discussion. CKD is a common disorder affecting over 10% of the world's population. Advanced CKD was focused on, those undergoing dialysis, because bone quality is often markedly altered at this stage due to CKD-Mineral Bone disease and the effects of long-term dialysis, including increased cortical porosity and reduced strength despite normal or high BMD. This population therefore represented a population with an unmet clinical need to improve diagnostics and represents a high-risk model for testing radiomics-based assessment. This study extends our previous proof-of-concept analysis in which radiomics features derived from HR-pQCT images were able to differentiate cortical bone in individuals with and without CKD. To build on these findings, sample size was increased and the range of radiomics and classification methods were expanded. In the present study, 21 cross-combinations of three feature extractors and seven ML classifiers were evaluated using tibial images from patients with end-stage kidney disease to assess the impact of feature-classifier pairing on model performance. Evaluating multiple combinations was important, as no single pairing is universally optimal across tasks. Different radiomic methods capture distinct image properties—such as spatial dependencies (GLCM) or local grayscale patterns (LBP)—while classifiers vary in how they model complexity, structure, and feature interactions. Because these combinations interact differently depending on dataset characteristics, systematically testing all pairings identified synergistic configurations tailored to detecting subtle CKD-related bone changes. These results demonstrate that among all evaluated combinations, the hybrid feature set combining of GLCM and LBP features with the XGBoost classifier achieved the highest predictive accuracy across both tibial sites, with strong sensitivity, specificity, PPV, and NPV.

The superior performance of XGBoost, is due to its ability to model complex, non-linear relationships and manage high-dimensional data, which are characteristic of radiomic features. XGBoost uses regularization techniques to reduce overfitting and supports parallel computation for faster training, making it well-suited for medical image classification. Characteristics of XGBoost make it particularly valuable for CKD-related cortical bone analysis, where both subtle textural variation and clinical interpretability are essential. Across most classifiers, LBP outperformed GLCM alone in terms of PPV, NPV and ROC, reaffirming prior reports that LBP is a highly effective texture descriptor. Tree-based models-especially RF, DT, and XGBoost-showed superior performance overall, though the KNN classifier yielded strong results when paired specifically with LBP features. This suggests that certain classifiers may pair more effectively with specific feature extraction strategies. However, the performance of KNN remained inferior to the hybrid approach.

Hybrid approaches like GLCM+LBP showed a notable advantage when paired with high-performing classifiers. This advantage is important in the context of CKD bone due to the complexity of assessment of cortical and trabecular changes. This approach may be attributed to the complementary nature of the two texture extraction methods in capturing different aspects of cortical bone microstructure that are not discernible using conventional imaging outcomes. GLCM characterizes second-order spatial statistics such as contrast, correlation, and entropy, which may reflect broader patterns in mineral distribution, such as localized demineralization or irregular matrix density, often seen in cortical bone affected by CKD. In contrast, LBP encodes fine-scale grayscale differences that are sensitive to local variations such as cortical porosity, micro-cracks, or early remodeling signals. In the context of cortical bone changes in patients with advanced CKD, where bone deterioration involves both diffuse and focal changes (e.g., mineralization defects, thinning, and heterogeneity in matrix quality), combining GLCM and LBP allows a more holistic texture representation. Prior studies in diverse imaging domains-including brain tumor, thyroid nodule, and general texture classification—have shown similar benefits from hybrid radiomics approaches, highlighting their ability to capture both global texture dependencies and local micro-patterns.

In a prior example that included 30 individuals (20 non-CKD, 10 CKD stage 3-5D), radiomics features extracted via GLCM and classified using XGBoost achieved outstanding performance: for the diaphyseal tibia region, the model yielded an AUC of 0.99, sensitivity of 0.99, and specificity of 0.92 in an independent validation cohort. The present study expands the evaluation to 21 feature-classifier combinations and demonstrates that a hybrid GLCM+LBP model with XGBoost achieves even stronger performance-sensitivities of 0.992 and 0.999, and specificities of 0.999 and 0.998 for distal and diaphyseal tibia sites, respectively. These results highlight the benefit of a disease-specific, image-only radiomics pipeline for detecting cortical bone alterations not captured by conventional approaches. Among all combinations, the hybrid feature set (GLCM+LBP) combined with XGBoost yielded the highest predictive performance in both distal and diaphyseal regions. These findings provide a reference for future work aiming to optimize radiomics pipelines for CKD-related bone analysis and broader skeletal health applications.

### Example 4

Additional New Data: Machine Learning Classifier Comparison for Radiomics-Based CKD Analysis. As part of the methodological advancement since the initial disclosure, a new analysis titled “Comparison of Feature Selection Methods Using Machine Learning Classifiers for Radiomics-Based CKD Analysis” has been conducted on our side. This work systematically evaluated multiple feature selection strategies (e.g., VarianceThreshold, mRMR, LASSO, ElasticNet, Random Forest, XGBoost) to determine their impact on classification performance using HR-pQCT-derived cortical radiomic features.

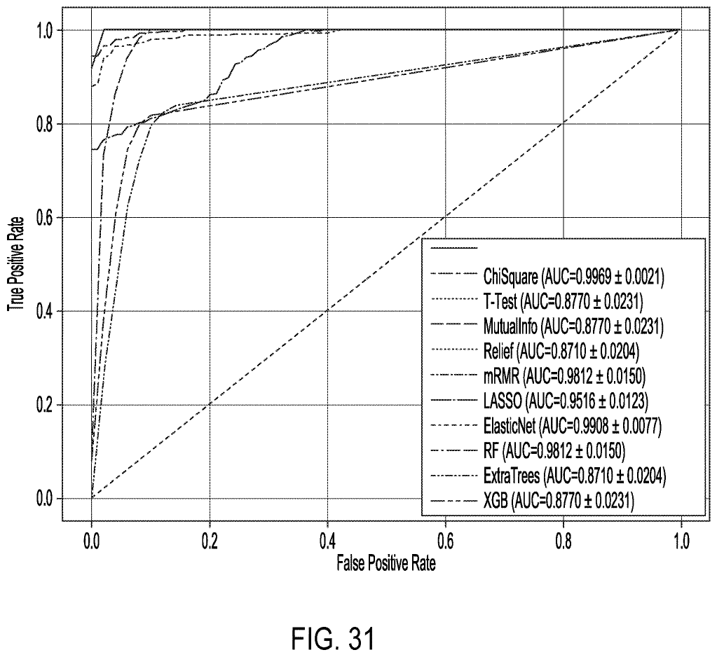

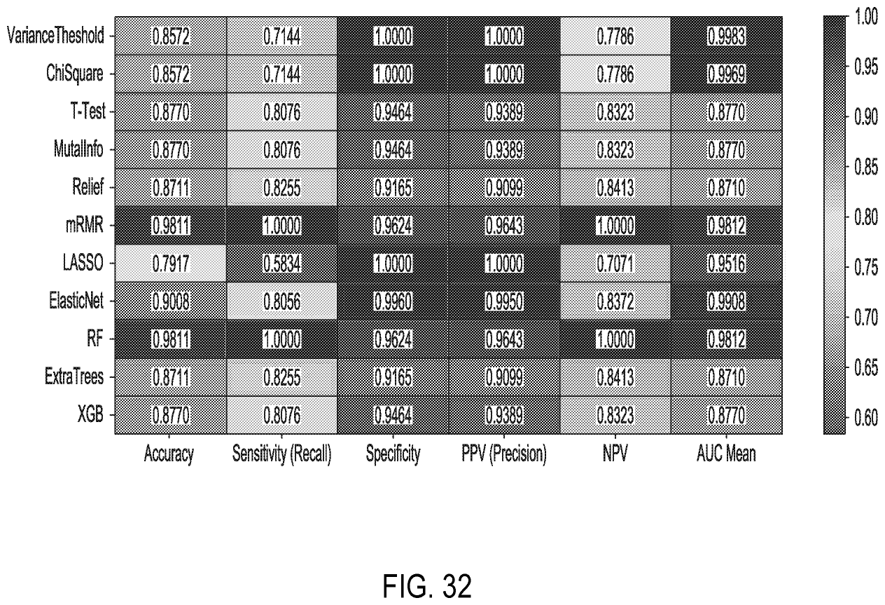

The newly generated dataset includes comparative performance metrics (accuracy, sensitivity, specificity, precision, NPV, and mean AUC) and ROC curve analyses (10-fold cross-validation). Results showed that mRMR-/VarianceThreshold- and Random Forest/-based feature selection methods achieved the highest overall performance (AUC≈0.98-1.00), while regularization-based approaches such as ElasticNet provided strong generalization with slightly lower variance across folds (FIGS. 31 and 32). These findings strengthen the robustness of the pipeline and highlight optimal feature-selection strategies for CKD-related cortical bone characterization.

This comparative evaluation represents new data not included in the original disclosure, supporting both methodological refinement and biological interpretability in the updated radiomics-machine learning framework.

FIG. 31 shows a ROC curve comparison of feature selection methods with 10-fld cross-validation.

FIG. 32 shows performance metrics across feature selection methods.

The present disclosure has described one or more preferred examples, and it should be appreciated that many equivalents, alternatives, variations, and modifications, aside from those expressly stated, are possible and within the scope of the invention.

It is to be understood that the disclosure is not limited in its application to the details of construction and the arrangement of components set forth in the accompanying description or illustrated in the accompanying drawings. The disclosure is capable of other examples and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular examples or relevant illustrations. For example, discussion of “top,” “front,” or “back” features is generally intended as a description only of the orientation of such features relative to a reference frame of a particular example or illustration. Correspondingly, for example, a “top” feature may sometimes be disposed below a “bottom” feature (and so on), in some arrangements or examples. Further, references to particular rotational or other movements (e.g., counterclockwise rotation) is generally intended as a description only of movement relative a reference frame of a particular example of illustration.

In some examples, aspects of the disclosure, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, examples of the disclosure can be implemented as a set of instructions, tangibly embodied on a non-transitory computer-readable media, such that a processor device can implement the instructions based upon reading the instructions from the computer-readable media. Some examples of the disclosure can include (or utilize) a control device such as an automation device, a special purpose or general purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the disclosure, or of systems executing those methods, may be represented schematically in the FIGS. or otherwise discussed herein. Unless otherwise specified or limited, representation in the FIGS. of particular operations in particular spatial order may not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular examples of the disclosure. Further, in some examples, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as examples of the disclosure, of the utilized features and implemented capabilities of such device or system.

In some examples, any suitable computer-readable media can be used for storing instructions for performing the functions and/or processes described herein. For example, in some examples, computer-readable media can be transitory or non-transitory. For example, non-transitory computer-readable media can include media such as magnetic media (e.g., hard disks, floppy disks), optical media (e.g., compact discs, digital video discs, Blu-ray discs), semiconductor media (e.g., RAM, flash memory, EPROM, EEPROM), any suitable media that is not fleeting or devoid of any semblance of permanence during transmission, and/or any suitable tangible media. As another example, transitory computer-readable media can include signals on networks, in wires, conductors, optical fibers, circuits, or any suitable media that is fleeting and devoid of any semblance of permanence during transmission, and/or any suitable intangible media.

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as examples of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

This discussion is presented to enable a person skilled in the art to make and use examples of the disclosure. Various modifications to the illustrated examples will be readily apparent to those skilled in the art, and the generic principles herein can be applied to other examples and applications without departing from the principles disclosed herein. Thus, examples of the disclosure are not intended to be limited to examples shown, but are to be accorded the widest scope consistent with the principles and features disclosed herein and the claims below. The accompanying detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g. “one or the other but not both”) when preceded by terms of exclusivity, such as “either,” “one of,” “only one of,” or “exactly one of.”

Also as used herein, unless otherwise specified or limited, the terms “about” and “approximately,” as used herein with respect to a reference value, refer to variations from the reference value of #15% or less (e.g., ±10%, ±5%, etc.), inclusive of the endpoints of the range. Similarly, the term “substantially equal” (and the like) as used herein with respect to a reference value refers to variations from the reference value of less than ±30% (e.g., ±20%, ±10%, ±5%) inclusive. Where specified, “substantially” can indicate in particular a variation in one numerical direction relative to a reference value. For example, “substantially less” than a reference value (and the like) indicates a value that is reduced from the reference value by 30% or more, and “substantially more” than a reference value (and the like) indicates a value that is increased from the reference value by 30% or more.

It will be appreciated by those skilled in the art that while the invention has been described above in connection with particular examples and examples, the invention is not necessarily so limited, and that numerous other examples, examples, uses, modifications and departures from the examples, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims. Various features and advantages of the disclosure are set forth in the following claims.

1. A method for analyzing bone images, comprising:
receiving high-resolution peripheral quantitative computed tomography (HR-pQCT) image data of a bone;
segmenting cortical bone regions in the HR-pQCT image data using a pre-trained machine learning model;
extracting radiomic features from the segmented cortical bone regions;
classifying, using the extracted radiomic features, the bone as belonging to a chronic kidney disease (CKD) group or a non-CKD group using a machine learning classifier.

2. The method of claim 1, wherein the machine learning classifier is trained on previously extracted radiomic features by:
processing previous HR-pQCT image data by performing gray-level normalization and discretization;
dividing each previous HR-pQCT image into proximal and distal subregions; and
applying a feature selection process to identify key radiomic features to determine the previously extracted radiomic features, wherein the feature selection process includes removing features with variance below a first threshold and intercorrelation above a second threshold.

3. The method of claim 2, wherein the first threshold is 0.20 and the second threshold is 0.80.

4. The method of claim 1, wherein extracting radiomic features comprises:
calculating Gray Level Co-occurrence Matrix (GLCM) features from the segmented cortical bone regions; and
deriving at least one texture descriptor from the GLCM.

5. The method of claim 4, further comprising extracting Neighboring Gray Tone Difference Matrix (NGTDM) features from the segmented cortical bone regions, wherein the NGTDM features include strength, and wherein the method further comprises using the NGTDM strength feature as an input to the machine learning classifier to distinguish between CKD and non-CKD bone images based on a quantification of the strength feature.

6. The method of claim 1, wherein extracting radiomic features further comprises:
calculating Local Binary Pattern (LBP) features from the segmented cortical bone regions; and
combining the LBP features with Gray Level Co-occurrence Matrix (GLCM) features to create a combined feature set that captures bone texture details indicative of CKD-related cortical bone.

7. The method of claim 2, wherein the machine learning classifier is a gradient boosted machine learning classifier

8. The method of claim 1, further comprising analyzing bone biomarkers from blood tests including parathyroid hormone (PTH), estimated glomerular filtration rate (eGFR), fibroblast growth factor 23 (FGF-23), or alpha-Klotho in combination with the extracted radiomic features to generate additional input features for the machine learning classifier.

9. A method comprising:
receiving one or more images of a region of a subject, the region including a tissue;
segmenting, using a trained image segmentation model, the tissue from each image of the one or more images to output a segmented image;
extracting features from each segmented image of the one or more segmented images;
outputting a classification for a subject by providing the extracted features to a trained classification model, the classification including a presence of a medical condition or an absence of a medical condition, the medical condition being at least one of a bone abnormality or chronic kidney disease (CKD).

10. The method of claim 9, wherein the tissue is cortical bone; and
wherein the medical condition is chronic kidney disease (CKD).

11. The method of claim 10, wherein the one or more images are high-resolution peripheral quantitative computed tomography (HR-pQCT) images.

12. The method of claim 10, wherein the classification indicates a stage of CKD.

13. The method of claim 9, wherein at least one of:
the image segmentation model is anatomical region specific; or
the trained classification model is anatomical region specific.

14. The method of claim 9, wherein the trained classification model is an ensemble classifier.

15. A method comprising:
receiving an image of a bone of a subject;
segmenting, using a trained image segmentation model, the image to output a segmented image, the segmented image including cortical bone, wherein the trained image segmentation model has been trained to identify cortical bone in an image;
extracting radiomic features from the segmented image; and
outputting a classification for a subject by providing the extracted features to a trained classification model, the classification including a presence of chronic kidney disease (CKD) or an absence of CKD.

16. The method of claim 15, wherein the trained classification model is an ensemble classifier having a plurality of weak models.

17. The method of claim 15, wherein the image is a peripheral quantitative computed tomography (HR-pQCT) image.

18. The method of claim 15, wherein the classification includes a stage of CKD.

19. The method of claim 15, wherein the extracted radiomic features include at least one of a first order radiomic feature, a second order radiomic feature, or a third order radiomic feature.

20. The method of claim 15, wherein a machine learning model includes the trained image segmentation model and the trained classification model; and
wherein the image is provided to the machine learning model and the machine learning model outputs the classification.
